(19) United States
(12) Patent Application Publication
(10) Pub. No.: US 2015/0346403 A1
(43) Pub. Date: Dec. 3, 2015

(54) IR CUT FILTER AND IMAGE CAPTURING DEVICE INCLUDING SAME

(71) Applicant: KONICA MINOLTA, INC., Chiyoda-ku, Tokyo (JP)

(72) Inventors: HIDETAKA JIDAI, SAKAI-SHI, OSAKA (JP); KOJI TAKAHARA, HIRAKATA-SHI, OSAKA (JP); KOJI NAKAMURA, TOYOKAWA-SHI, AICHI (JP); TAKUJI HATANO, SUITA-SHI, OSAKA (JP)

(73) Assignee: KONICA MINOLTA, INC., TOKYO (JP)

(21) Appl. No.: 14/654,948

(22) PCT Filed: Dec. 20, 2013
(86) PCT No.: PCT/JP2013/084229

§ 371 Date: Jun. 23, 2015

(30) Foreign Application Priority Data
Dec. 27, 2012 (JP) 2012-284411
Feb. 28, 2013 (JP) 2013-038725
Feb. 28, 2013 (JP) 2013-038734
Feb. 28, 2013 (JP) 2013-038739

(51) Int. Cl. G02B 5/20; H04N 5/33; H04N 9/04

(52) U.S. Cl. CPC G02B 5/208; H04N 9/045; H04N 5/33

(57) ABSTRACT

A multilayer film of an IR cut filter has the following characteristics. The multilayer film is formed by stacking a high refractive index layer 4 and a low refractive index layer 5 on a substrate 2 and average transmittance in a wavelength region of 450 nm to 600 nm is equal to or greater than 90%. A wavelength with transmittance of 50% at an incidence angle of 0° is in a range of 650±25 nm. 0.5%/nm<|DT|<7%/nm is satisfied. A difference in wavelength with transmittance of 50% between an incidence angle of 0° and an incidence angle of 30° is equal to or less than 8 nm. A difference in wavelength with transmittance of 75% between an incidence angle of 0° and an incidence angle of 30° is equal to or less than 20 nm. Here, |DT| is a value (%/nm) of |(T70%−T30%)/(λ70%−λ30%)| at the incidence angle of 0°, T70% is a transmittance value of 70%, T30% is a transmittance value of 30%, λ70% is a wavelength (nm) with transmittance of 70%, and λ30% is a wavelength (nm) with transmittance of 30%.

### TECHNICAL FIELD

The present invention relates to an infrared (IR) cut filter which transmits visible light and reflects near-infrared light and an image capturing device having the IR cut filter.

### BACKGROUND ART

A solid-state image capturing device such as a charge coupled device (CCD) is built in a camera of a portable phone. A CCD is a silicon semiconductor device that converts image light into an electrical signal and has sensitivity up to a near-infrared (IR) region. Accordingly, when light including visible light and near-infrared light is incident on the CCD, the near-infrared light is also received as an image and there is a problem in that a false color appears in an acquired image. In order to solve this problem, an IR cut filter is generally inserted between a lens group and the CCD.

An IR cut filter has spectral characteristics (transmittance characteristics) of transmitting visible light and reflecting near-infrared light. An IR cut filter which is generally used in the related art has an optical film (multilayer film) in which a layer formed of a high refractive index material such as TiO₂, Nb₂O₅, or Ta₂O₅ and a layer formed of a low refractive index material such as SiO₂ or MgF₂ are alternately stacked using a vacuum vapor deposition method, a sputtering method, or the like.

Such an IR cut filter employing the optical film is disclosed, for example, in Patent Literature 1. The IR cut filter disclosed in Patent Literature 1 has IR cut characteristics and visibility correction characteristics together and is a thin IR cut filter which is of a coating type and which has the same spectral characteristics as visibility correction glass.

Since the IR cut filter having an optical film uses interference of light at the time of transmitting visible light and reflecting near-infrared light, the spectral characteristics vary with a variation in incidence angle of light. As a result, IR cut characteristics vary in a central part of a screen and a peripheral part of the screen which have different incidence angles of light, and the central part of a captured image received from the CCD via the IR cut filter is reddened.

For example, in an IR cut filter disclosed in Patent Literature 2, a decrease in variation of spectral characteristics with respect to a variation in incidence angle is attempted by setting a refractive index difference between a high refractive index layer and a low refractive index layer to be equal to or less than 0.4.

An IR cut filter disclosed in Patent Literature 3 includes a glass substrate, a dielectric multilayer film, and a resin layer having a near-infrared absorbent, and realizes characteristics (incidence angle dependency) that a difference in wavelength with transmittance of 50% (cutoff wavelength) between an incidence angel of 0° and an incidence angle of 30° is equal to or less than 15 nm in a wavelength region of 560 nm to 800 nm.

On the other hand, Patent Literature 4 discloses a method of partially changing the thickness of a resin layer having an infrared absorption function as a countermeasure against ghosts due to reflected light. More specifically, in a solid-state image capturing device including plural microlenses on a semiconductor substrate on which plural photoelectric conversion elements are formed, scattered light of light incident between the microlenses or oblique light incident on a hem pars of the microlenses at which light-condensing efficiency is poor can be effectively cut off and light reflected from between the microlenses can be effectively cut off, by forming a resin layer to be selectively thin on the microlenses and forming the resin layer to be selectively thick between the neighboring microlenses.

### CITATION LIST

### Patent Literatures

Patent Literature 1: JP 2006-195373 A (see claim 1, paragraphs [0011] and [0024], and the like)

Patent Literature 2: JP 2008-158036 (see claim 2, paragraphs [0009] and [0016, and the like]

Patent Literature 3: JP 2012-103340 (see claims 1, 2, and 7, paragraph [0024), and the like]

Patent Literature 4: JP 2003-101001 (see claim 1, paragraph [0020], and the like]

### SUMMARY OF INVENTION

### Technical Problem

Recently, a decrease in thickness of a portable phone, a smart phone, or the like has been attempted more and more, a low profile of an imaging lens has accordingly been required, and specifications of low incidence angle dependency of spectral characteristics have been required for an IR cut filter which is used together with the imaging lens.

However, the IR cut filter disclosed in Patent Literature 2 does not satisfy requirements of the recent specifications of low incidence angle dependency. That is, in Patent Literature 2, a film configuration has been studied so as to decrease a variation in spectral characteristics with respect to a variation in incidence angle, but the variation in incidence angle is considered to be 20°, which is not enough as conditions for coping with the low profile of the imaging lens. In order to cope with the low profile of the imaging lens, it is necessary to suppress the variation in spectral characteristics with respect to a larger variation in incidence angle (for example, 30°). In the IR cut filer disclosed in Patent Literature 3, since an allowable range of a shift in a cutoff wavelength with respect to a variation in incidence angle of 30° is 15 nm which is broad, it cannot be said to realize the low incidence angle dependency.

On the other hand, as described above, the IR cut filter disclosed in Patent Literature 1 is directed to realizing a visibility correction function with a thin configuration and does not have a technical idea lowering the incidence angle dependency of spectral characteristics and a film configuration based on the technique idea.

Even when the low incidence angle dependency is realized by forming a multilayer film on one surface (hereinafter, often referred to as Surface A) of a substrate of the IR cut filter, a rapid variation in transmittance of a wavelength region of 600 nm to 700 nm is suppressed in the multilayer film and it is thus difficult to satisfactorily secure reflection characteristics of near-infrared light around a wavelength of 700 nm. Accordingly, a method of forming another multilayer film on the opposite surface (hereinafter, often referred to as Surface B) of the substrate to give reflection characteristics of near-infrared light to the multilayer film can be considered. However, in this case, when a cutoff wavelength (wavelength with transmittance of 50%) in a wavelength region of 600 nm to 700 nm in the multilayer film on Surface B is excessively short, the angle dependency which is suppressed to be small by the multilayer film on Surface A collapses due to the characteristics of the multilayer film on Surface B and it is thus necessary to appropriately set the spectral characteristics of the multilayer film on Surface B in consideration of this point.

Various IR cut filters having a dielectric multilayer film with high incidence angle dependency in which the shift of the cutoff wavelength with respect to a variation in incidence angle of 30° is equal to or greater than 15 nm and an infrared absorbent layer (resin layer) have been present in the related art. In such IR cut filters, it is considered that the reflection characteristics around the cutoff wavelength can be improved to lower the incidence angle dependency by increasing an amount of infrared light absorbed by an infrared absorbent (an amount of infrared absorbent added).

Here, FIG. 122 schematically illustrates characteristics of an infrared absorbent. From the drawing, it can be seen that the infrared absorbent absorbs visible light of a wavelength on a shorter wavelength side than the cutoff wavelength as well as near-infrared light of a wavelength on a longer wavelength side than the cutoff wavelength (for example, 650 nm) and the transmittance of visible light decreases when the amount of infrared absorbent added increases. Accordingly, in order to realize the low incidence angle dependency while securing the transmittance of visible light to a certain extent, it is necessary to appropriately define the amount of infrared absorbent added (the amount of infrared light absorbed).

A substrate of an IR cut filter having a multilayer film and an infrared absorbent layer (resin layer) on the substrate is generally a flat panel. Accordingly, when the technique disclosed in Patent Literature 4 in which the thickness of the resin layer is changed is employed as a countermeasure against ghosts due to reflected light from the multilayer film, absorption characteristics vary in a plane parallel to the substrate vary. Accordingly, as a countermeasure against the ghosts, it is necessary to reduce the ghosts without changing the thickness of the resin layer.

The present invention is made to solve the above-mentioned problems and a first object thereof is to provide an IR cut filter of low incidence angle dependency which can satisfactorily cope with a low profile of an imaging lens and an image capturing device having the IR cut filter.

A second object of the present invention is to provide an IR cut filter which can realize low incidence angle dependency using a multilayer film formed on one surface of a substrate and which can satisfactorily secure reflection characteristics of near-infrared light without greatly damaging the low incidence angle dependency using another multilayer film formed on the opposite surface of the substrate and an image capturing device having the IR cut filter.

A third object of the present invention is to provide an IR cut filter which can realize low incidence angle dependency capable of satisfactorily coping with a low profile of an imaging lens with a configuration in which a multilayer film and a resin layer having an infrared absorption function are formed on a substrate and which can reduce ghosts due to reflected light from the multilayer film without changing the thickness of the resin layer and an image capturing device having the IR cut filter.

### Solution to Problem

An IR cut filter according to an aspect of the present invention is an IR cut filter that transmits visible light and reflects near-infrared light, including:

a transparent substrate; and

a multilayer film that is formed on the substrate,

wherein the multilayer film includes a high refractive index layer and a low refractive index layer which are alternately stacked,

wherein, in the multilayer film, average transmittance in a wavelength region of 450 nm to 600 nm in the multilayer film is equal to or greater than 90%,

wherein a wavelength with transmittance of 50% at an incidence angle of 0° is in a range of 650±25 nm,

wherein 0.5%/nm<|ΔT|<7%/nm is satisfied,

wherein, in a wavelength region of 600 nm to 700 nm, a difference in wavelength with transmittance of 50% between an incidence angle of 0° and an incidence angle of 30° is equal to or less than 8 nm, and

wherein a difference in wavelength with transmittance of 75% between an incidence angle of 0° and an incidence angle of 30° is less than 20 nm,

|ΔT|: value (%/nm) of |(T_{70%}−T_{30%})/(λ_{70%}−λ_{30%})| at the incidence angle of 0°

T_{70%}: transmittance value of 70%,

T_{30%}: transmittance value of 30%,

λ_{70%}: wavelength (nm) with transmittance of 70%, and

λ_{30%}: wavelength (nm) with transmittance of 30%.

The IR cut filter may have an absorption film (resin layer) having an absorption peak at a wavelength of 600 nm to 700 nm.

An IR cut filter according to another aspect of the present invention is an IR cut filter that transmits visible light and reflects near-infrared light, including:

a transparent substrate; and

a multilayer film that is formed on the substrate,

wherein the multilayer film includes a high refractive index layer and a low refractive index layer which are alternately stacked,

wherein average transmittance in a wavelength region of 450 nm to 600 nm in the multilayer film is equal to or greater than 90%,

wherein a wavelength with transmittance of 50% at an incidence angle of 0° is in a range of 650±25 nm,

wherein 0.5%/nm<|ΔT|<7%/nm is satisfied in a wavelength region of 600 nm to 700 nm,

|ΔT|: value (%/nm) of |(T_{70%}−T_{30%})/(λ_{70%}−λ_{30%})| at the incidence angle of 0°

T_{70%}: transmittance value of 70%,

T_{30%}: transmittance value of 30%,

λ_{70%}: wavelength (nm) with transmittance of 70%,

λ_{30%}: wavelength (nm) with transmittance of 30%, and

wherein when a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,

$${\sum }_{n = 50}^{80} \vert Tn \% λ ( 0 ° ) - Tn \% λ ( 30 ° ) \vert ≦ 350 nm . \qquad [ Expression 1 ]$$

An IR cut filter according to yet another aspect of the present invention is an IR cut filter that transmits visible light and reflects near-infrared light, including:

a transparent substrate;

a first multilayer film that is formed on one surface of the substrate; and

a second multilayer film that is formed on the opposite surface of the substrate,

wherein in a state in which the first multilayer film and the second multilayer film are formed on both surfaces of the substrate, respectively, a wavelength with transmittance of 50% at an incidence angle of 0° is in a range of 650±25 nm,

wherein in the first multilayer film,

a wavelength with transmittance of 50% at an incidence angle of 0° is in a range of 650±25 nm, and

0.5%/nm<|ΔT|<7%/nm is satisfied in a wavelength region of 600 nm to 700 nm, |ΔT|: value (%/nm) of |(T_{70%}−T_{30%})/(λ_{70%}−λ_{30%})| at the incidence angle of 0°

T_{70%}: transmittance value of 70%,

T_{30%}: transmittance value of 30%,

λ_{70%}: wavelength (nm) with transmittance of 70%,

λ_{30%}: wavelength (nm) with transmittance of 30%, and

when a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,

$${\sum }_{n = 50}^{80} \vert Tn \% λ ( 0 ° ) - Tn \% λ ( 30 ° ) \vert ≦ 350 nm , \qquad [ Expression 1 ]$$

and

wherein in the second multilayer film,

transmittance of a wavelength of 710 nm at the incidence angle of 0° is equal to or less than 5%, and

T_{A}50% λ(30°)−T_{B}50% λ(30°)≦8 nm is satisfied,

T_{A}50% λ(30°): wavelength (nm) with transmittance of 50% in the wavelength region of 600 nm to 700 nm at the incidence angle of 30° in the first multilayer film

T_{B}50% λ(30°): wavelength (nm) with transmittance of 50% in the wavelength region of 600 nm to 700 nm at the incidence angle of 30° in the second multilayer film.

An image capturing device according to yet another aspect of the present invention includes: the IR cut filter according to any one of the aspects; an imaging lens that is disposed on a light incidence side of the IR cut filter; and an imaging element that receives light which is incident through the imaging lens and the IR cut filter.

### Advantageous Effects of Invention

According to the configurations, it is possible to suppress a variation in spectral characteristics with respect to a great variation in incidence angle (for example, a variation of 30°) and thus to realize an IR cut filter of low incidence angle dependency which can satisfactorily cope with the low profile of the imaging lens. It is also possible to realize the low incidence angle dependency using the first multilayer film formed on one surface of the substrate and to satisfactorily secure reflection characteristics of near-infrared light without greatly damaging the low incidence angle dependency using the second multilayer film formed on the opposite surface of the substrate.

### BRIEF DESCRIPTION OF DRAWINGS

FIG. 1 is a cross-sectional view schematically illustrating a configuration of an IR cut filter according to a first embodiment of the present invention.

FIG. 2 is a diagram illustrating a relationship among ΔT, Δn×nH, and acceptance or rejection of performance in a multilayer film of the IR cut filter.

FIG. 3 is a diagram illustrating a relationship among the number of cutoff adjustment pairs, the number of design solutions, and acceptance or rejection of performance in the multilayer film.

FIG. 4 is a cross-sectional view schematically illustrating another configuration of the IR cut filter.

FIG. 5 is a cross-sectional view schematically illustrating a configuration of an image capturing device to which the IR cut filter is applied.

FIG. 6 is a diagram illustrating characteristics of multilayer films of IR cut filters according to examples and comparative examples of the first embodiment together.

FIG. 7 is a diagram illustrating a film configuration of a multilayer film of an IR cut filter according to Example 1-1.

FIG. 8 is a graph illustrating spectral characteristics of the multilayer film.

FIG. 9 is a diagram illustrating a film configuration of another multilayer film which is formed on the opposite surface of the substrate of the IR cut filter to the multilayer film.

FIG. 10 is a graph illustrating spectral characteristics of another multilayer film.

FIG. 11 is a graph illustrating spectral characteristics of the IR cut filter in a double-side coated state.

FIG. 12 is a diagram illustrating characteristics of the IR cut filter in the double-side coated state.

FIG. 13 is a diagram illustrating a film configuration of a multilayer film of an IR cut filter according to Example 1-2.

FIG. 14 is a graph illustrating spectral characteristics of the multilayer film.

FIG. 15 is a diagram illustrating a film configuration of a multilayer film of an IR cut filter according to Example 1-3.

FIG. 16 is a graph illustrating spectral characteristics of the multilayer film.

FIG. 17 is a diagram illustrating a film configuration of another multilayer film which is formed on the opposite surface of the substrate of the IR cut filter to the multilayer film.

FIG. 18 is a graph illustrating spectral characteristics of another multilayer film.

FIG. 19 is a graph illustrating spectral characteristics of the IR cut filter in a double-side coated state.

FIG. 20 is a diagram illustrating characteristics of the IR cut filter in the double-side coated state.

FIG. 21 is a diagram illustrating a film configuration of a multilayer film of an IR cut filter according to Example 1-4.

FIG. 22 is a graph illustrating spectral characteristics of the multilayer film.

FIG. 23 is a diagram illustrating a film configuration of a multilayer film of an IR cut filter according to Example 1-5.

FIG. 24 is a graph illustrating spectral characteristics of the multilayer film.

FIG. 25 is a diagram illustrating a film configuration of a multilayer film of an IR cut filter according to Example 1-6.

FIG. 26 is a graph illustrating spectral characteristics of the multilayer film.

FIG. 27 is a diagram illustrating a film configuration of a multilayer film of an IR cut filter according to Example 1-7.

FIG. 28 is a graph illustrating spectral characteristics of the multilayer film.

FIG. 29 is a diagram illustrating a film configuration of a multilayer film of an IR cut filter according to Example 1-8.

FIG. 30 is a graph illustrating spectral characteristics of the multilayer film.

FIG. 31 is a diagram illustrating a film configuration of a multilayer film of an IR cut filter according to Example 1-9.

FIG. 32 is a graph illustrating spectral characteristics of the multilayer film.

FIG. 33 is a diagram illustrating a film configuration of a multilayer film of an IR cut filter according to Comparative Example 1-1.

FIG. 34 is a graph illustrating spectral characteristics of the multilayer film.

FIG. 35 is a diagram illustrating a film configuration of a multilayer film of an IR cut filter according to Comparative Example 1-2.

FIG. 36 is a graph illustrating spectral characteristics of the multilayer film.

FIG. 37 is a diagram illustrating a film configuration of a multilayer film of an IR cut filter according to Comparative Example 1-3.

FIG. 38 is a graph illustrating spectral characteristics of the multilayer film.

FIG. 39 is a diagram illustrating a film configuration of a multilayer film of an IR cut filter according to Comparative Example 1-4.

FIG. 40 is a graph illustrating spectral characteristics of the multilayer film.

FIG. 43 is a diagram illustrating a film configuration of a multilayer film of an IR cut filter according to Comparative Example 1-5.

FIG. 42 is a graph illustrating spectral characteristics of the multilayer film.

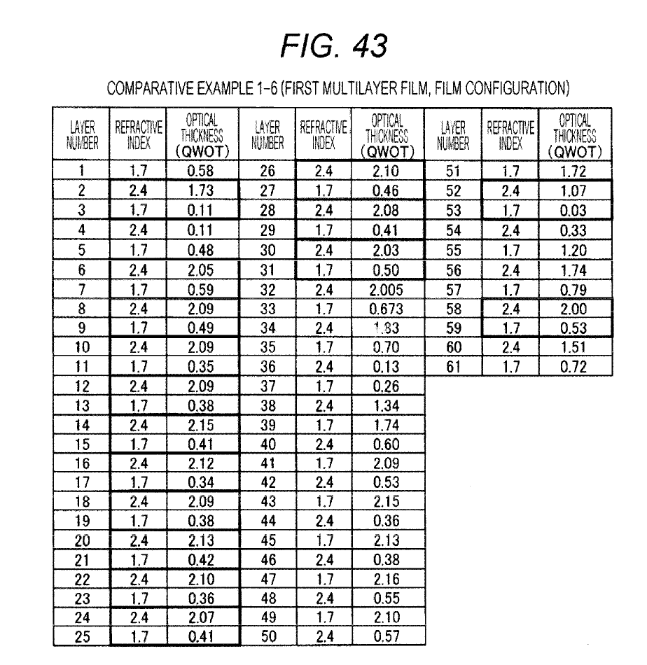

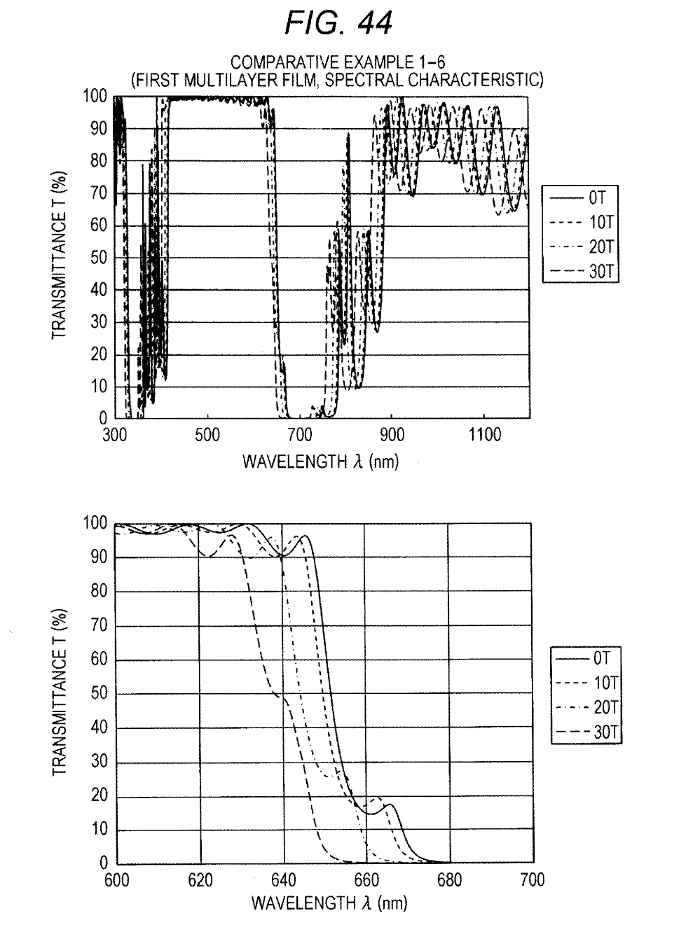

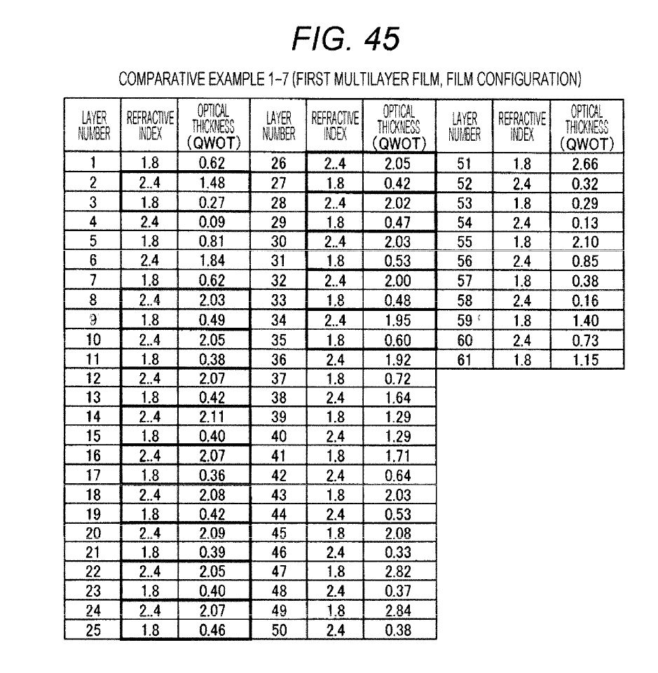

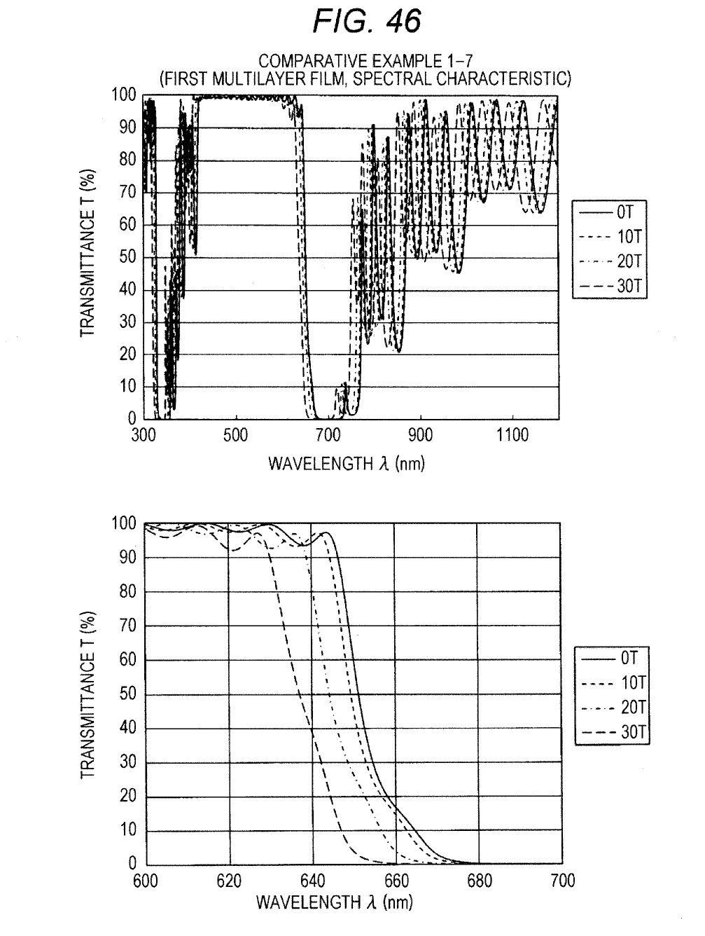

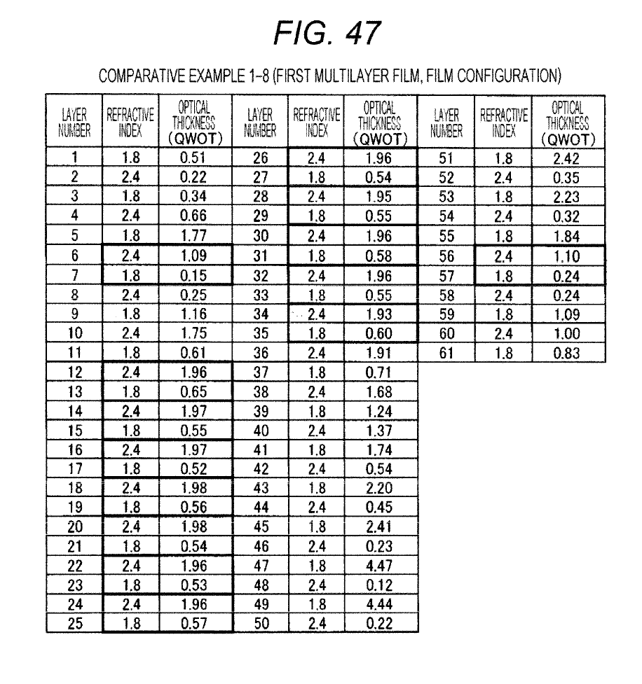

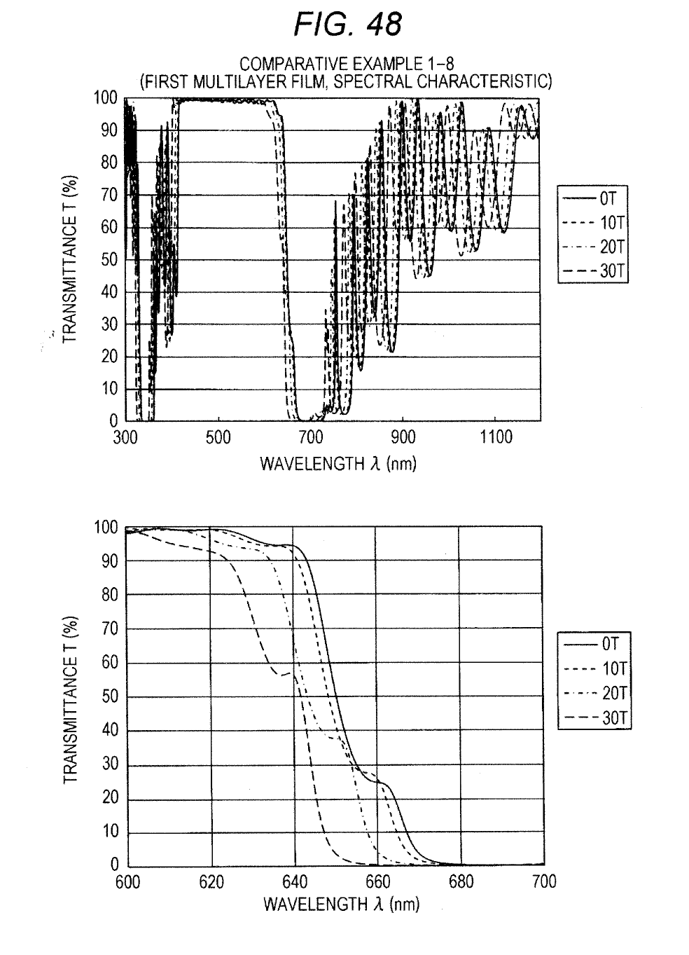

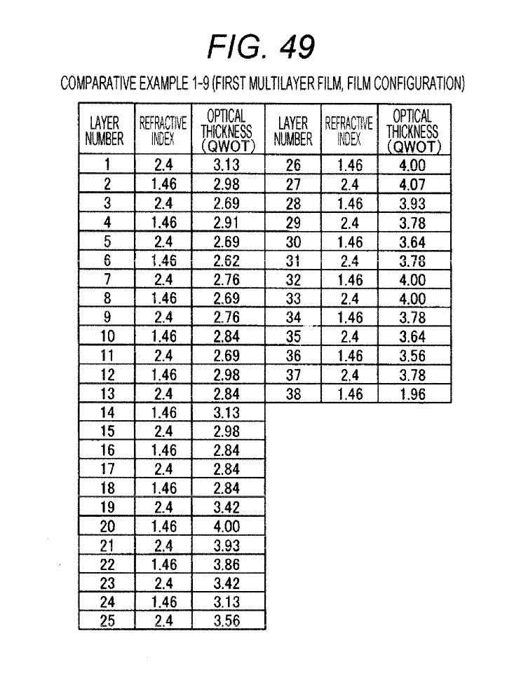

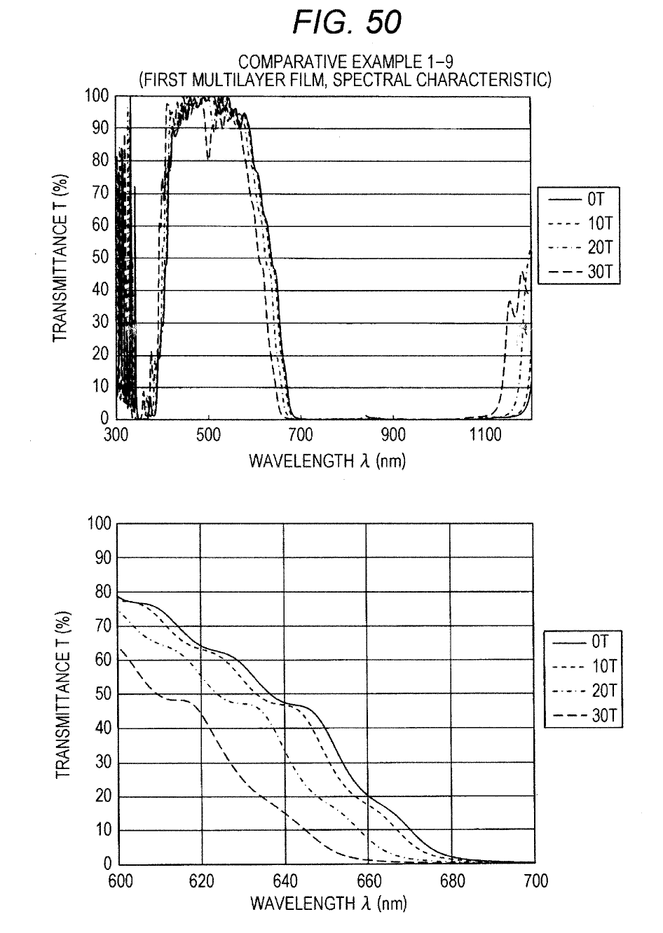

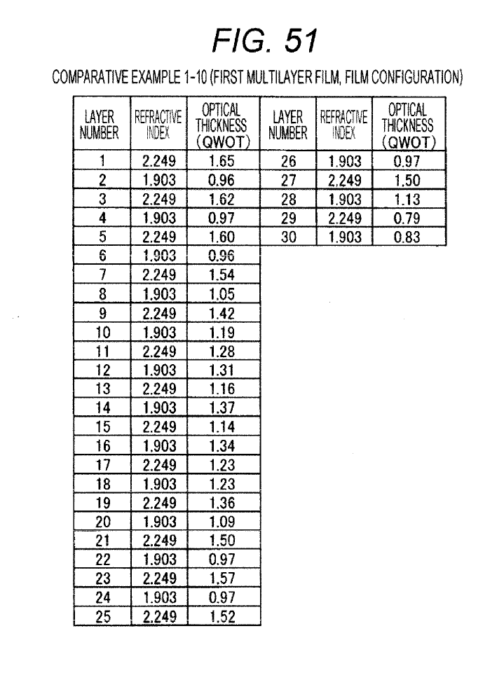

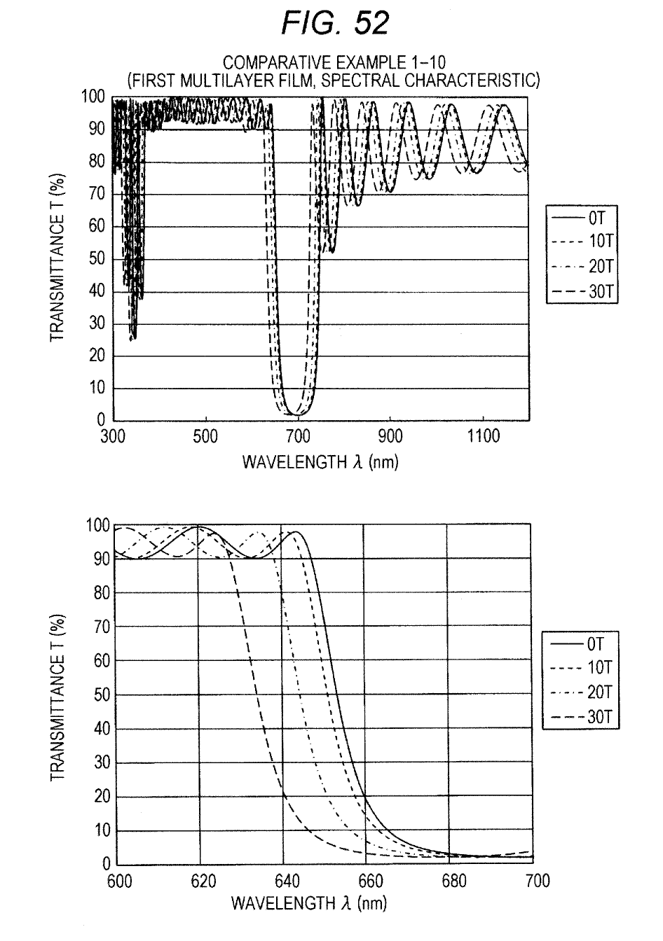

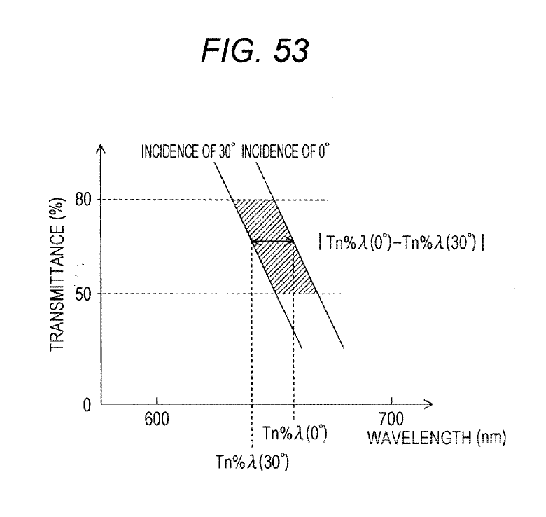

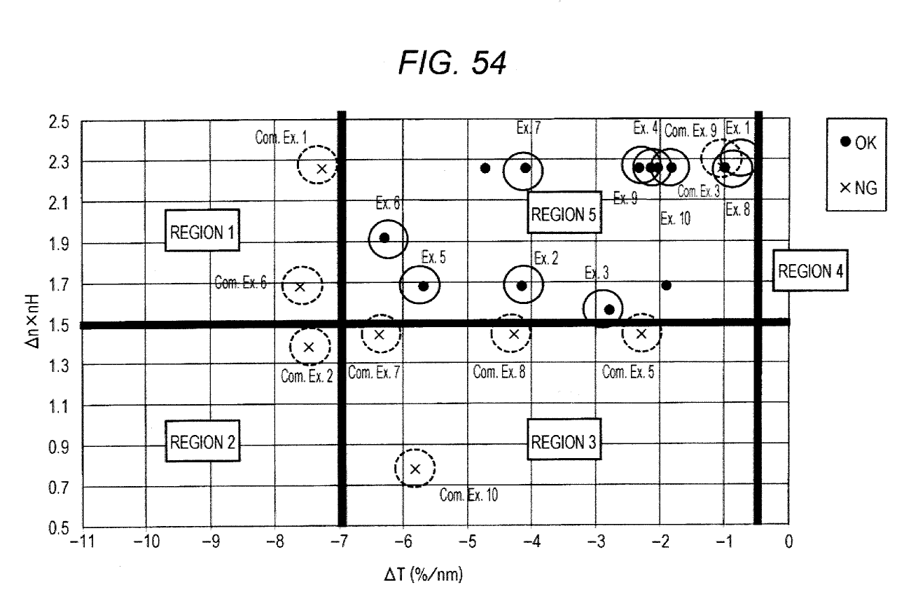

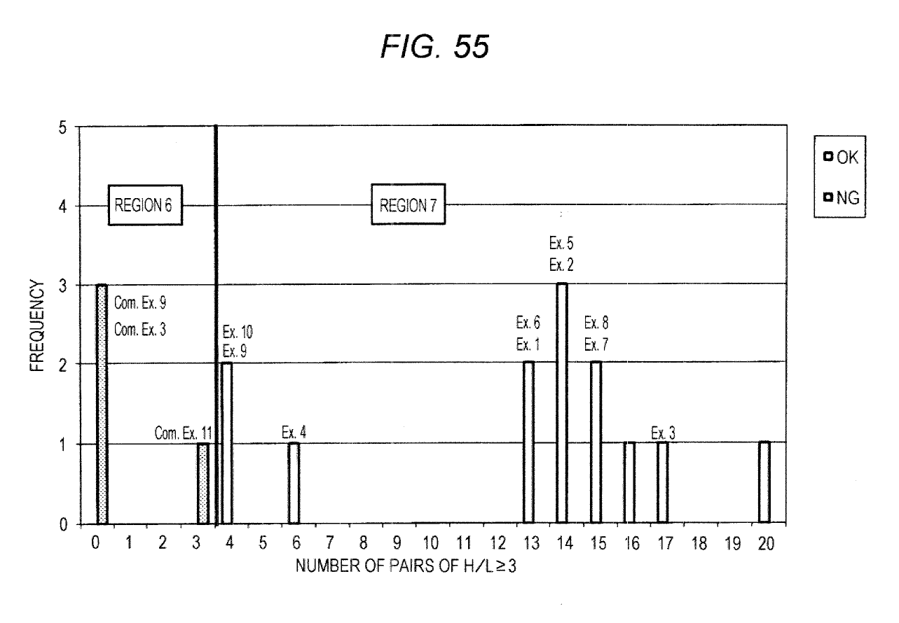

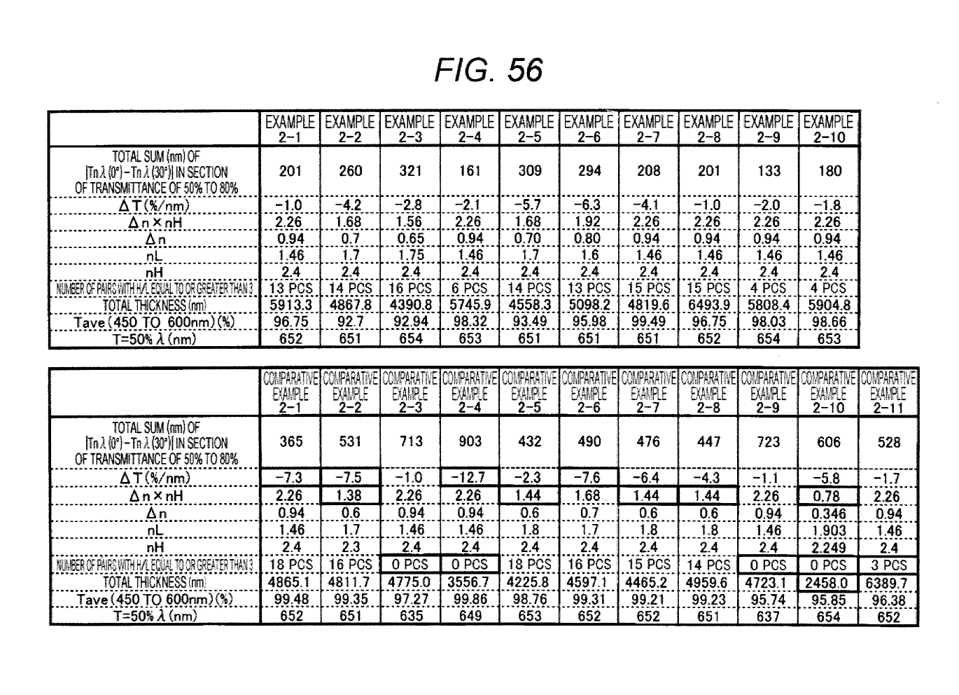

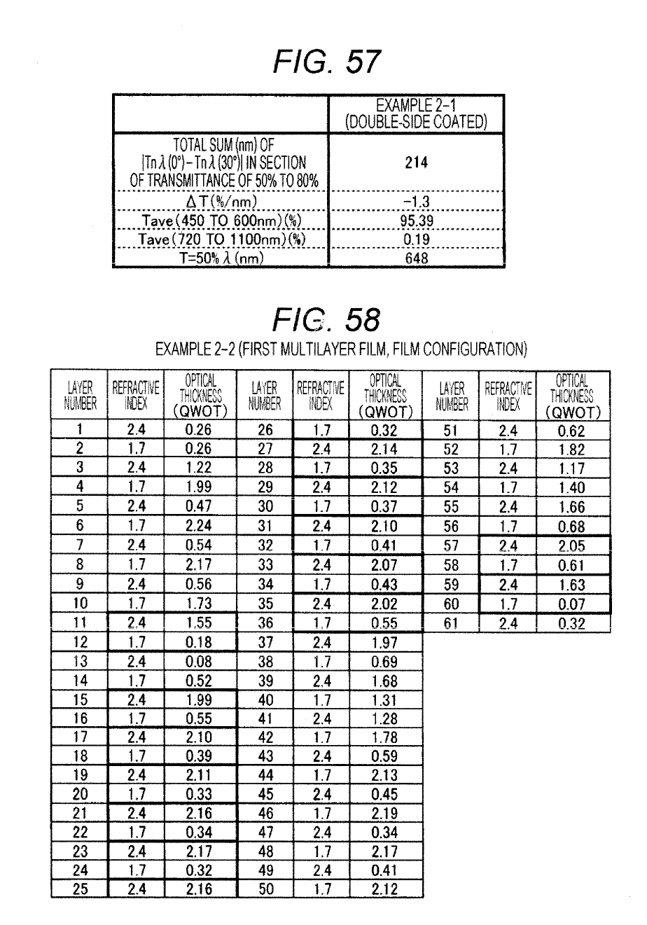

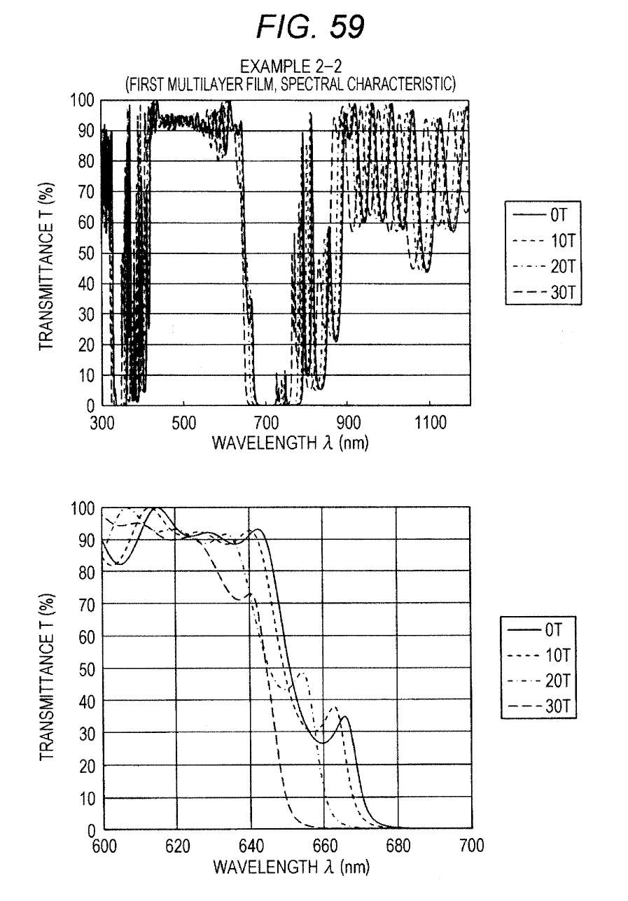

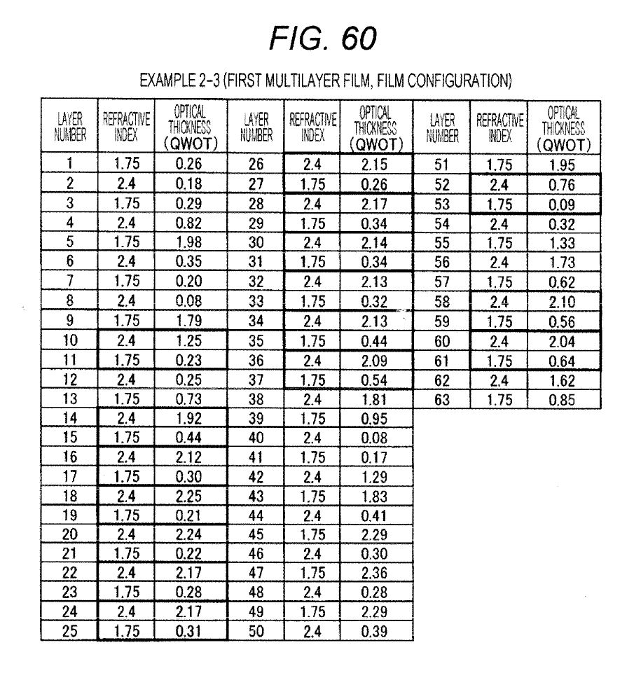

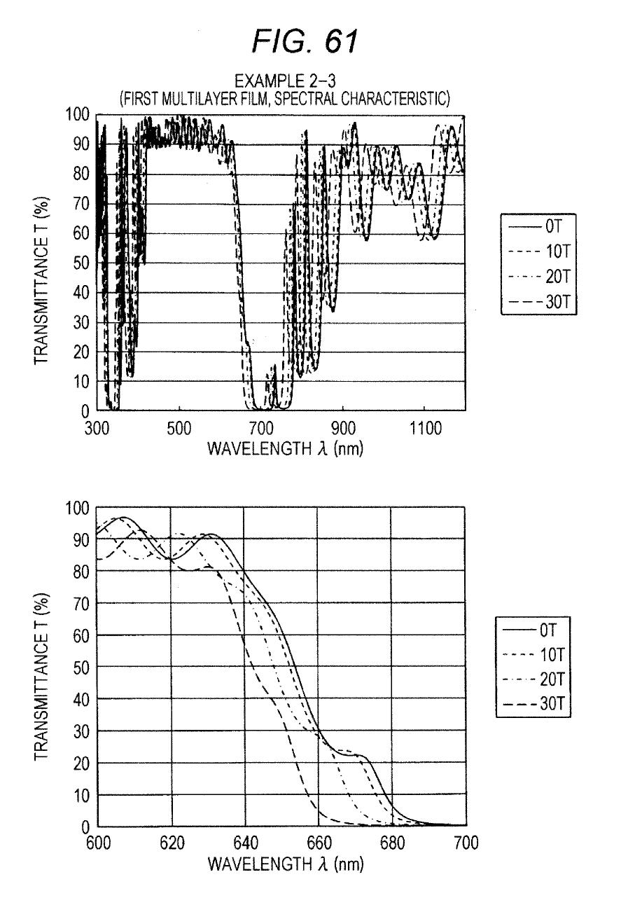

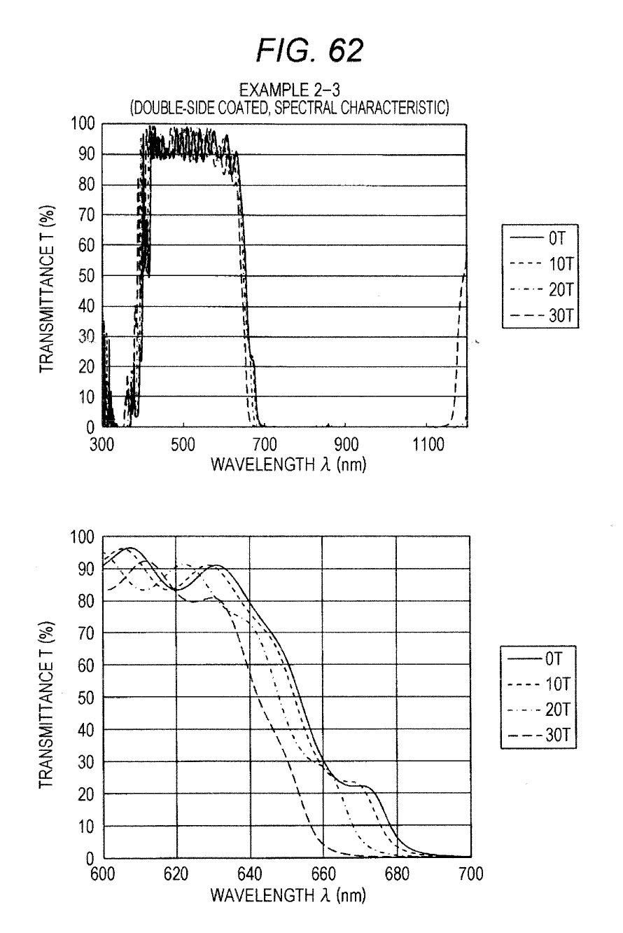

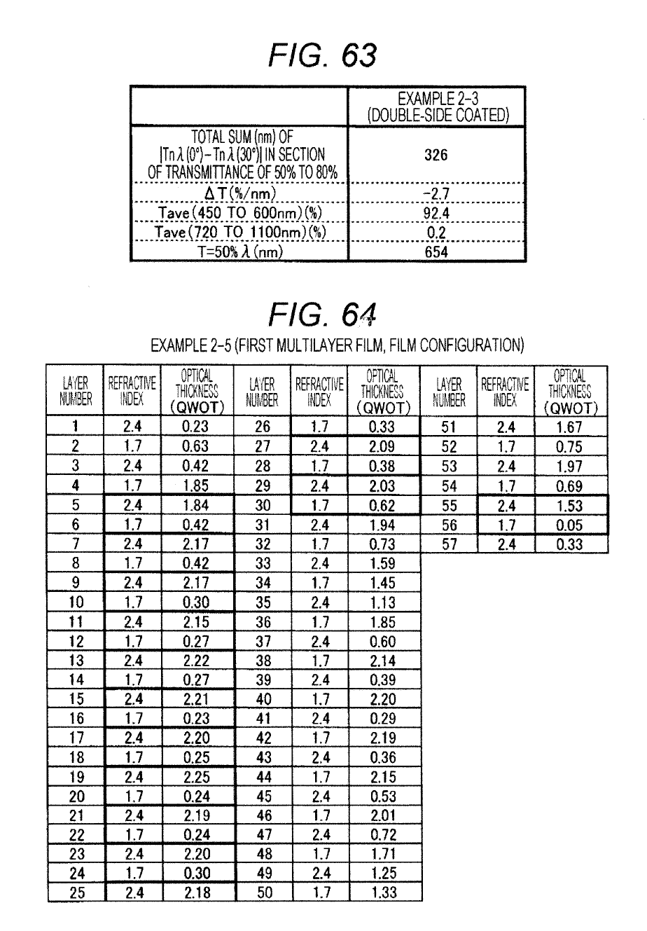

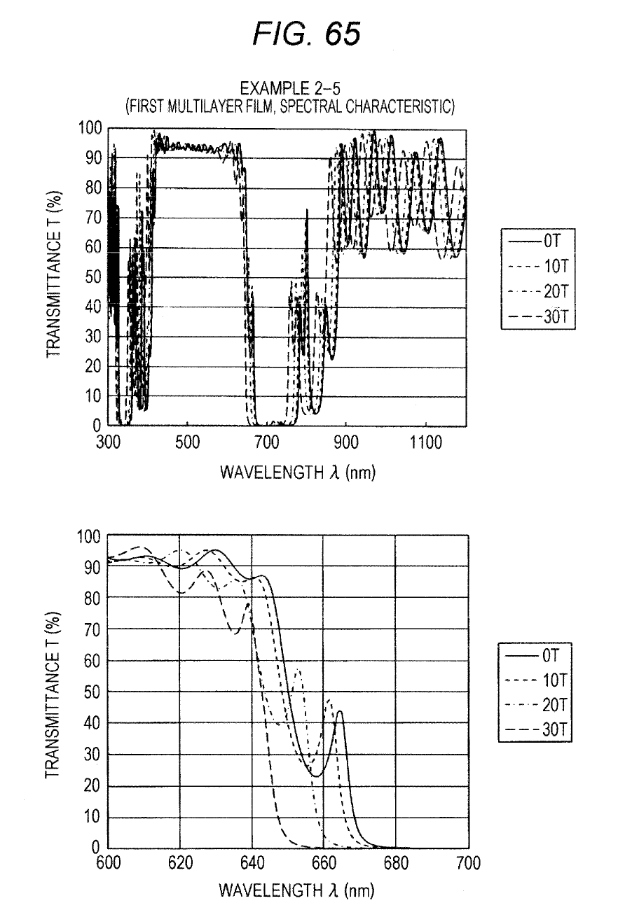

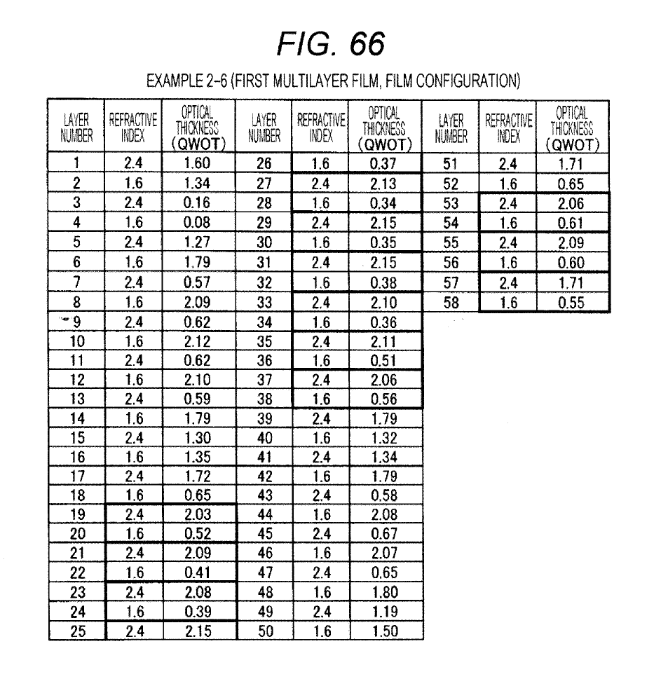

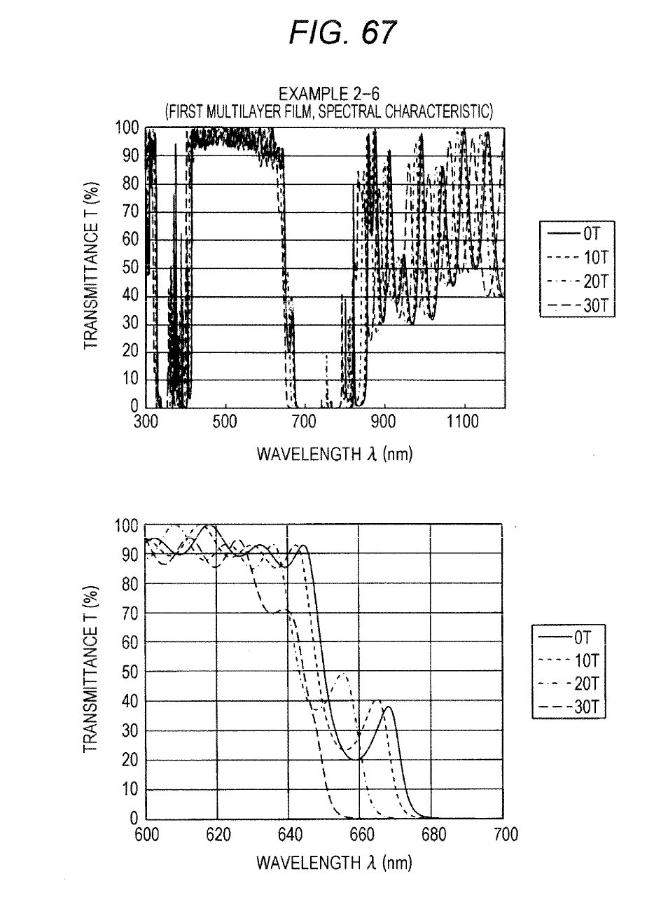

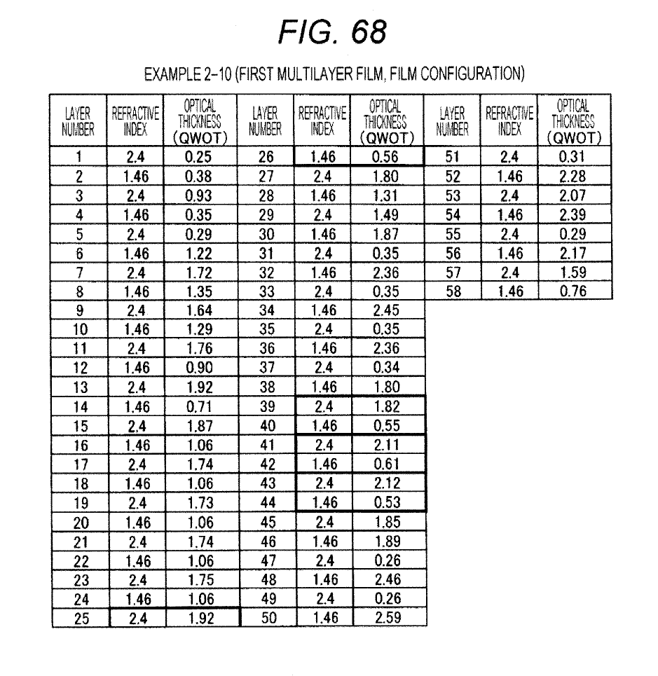

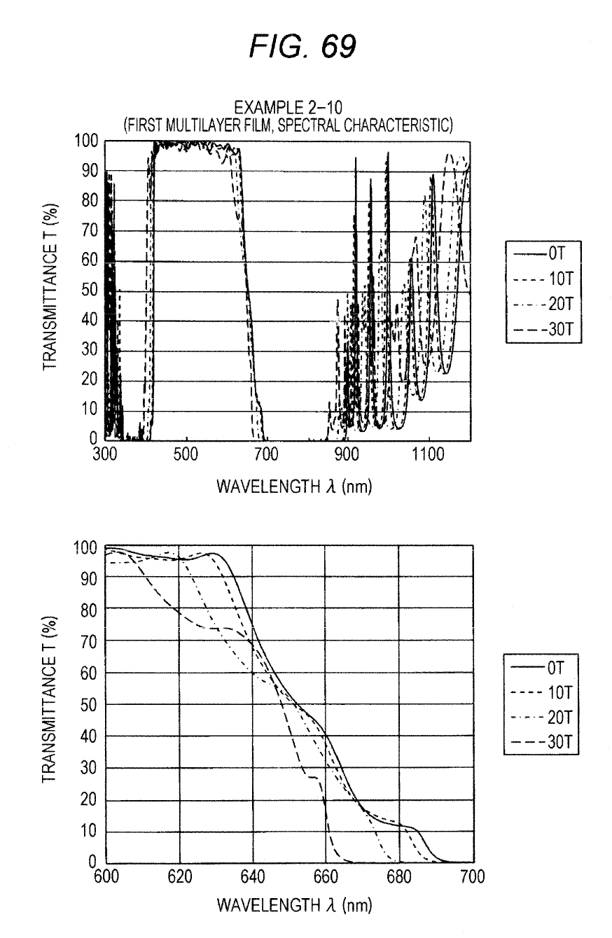

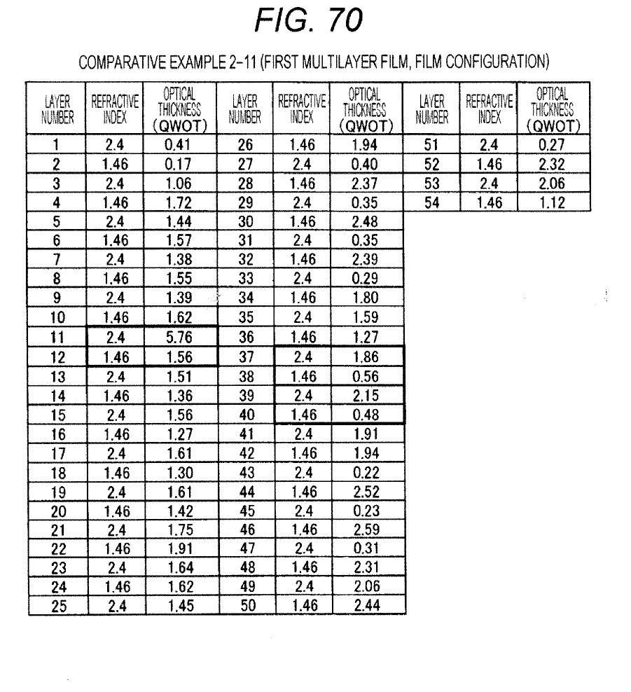

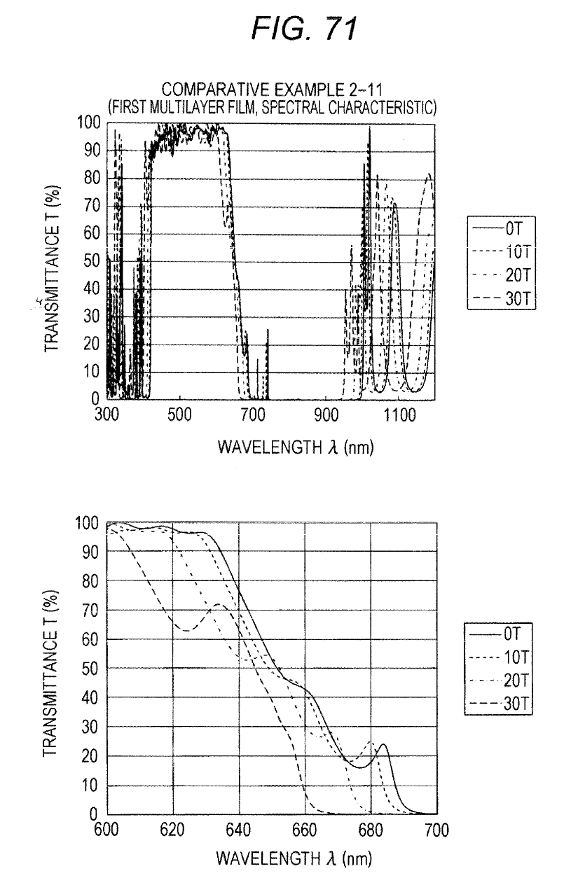

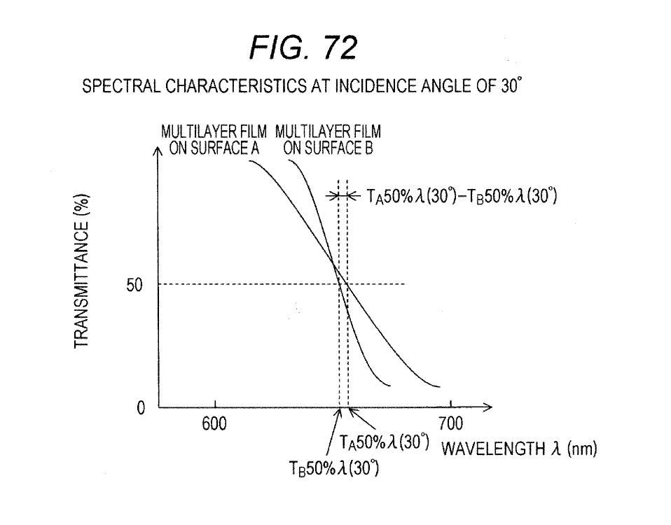

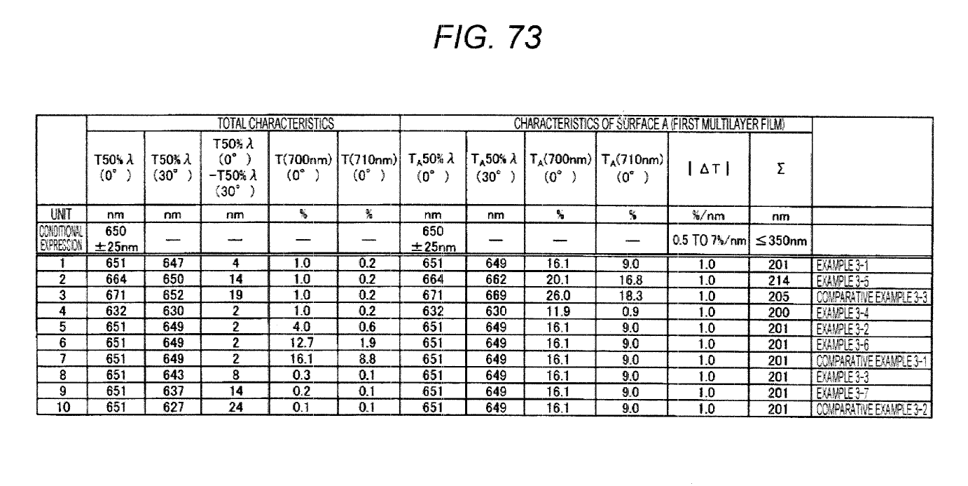

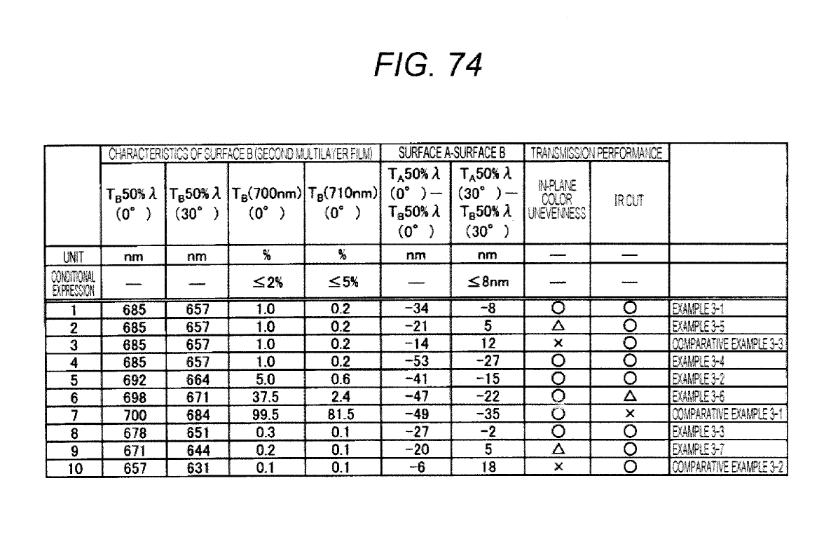

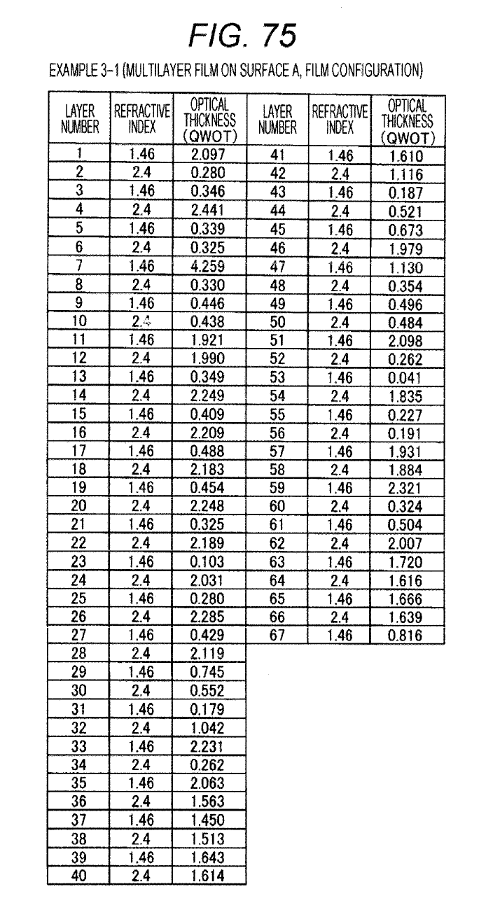

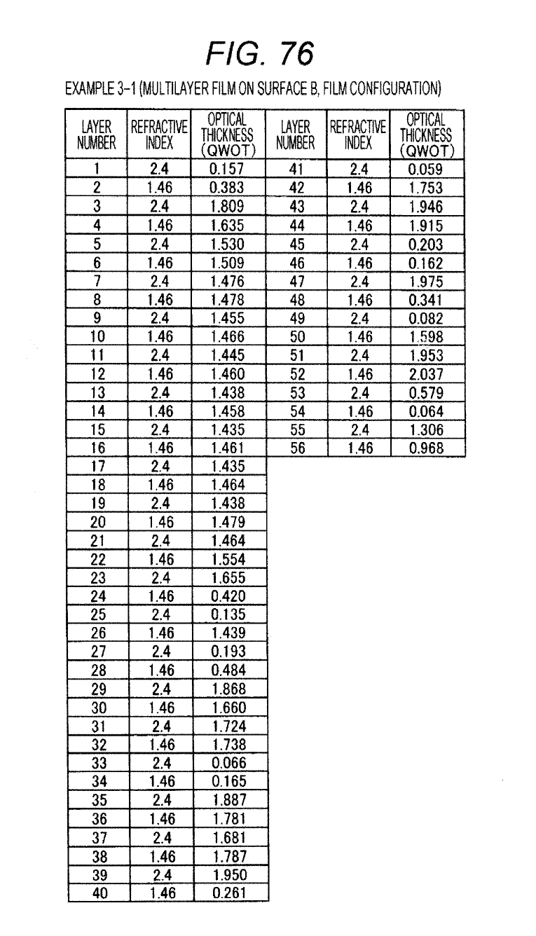

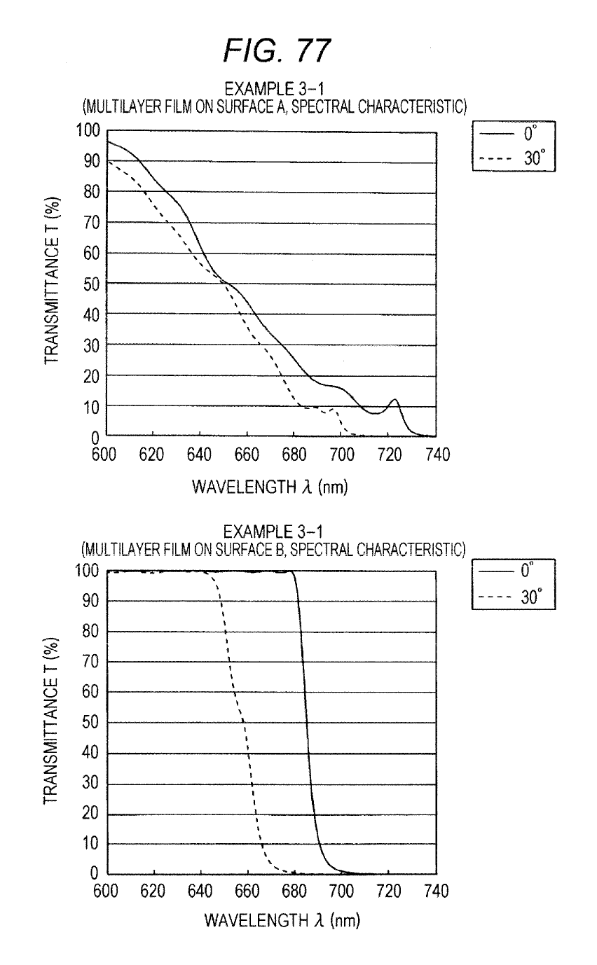

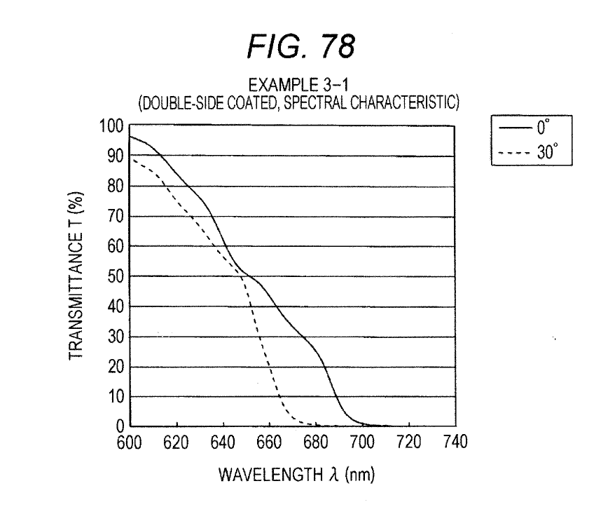

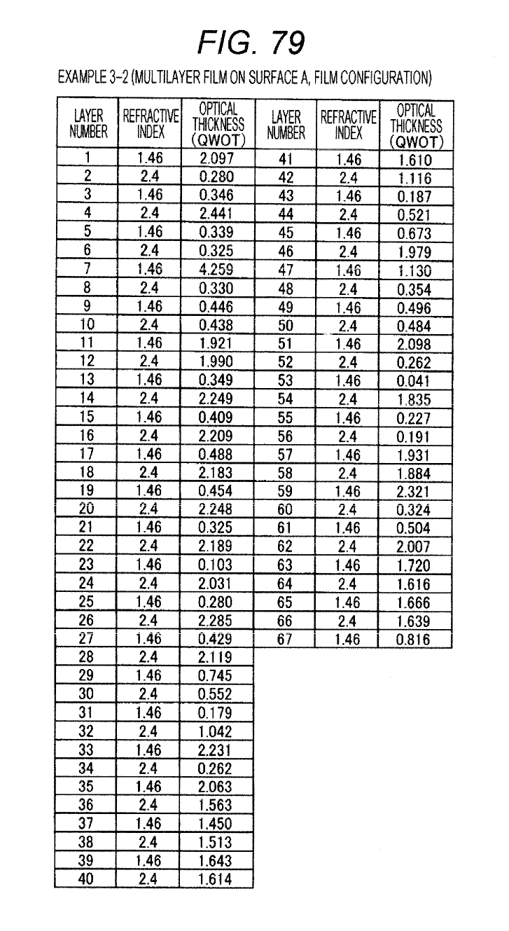

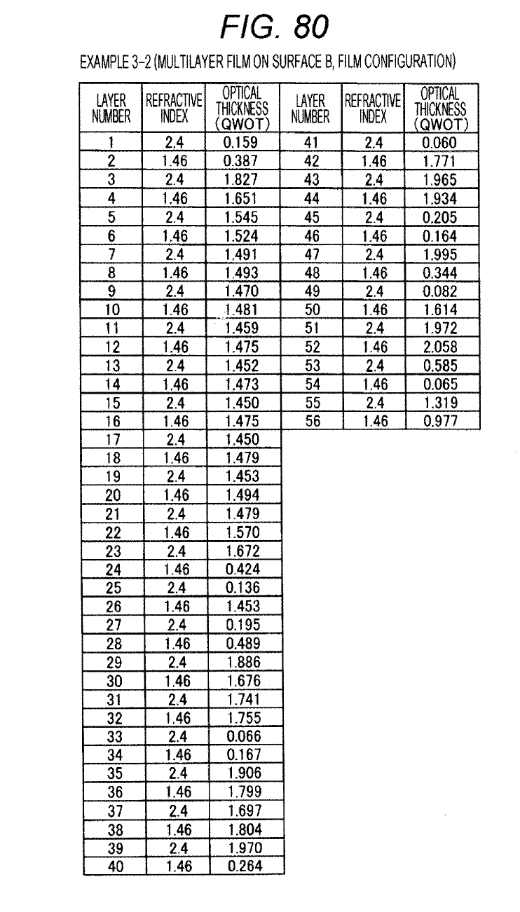

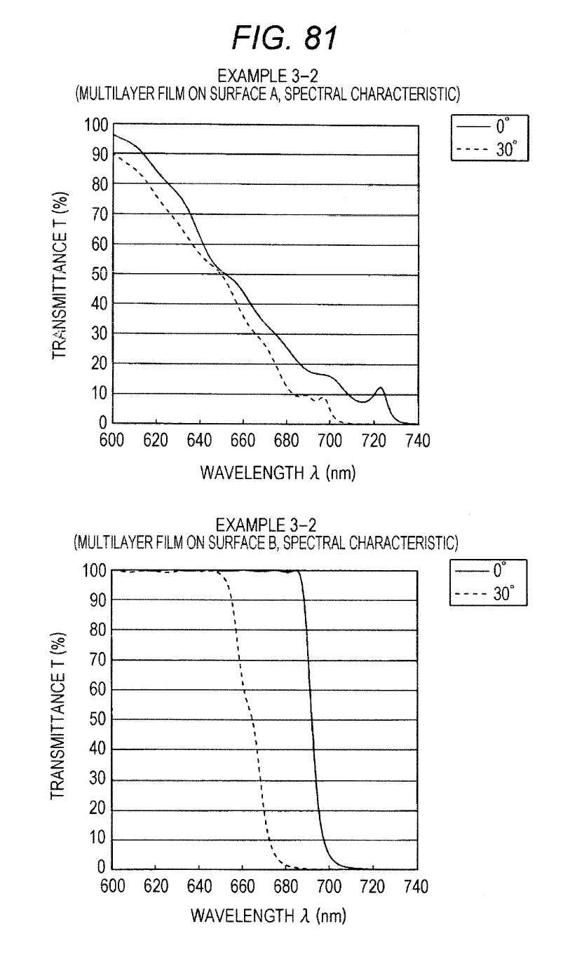

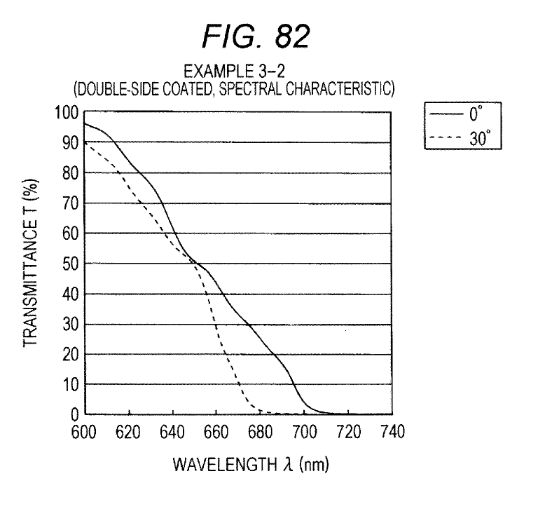

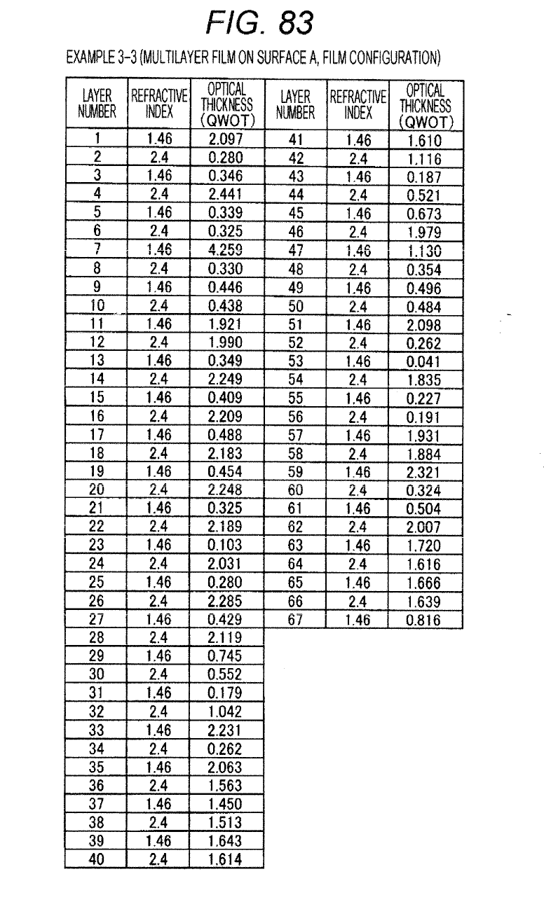

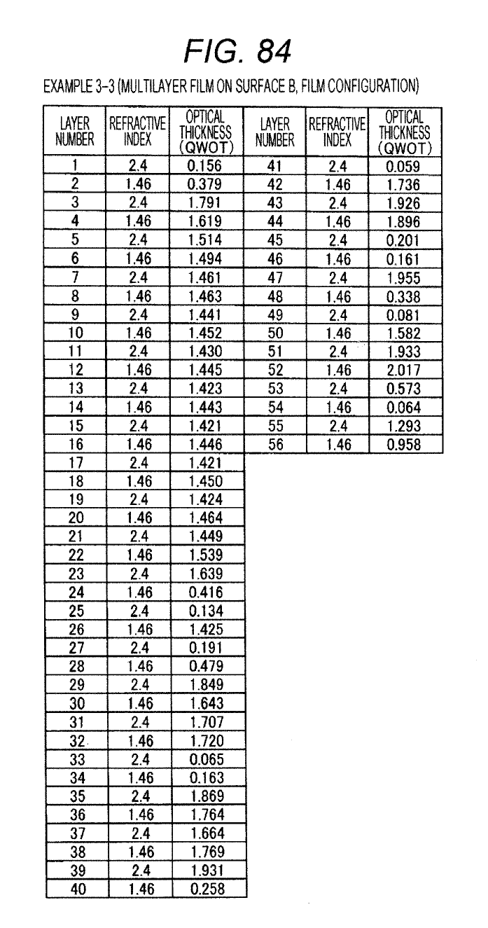

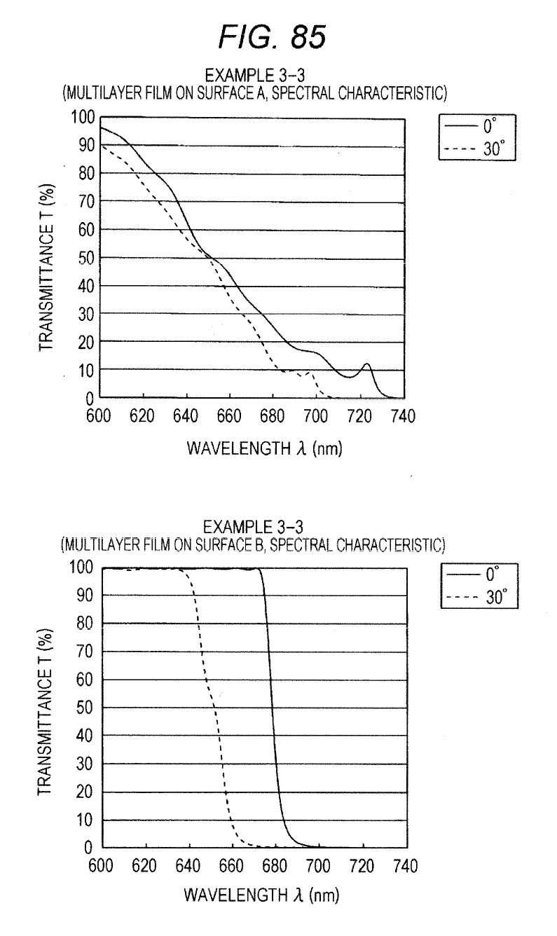

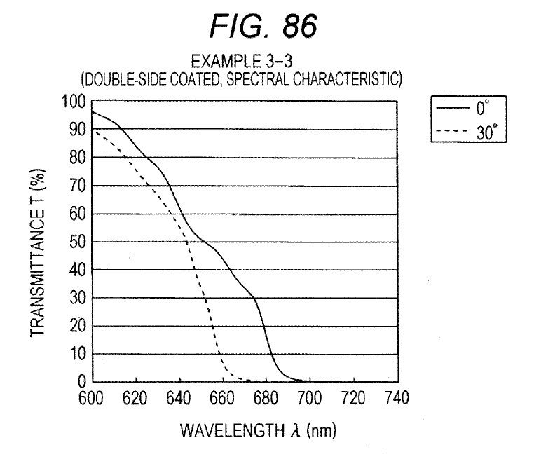

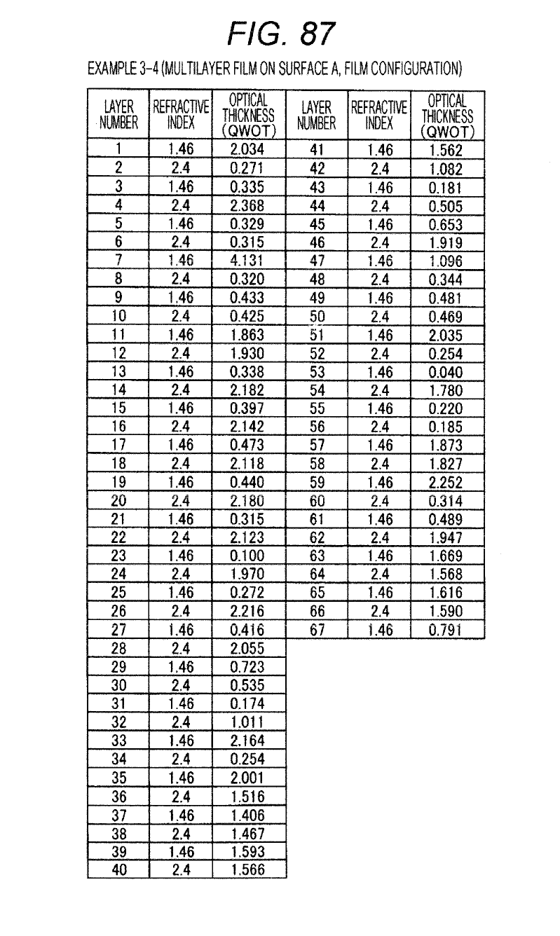

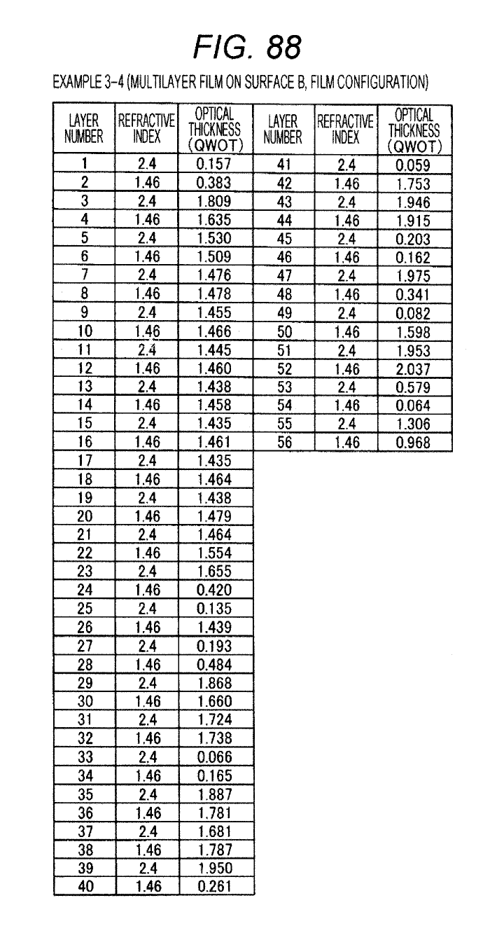

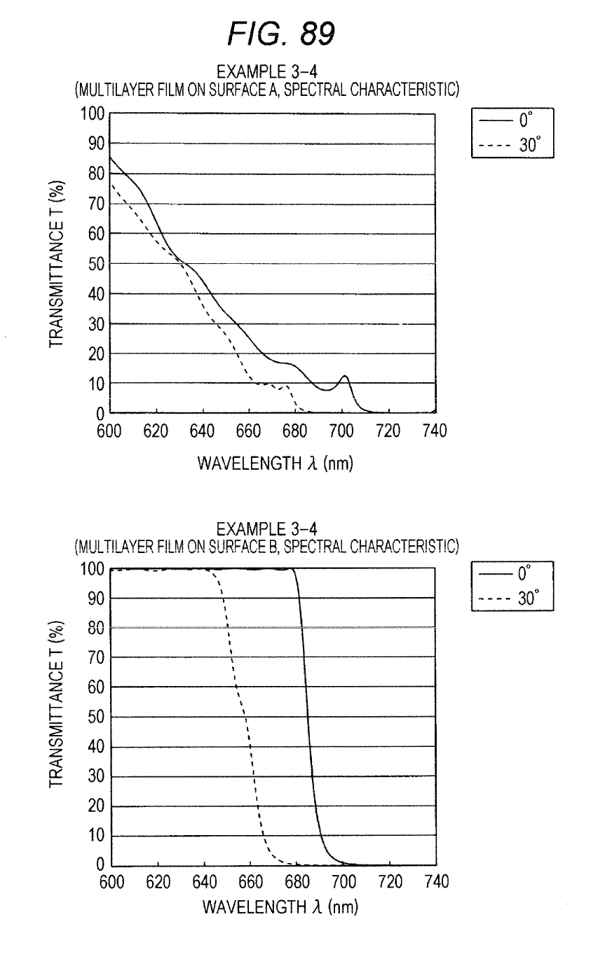

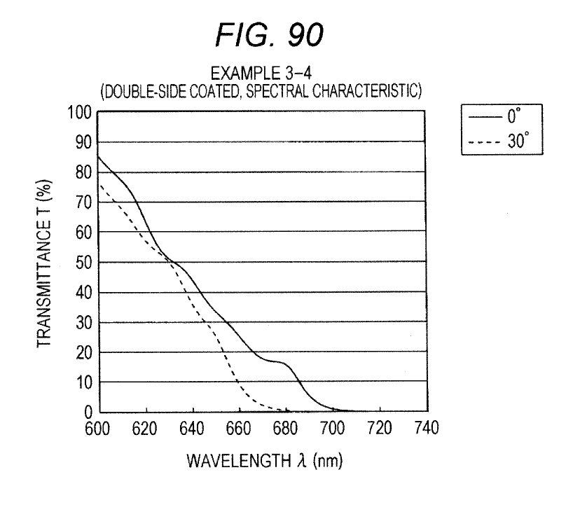

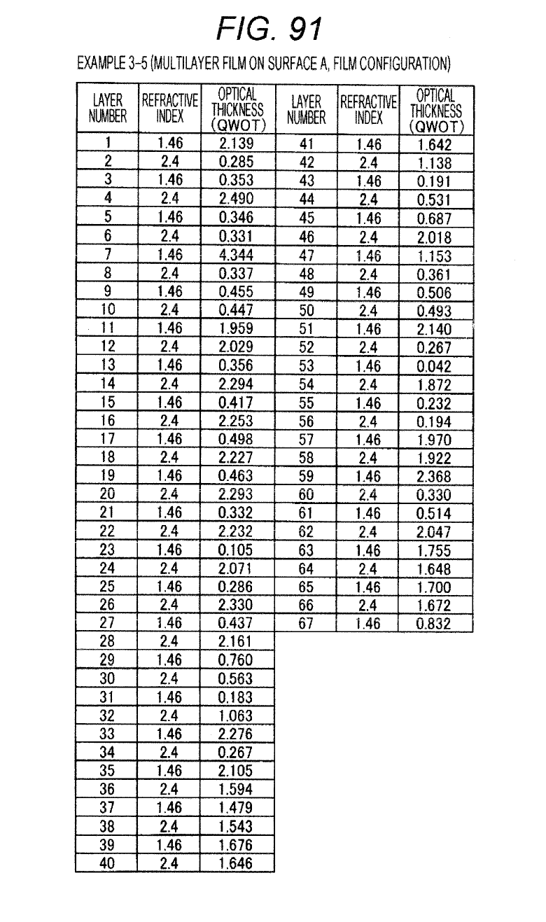

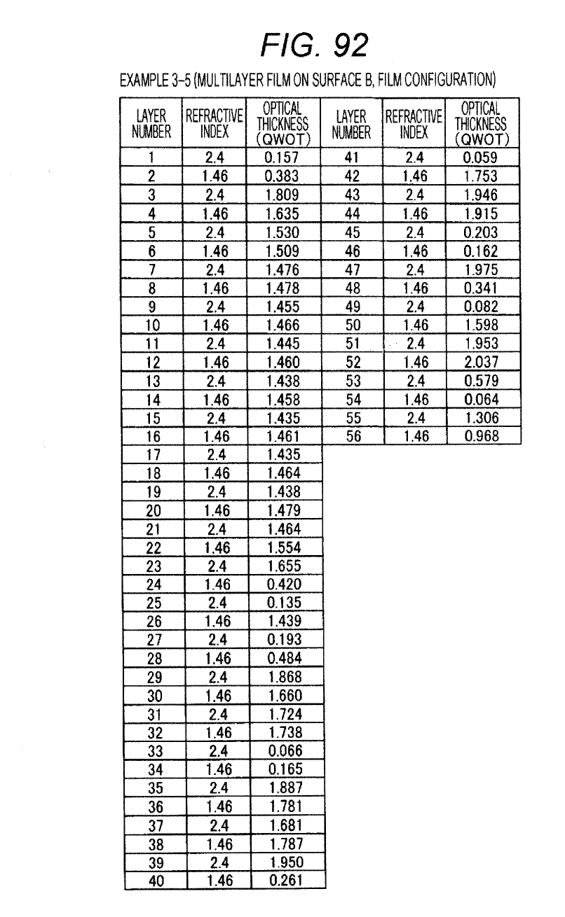

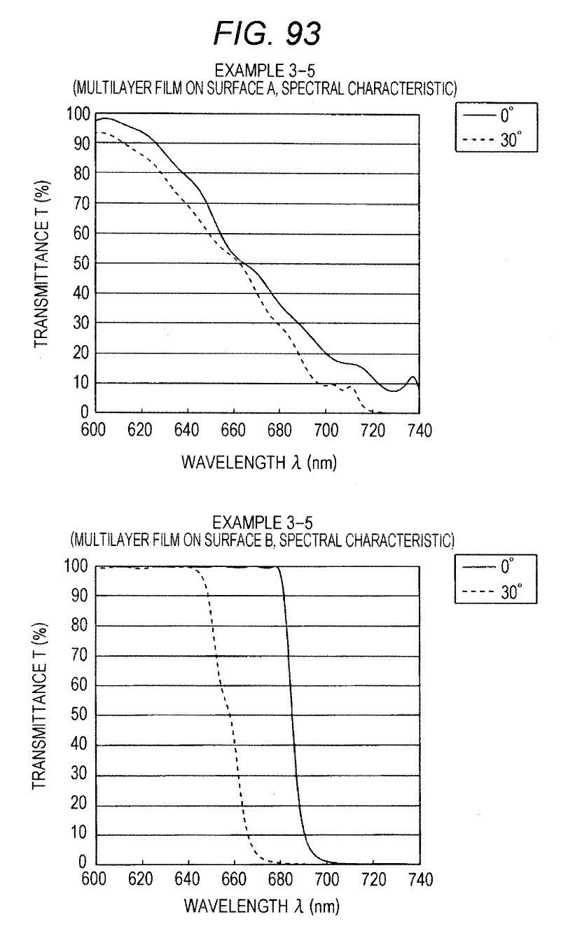

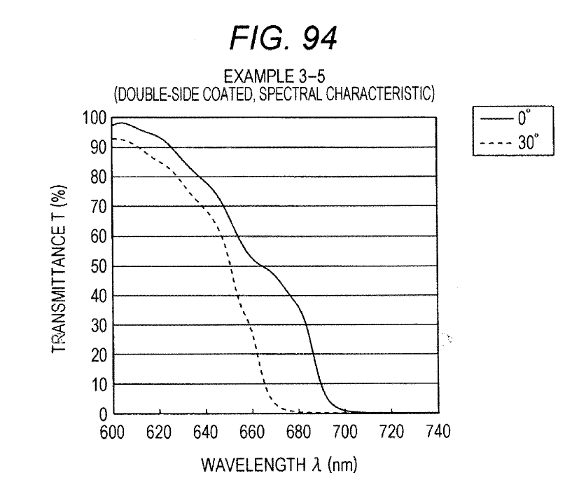

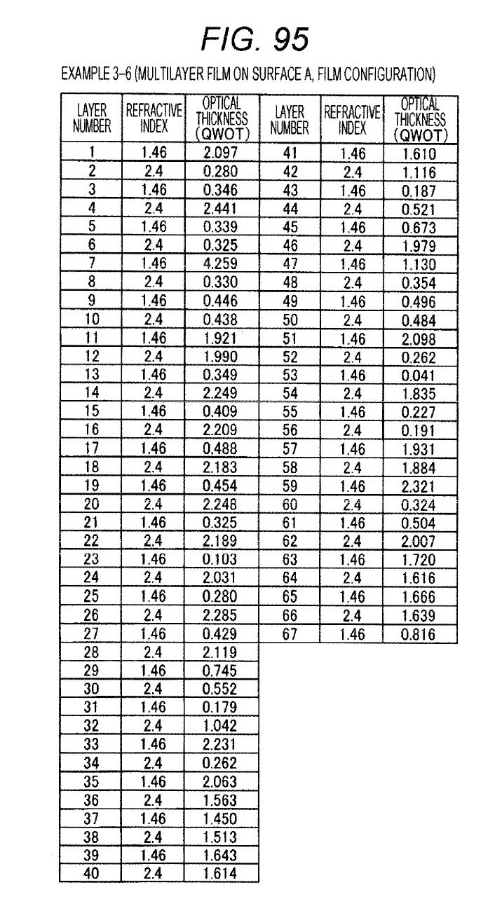

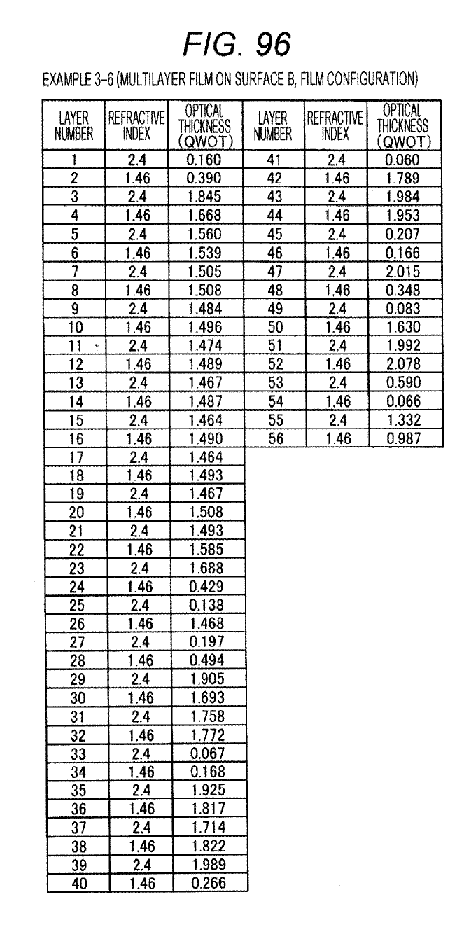

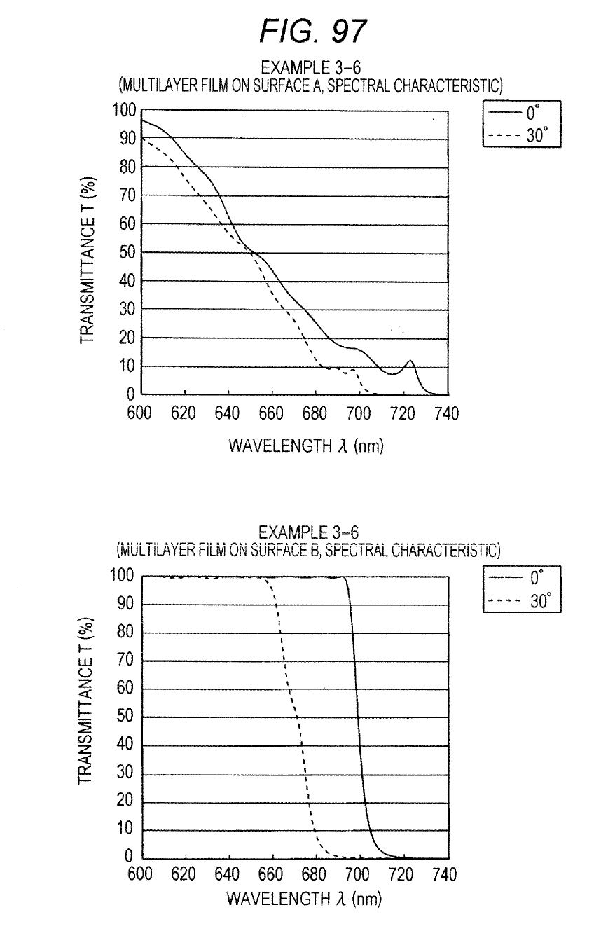

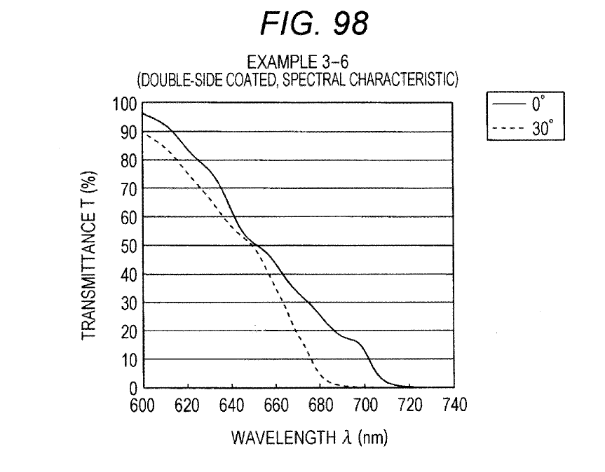

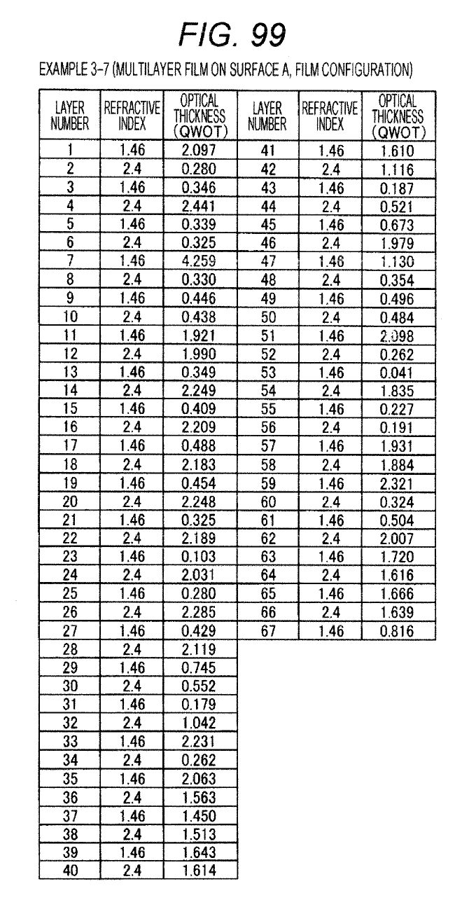

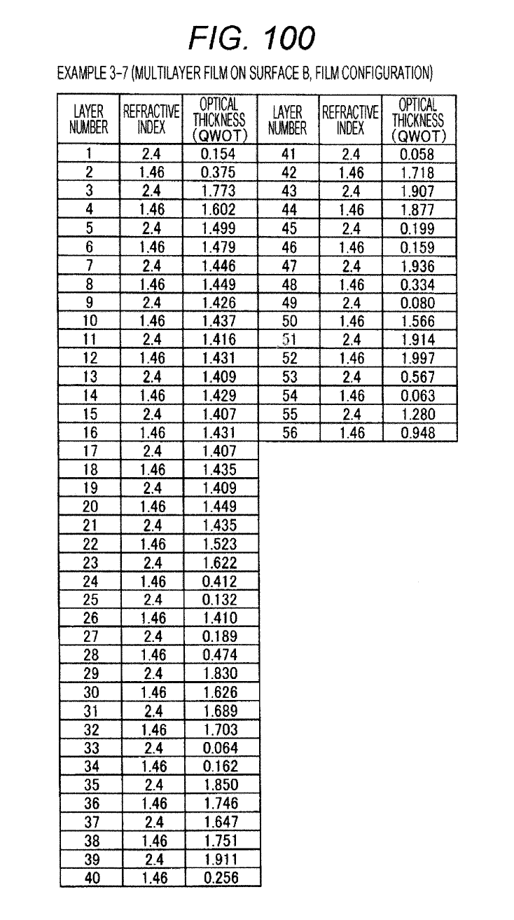

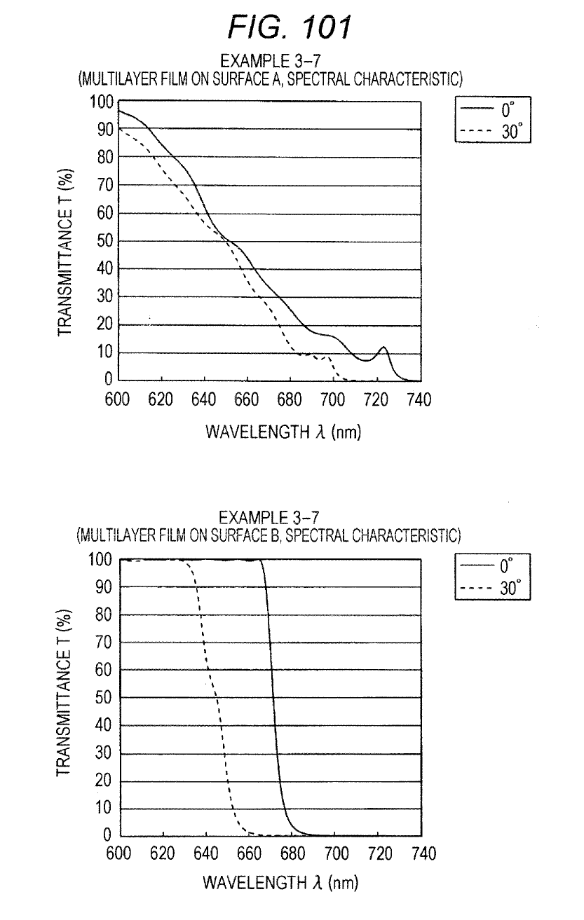

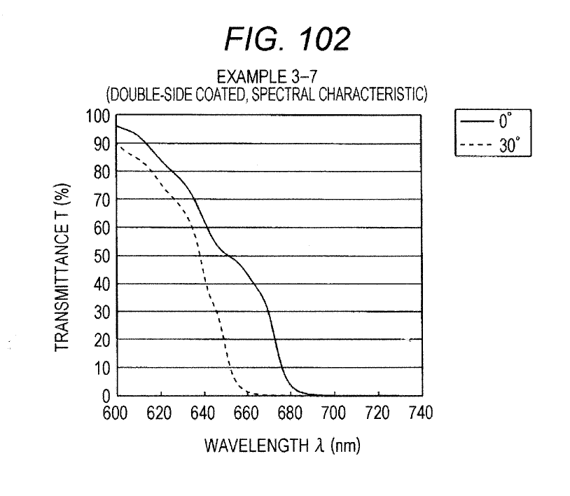

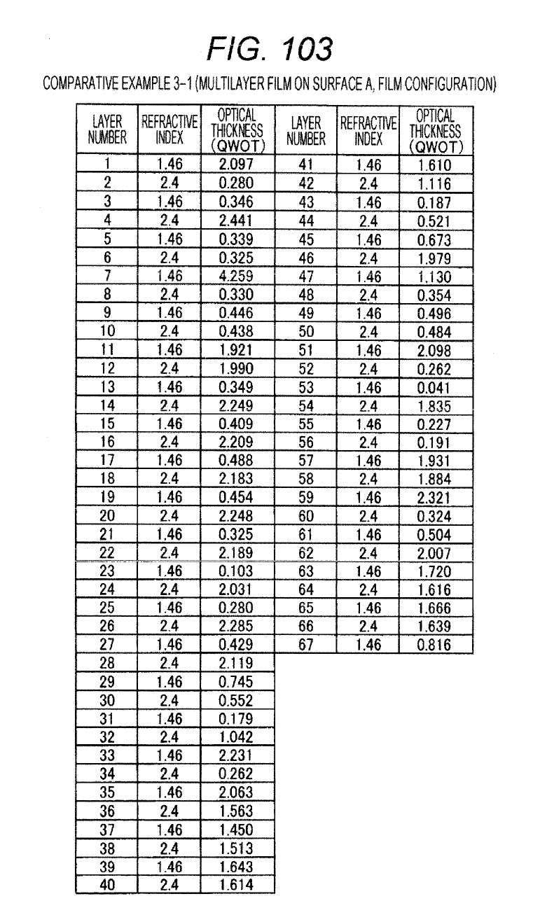

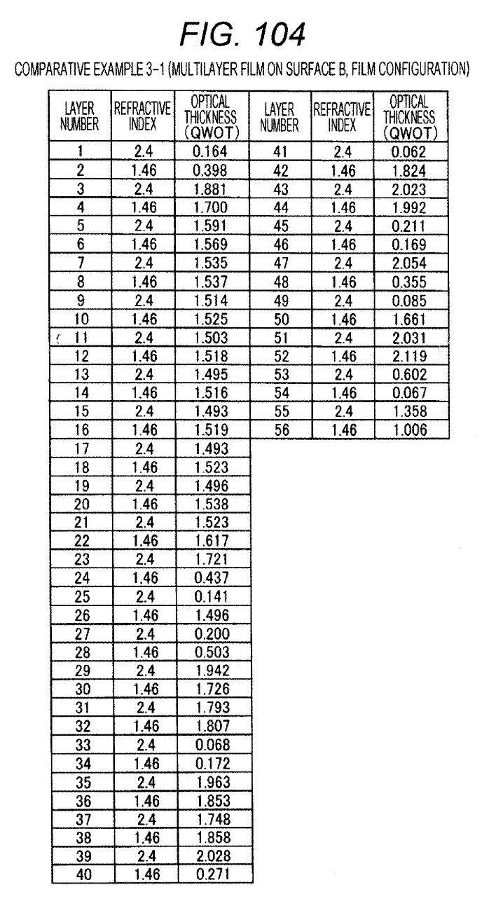

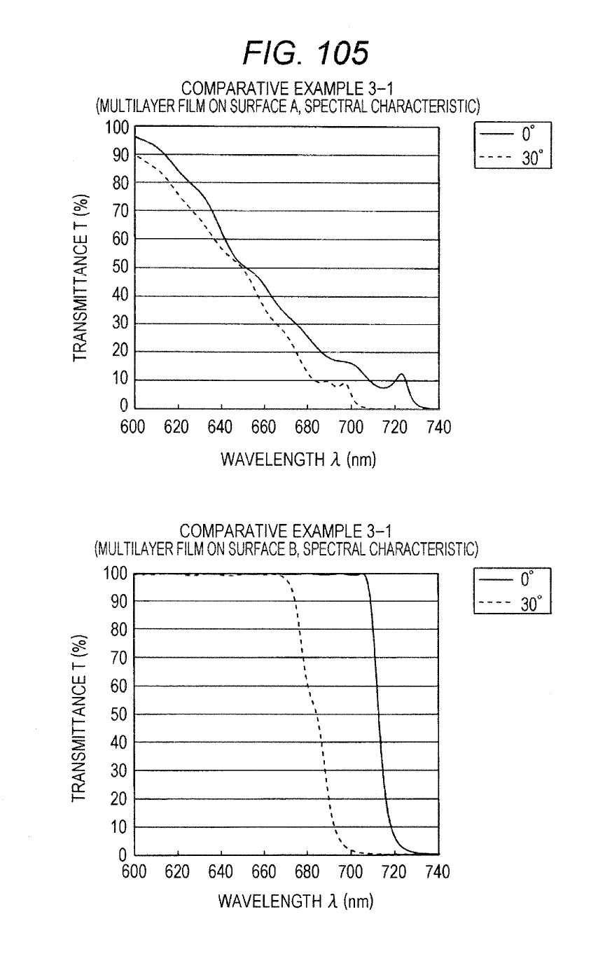

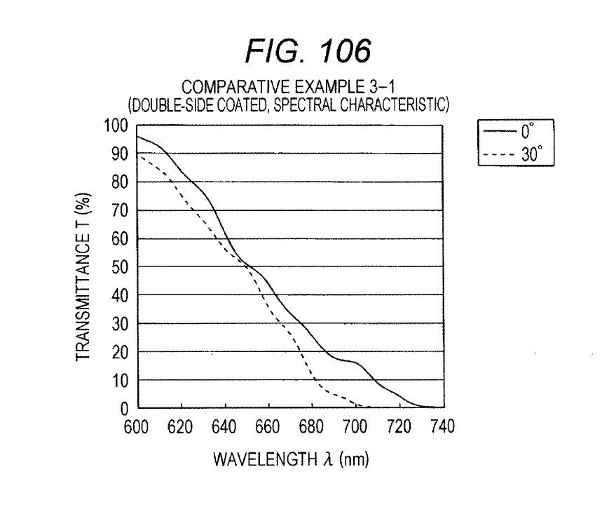

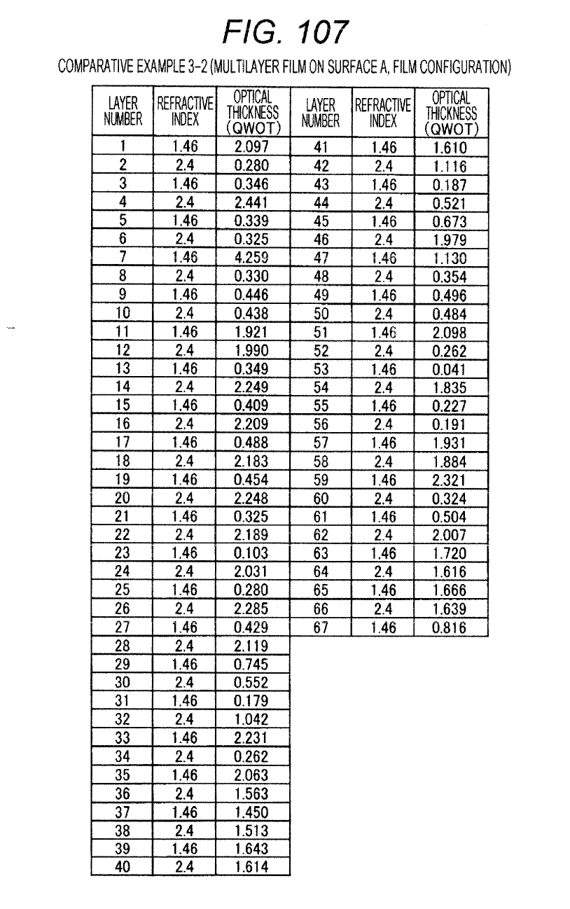

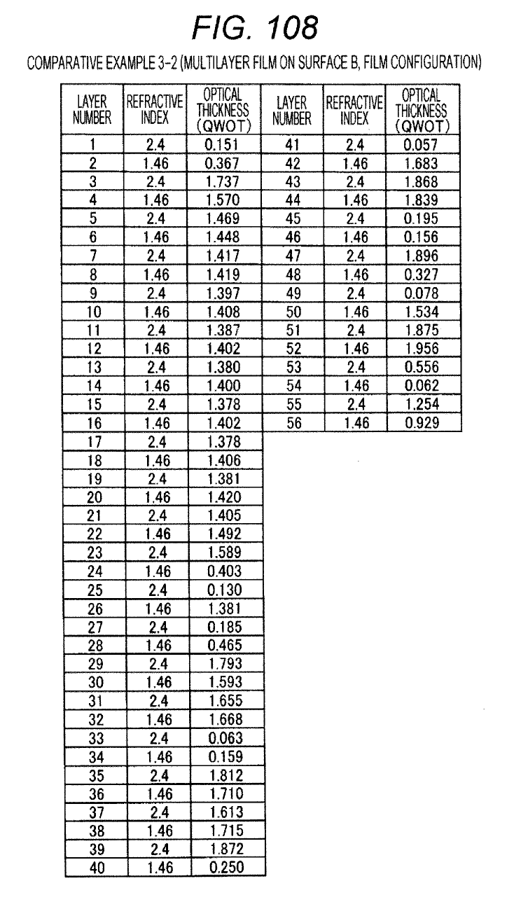

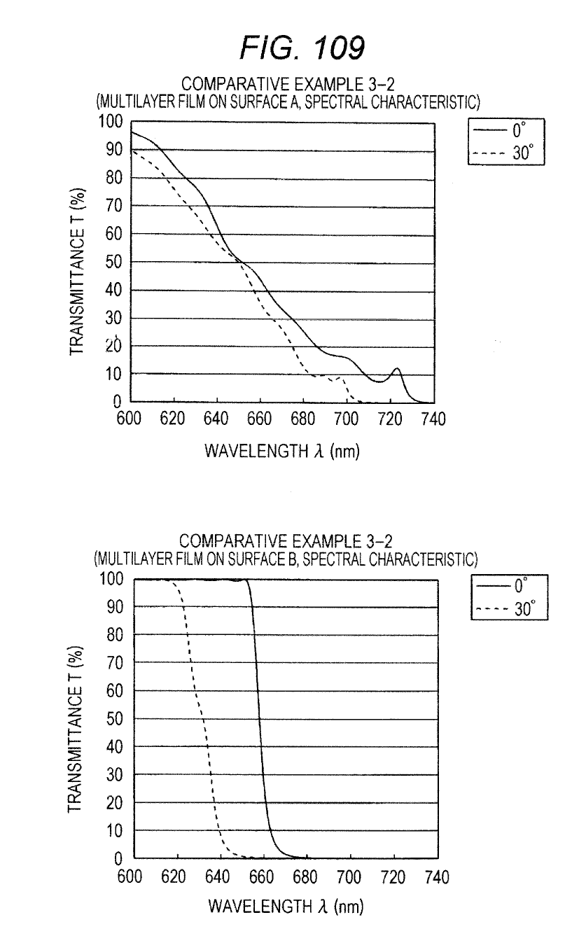

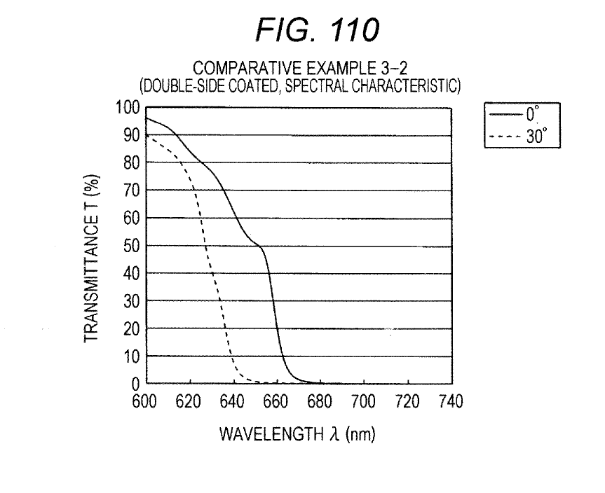

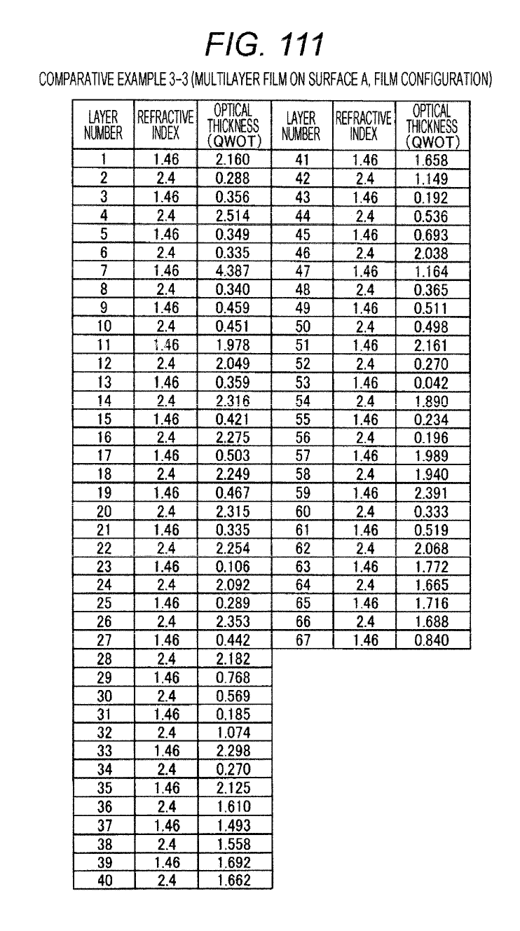

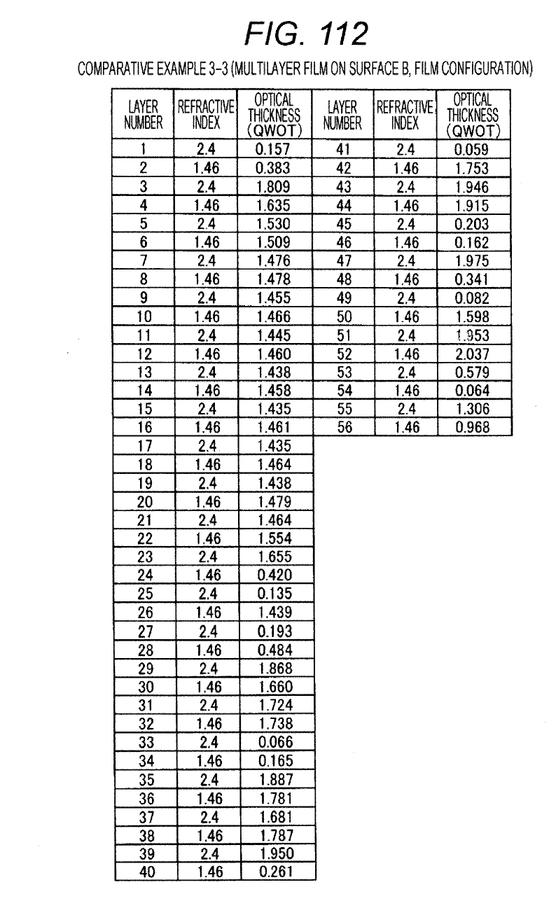

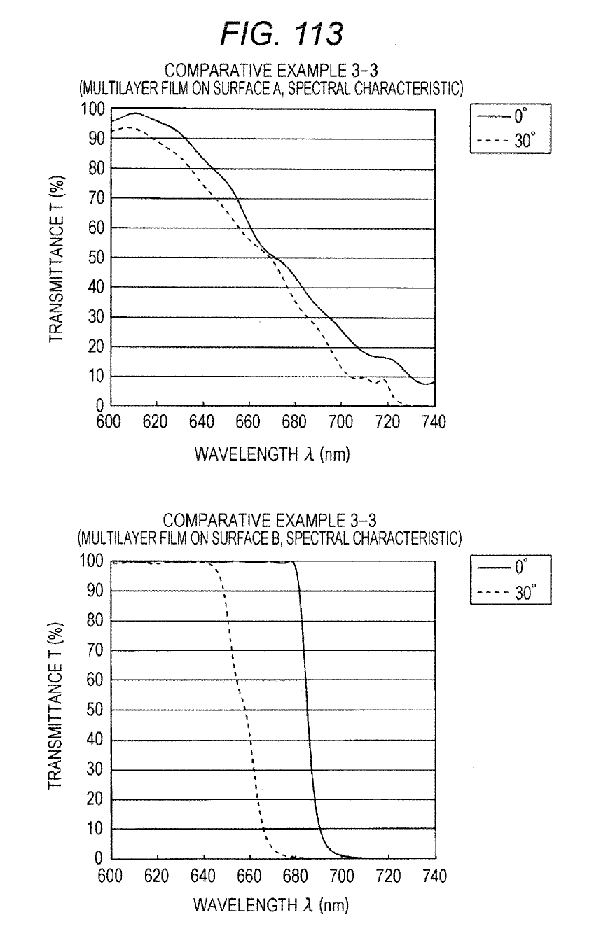

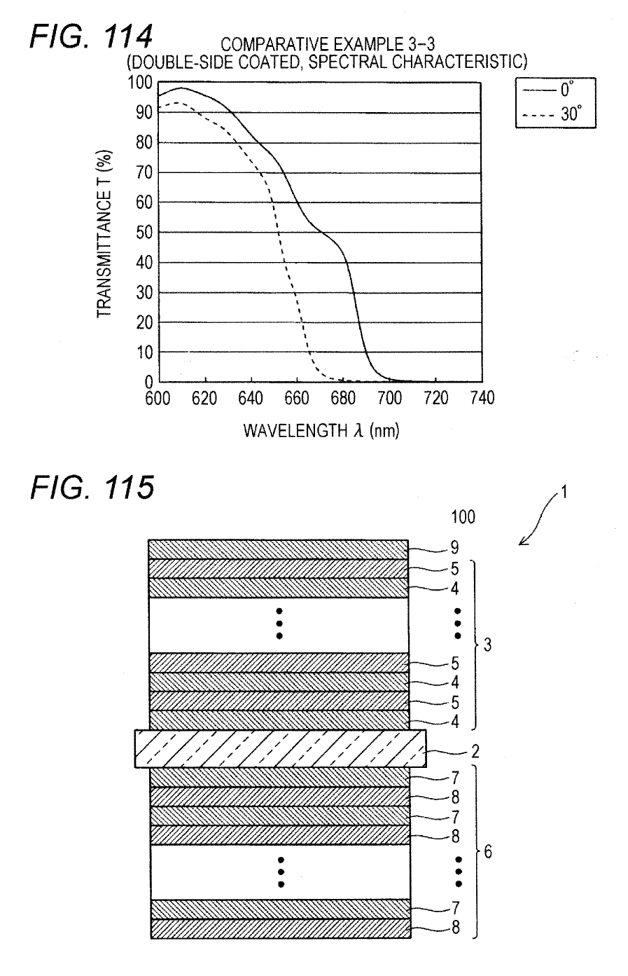

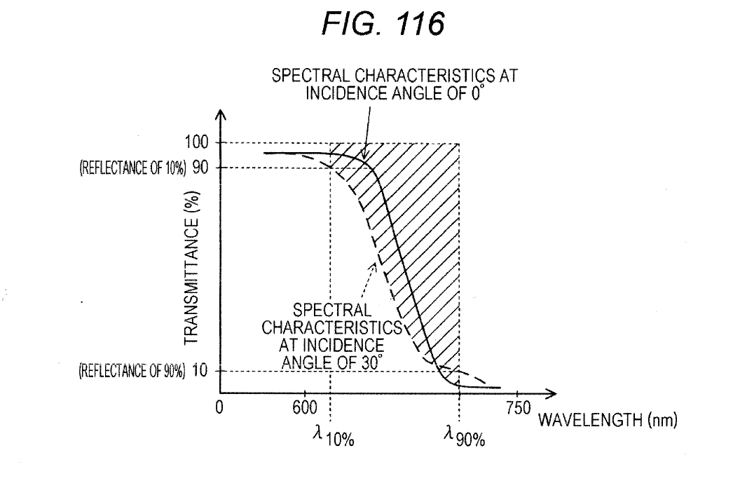

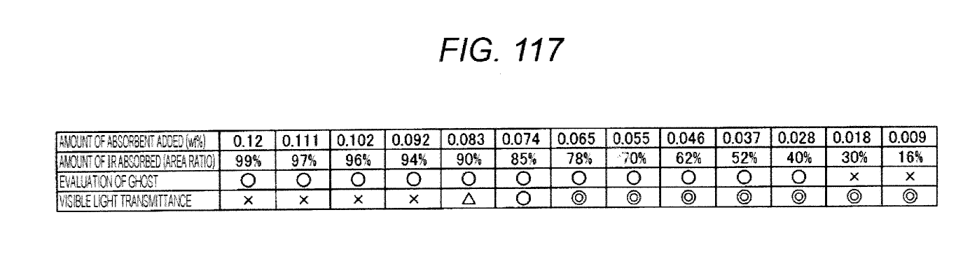

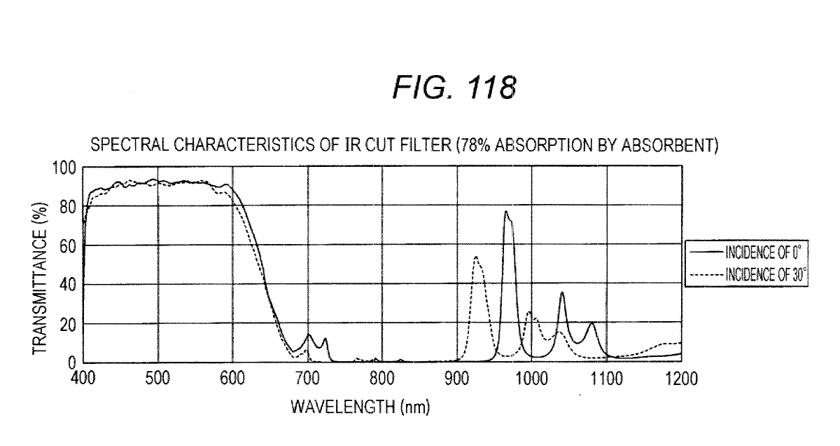

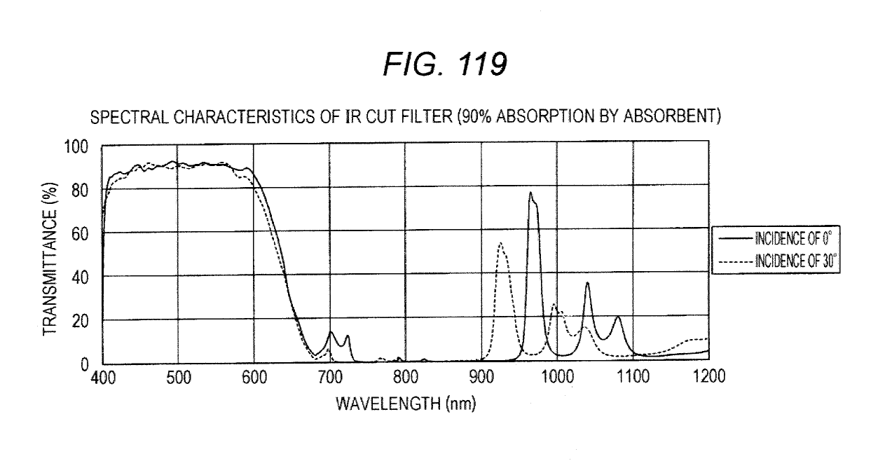

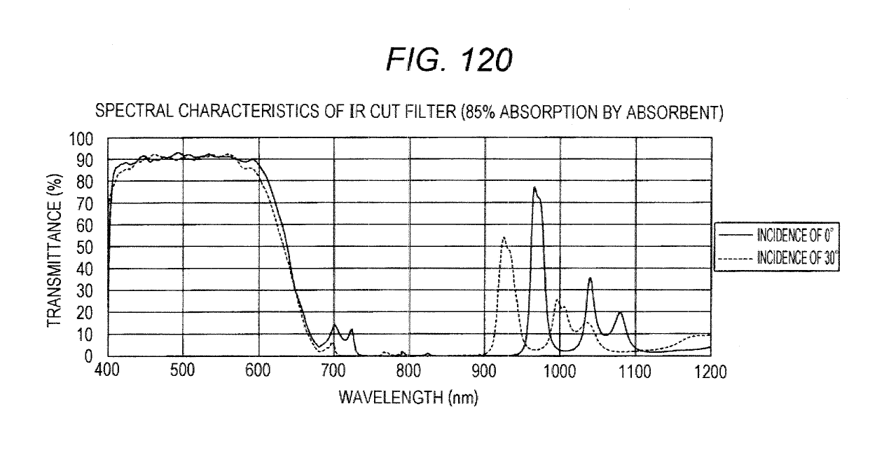

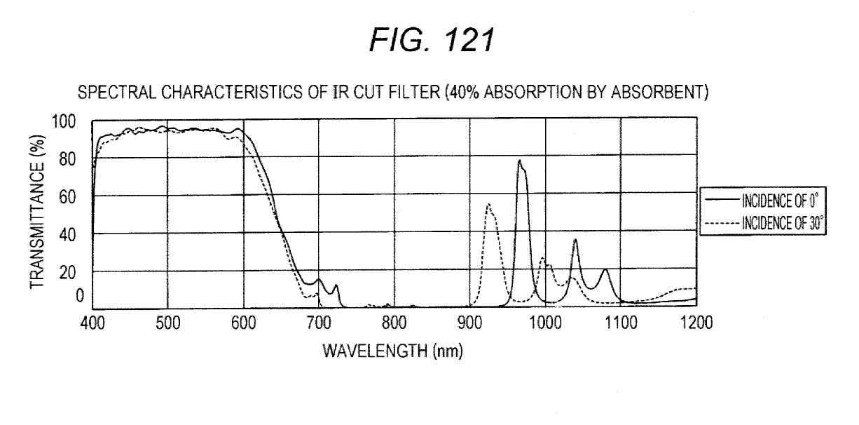

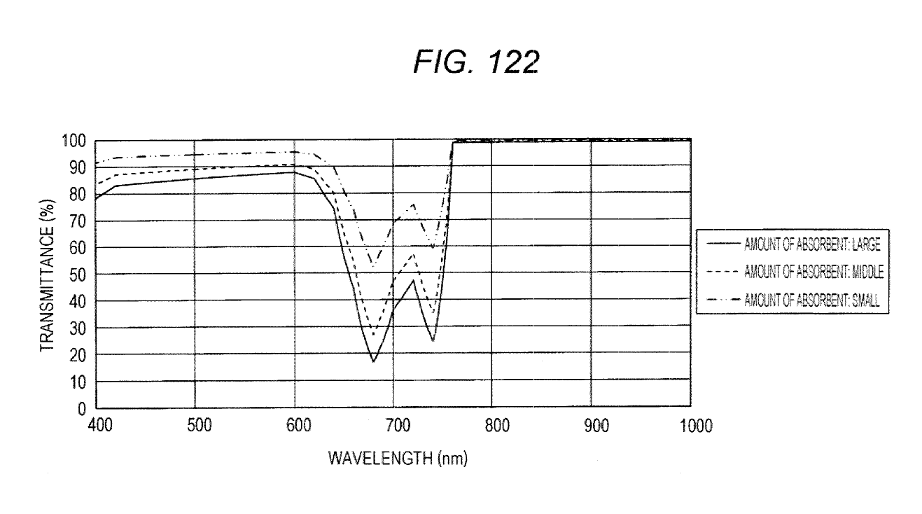

FIG. 43 is a diagram illustrating a film configuration of a multilayer film of an IR cut filter according to Comparative Example 1-6.

FIG. 44 is a graph illustrating spectral characteristics of the multilayer film.

FIG. 45 is a diagram illustrating a film configuration of a multilayer film of an IR cut filter according to Comparative Example 1-7.

FIG. 46 is a graph illustrating spectral characteristics of the multilayer film.

FIG. 47 is a diagram illustrating a film configuration of a multilayer film of an IR cut filter according to Comparative Example 1-8.

FIG. 48 is a graph illustrating spectral characteristics of the multilayer film.

FIG. 49 is a diagram illustrating a film configuration of a multilayer film of an IR cut filter according to Comparative Example 1-9.

FIG. 50 is a graph illustrating spectral characteristics of the multilayer film.

FIG. 51 is a diagram illustrating a film configuration of a multilayer film of an IR cut filter according to Comparative Example 1-10.

FIG. 52 is a graph illustrating spectral characteristics of the multilayer film.

FIG. 53 is a graph illustrating spectral characteristics a multilayer film of an IR cut filter according to a second embodiment of the present invention in a wavelength region of 600 nm to 700 nm at an incidence angle of 0° and an incidence angle of 30°.

FIG. 54 is a diagram illustrating a relationship among ΔT, Δn×nH, and acceptance or rejection of performance in a multilayer film of the IR cut filter.

FIG. 55 is a diagram illustrating a relationship among the number of cutoff adjustment pairs, the number of design solutions, and acceptance or rejection of performance in the multilayer film.

FIG. 56 is a diagram illustrating characteristics of multilayer films of IR cut filters according to examples and comparative examples of the second embodiment together.

FIG. 57 is a diagram illustrating characteristics of an IR cut filter according to Example 2-1 in a double-side coated state.

FIG. 58 is a diagram illustrating a film configuration of a multilayer film of an IR cut filter according to Example 2-2.

FIG. 59 is a graph illustrating spectral characteristics of the multilayer film.

FIG. 60 is a diagram illustrating a film configuration of a multilayer film of an IR cut filter according to Example 2-3.

FIG. 61 is a graph illustrating spectral characteristics of the multilayer film.

FIG. 62 is a graph illustrating spectral characteristics of the IR cut filter in a double-side coated state.

FIG. 63 is a diagram illustrating characteristics of the IR cut filter in the double-side coated state.

FIG. 64 is a diagram illustrating a film configuration of a multilayer film of an IR cut filter according to Example 2-5.

FIG. 65 is a graph illustrating spectral characteristics of the multilayer film.

FIG. 66 is a diagram illustrating a film configuration of a multilayer film of an IR cut filter according to Example 2-6.

FIG. 67 is a graph illustrating spectral characteristics of the multilayer film.

FIG. 68 is a diagram illustrating a film configuration of a multilayer film of an IR cut filter according to Example 2-10.

FIG. 69 is a graph illustrating spectral characteristics of the multilayer film.

FIG. 70 is a diagram illustrating a film configuration of a multilayer film of an IR cut filter according to Comparative Example 2-11.

FIG. 71 is a graph illustrating spectral characteristics of the multilayer film.

FIG. 72 is a graph schematically illustrating spectral characteristics of a multilayer film on Surface A and a multilayer film on Surface B of an IR cut filter at an incidence angle of 30° according to a third embodiment of the present invention.

FIG. 73 is a diagram illustrating characteristics of IR cut filters according to examples and comparative examples of the second embodiment along with characteristics of a multilayer film on Surface A together.

FIG. 74 is a diagram illustrating characteristics of the multilayer film on Surface B of the IR cut filter and evaluation results thereof.

FIG. 75 is a diagram illustrating a film configuration of a multilayer film on Surface A of an IR cut filter according to Example 3-1.

FIG. 76 is a diagram illustrating a film configuration of a multilayer film on Surface B of the IR cut filter.

FIG. 77 is a graph illustrating spectral characteristics of the multilayer film on Surface A and the multilayer film on Surface B.

FIG. 78 is a graph illustrating spectral characteristics of the IR cut filter as a whole.

FIG. 79 is a diagram illustrating a film configuration of a multilayer film on Surface A of an IR cut filter according to Example 3-2.

FIG. 80 is a diagram illustrating a film configuration of a multilayer film on Surface B of the IR cut filter.

FIG. 81 is a graph illustrating spectral characteristics of the multilayer film on Surface A and the multilayer film on Surface B.

FIG. 82 is a graph illustrating spectral characteristics of the IR cut filter as a whole.

FIG. 83 is a diagram illustrating a film configuration of a multilayer film on Surface A of an IR cut filter according to Example 3-3.

FIG. 84 is a diagram illustrating a film configuration of a multilayer film on Surface B of the IR cut filter.

FIG. 85 is a graph illustrating spectral characteristics of the multilayer film on Surface A and the multilayer film on Surface B.

FIG. 86 is a graph illustrating spectral characteristics of the IR cut filter as a whole.

FIG. 87 is a diagram illustrating a film configuration of a multilayer film on Surface A of an IR cut filter according to Example 3-4.

FIG. 88 is a diagram illustrating a film configuration of a multilayer film on Surface B of the IR cut filter.

FIG. 89 is a graph illustrating spectral characteristics of the multilayer film on Surface A and the multilayer film on Surface B.

FIG. 90 is a graph illustrating spectral characteristics of the IR cut filter as a whole.

FIG. 91 is a diagram illustrating a film configuration of a multilayer film on Surface A of an IR cut filter according to Example 3-5.

FIG. 92 is a diagram illustrating a film configuration of a multilayer film on Surface B of the IR cut filter.

FIG. 93 is a graph illustrating spectral characteristics of the multilayer film on Surface A and the multilayer film on Surface B.

FIG. 94 is a graph illustrating spectral characteristics of the IR cut filter as a whole.

FIG. 95 is a diagram illustrating a film configuration of a multilayer film on Surface A of an IR cut filter according to example 3-6.

FIG. 96 is a diagram illustrating a film configuration of a multilayer film on Surface B of the IR cut filter.

FIG. 97 is a graph illustrating spectral characteristics of the multilayer film on Surface A and the multilayer film on Surface B.

FIG. 98 is a graph illustrating spectral characteristics of the IR cut filter as a whole.

FIG. 99 is a diagram illustrating a film configuration of a multilayer film on Surface A of an IR cut filter according to Example 3-7.

FIG. 100 is a diagram illustrating a film configuration of a multilayer film on Surface B of the IR cut filter.

FIG. 101 is a graph illustrating spectral characteristics of the multilayer film on Surface A and the multilayer film on Surface B.

FIG. 102 is a graph illustrating spectral characteristics of the IR cut filter as a whole.

FIG. 103 is a diagram illustrating a film configuration of a multilayer film on Surface A of an IR cut filter according to Comparative Example 3-1.

FIG. 104 is a diagram illustrating a film configuration of a multilayer film on Surface B of the IR cut filter.

FIG. 105 is a graph illustrating spectral characteristics of the multilayer film on Surface A and the multilayer film on Surface B.

FIG. 106 is a graph illustrating spectral characteristics of the IR cut filter as a whole.

FIG. 107 is a diagram illustrating a film configuration of a multilayer film on Surface A of an IR cut filter according to Comparative Example 3-2.

FIG. 108 is a diagram illustrating a film configuration of a multilayer film on Surface B of the IR cut filter.

FIG. 109 is a graph illustrating spectral characteristics of the multilayer film on Surface A and the multilayer film on Surface B.

FIG. 110 is a graph illustrating spectral characteristics of the IR cut filter as a whole.

FIG. 111 is a diagram illustrating a film configuration of a multilayer film on Surface A of an IR cut filter according to Comparative Example 3-3.

FIG. 112 is a diagram illustrating a film configuration of a multilayer film on Surface B of the IR cut filter.

FIG. 113 is a graph illustrating spectral characteristics of the multilayer film on Surface A and the multilayer film on Surface B.

FIG. 114 is a graph illustrating spectral characteristics of the IR cut filter as a whole.

FIG. 115 is a cross-sectional view schematically illustrating a configuration of an IR cut filter according to a fourth embodiment of the present invention.

FIG. 116 is a diagram illustrating examples of spectral characteristics of a multilayer film of the IR cut filter in a wavelength region of 600 nm to 750 nm at an incidence angle of 0° and an incidence angle of 30°.

FIG. 117 is a diagram illustrating ghosts and average transmittance of an IR cut filter having an absorption film.

FIG. 118 is a diagram illustrating an example of spectral characteristics of the IR cut filter.

FIG. 119 is a diagram illustrating another example of spectral characteristics of the IR cut filter.

FIG. 120 is a diagram illustrating still another example of spectral characteristics of the IR cut filter.

FIG. 121 is a diagram illustrating still another example of spectral characteristics of the IR cut filter.

FIG. 122 is a diagram schematically illustrating characteristics of an infrared absorbent.

### DESCRIPTION OF EMBODIMENTS

### First Embodiment

A first embodiment of the present invention will be described below with reference to the accompanying drawings as follows. On the other hand, in this description, when a numerical range is mentioned to be A to B, values of Lower Limit A and Upper Limit B are included in the numerical range.

[Configuration and Characteristics of IR Cut Filter]

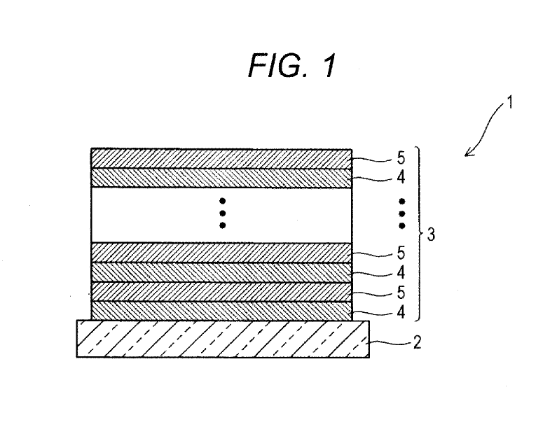

FIG. 1 is a cross-sectional view schematically illustrating a configuration of an IR cut filter 1 according to this embodiment. The IR cut filter 1 is an IR cut filter that transmits visible light and reflects near-infrared light, and includes a substrate 2 and a multilayer film 3 (first multilayer film) formed on the substrate 2. The substrate 2 is formed of, for example, a transparent glass substrate (for example, BK7), but may be formed of a transparent resin substrate. The multilayer film 3 is an optical film in which a high refractive index layer 4 having a relatively high refractive index and a low refractive index layer 5 having a relatively low refractive index are alternately stacked. In FIG. 1, a layer of the multilayer film 3 closest to the substrate 2 is the high refractive index layer 4, but the layer may be the low refractive index layer 5.

The high refractive index layer 4 has a refractive index which is equal to or higher than an average value of refractive indices of plural materials constituting the multilayer film 3 and the low refractive index layer 5 has a refractive index which is lower than the average value. When plural low refractive index materials having different refractive indices are stacked in parallel (continuously), this is optically equivalent to a configuration in which a single low refractive index layer is present. The same is true when plural high refractive index materials having different refractive indices are stacked in parallel (continuously).

The multilayer film 3 has the following characteristics.

(1) Average transmittance in a wavelength region of 450 nm to 600 nm is equal to or greater than 90%.

(2) A wavelength with transmittance of 50% at an incidence angle of 0° is in a range of 650±25 nm. Hereinafter, this wavelength is also referred to as a cutoff wavelength.

(3) A conditional expression of 0.5%/nm<|ΔT|<7%/nm is satisfied. Here, definitions are as follows.

|ΔT|: value (%/nm) of |(T_{70%}−T_{30%})/(λ_{70%}−λ_{30%})| at an incidence angle of 0°

T_{70%}: transmittance value of 70%

T_{30%}: transmittance value of 30%

λ_{70%}: wavelength (nm) with transmittance of 70%

λ_{30%}: wavelength (nm) with transmittance of 30%

That is, |ΔT| indicates a slope of a straight line (ratio of a variation in transmittance to a variation in wavelength when a graph indicating the variation in transmittance is the straight line in a wavelength region in which the transmittance is lowered from 70% to 30% at an incidence angle of 0°. Hereinafter, |ΔT| is also referred to as a slope of a transmittance variation line. In a wavelength region of 600 nm to 700 nm, the following conditions are satisfied.

(4) A difference in wavelength with transmittance of 50% between an incidence angle of 0° and an incidence angle of 30° is equal to or less than 8 nm. Hereinafter, the difference in wavelength is also referred to as a wavelength shift (T=50%).

(5) A difference in wavelength with transmittance of 25% between an incidence angle of 0° and an incidence angle of 30° equal to or less than 20 nm. Hereinafter, the difference in wavelength is also referred to as a wavelength shift (T=25%).

(6) A difference in wavelength with transmittance of 75% between an incidence angle of 0° and an incidence angle of 30° is equal to or less than 20 nm. Hereinafter, the difference in wavelength is also referred to as a wavelength shift (T=75%).

From the characteristics (1) and (2), spectral characteristics in which the transmittance on a shorter wavelength side than the cutoff wavelength is higher and the transmittance on a longer wavelength side than the cutoff wavelength is lower can be realized as the spectral characteristics of the multilayer film 3. Accordingly, it is possible to realize an IR cut filter 1 that mainly transmits light on a shorter wavelength side than the cutoff wavelength and mainly reflects light (including near-infrared light of a wavelength of 700 nm or greater) on a longer wavelength side than the cutoff wavelength.

The conditional expression described in the characteristic of (3) defines an appropriate range of the slope of the transmittance variation line at an incidence angle of 0°. When |ΔT| is equal to or less than the lower limit of the conditional expression, the slope of the transmittance variation line is excessively small (the transmittance variation line lies down) and thus separation of transmission/reflection with the cutoff wavelength as an interface is not clear. Accordingly, the cut characteristics of near-infrared light get worse and the performance as the IR cut filter is not sufficient. On the contrary, when |ΔT| is equal to or greater than the upper limit of the conditional expression, the slope of the transmittance variation line is great and the characteristics as the IR cut filter are sharpened, but the incidence angle dependency increases. That is, when the incidence angle is changed, for example, from 0° to 30°, the transmittance variation line is shifted to a short wavelength side, and the shift amount at that time increases.

The characteristics of (4) to (6) represent allowable ranges of the shift (shift amount) of the transmittance variation line at the incidence angle of 0° and the incidence angle of 30° in the wavelength region of 600 nm to 700 nm. By satisfying the characteristic of (4), the shift of the cutoff wavelength with respect to a variation in incidence angle of 30° can be limited to the allowable range. By satisfying the characteristics of (5) and (6), the shift of the wavelength with transmittance of 75% and the shift of the wavelength with transmittance of 25% with respect to the variation in incidence angle of 30° can be limited to the allowable ranges.

Accordingly, by satisfying the characteristics of (3) to (6), it is possible to decrease the slope of the transmittance variation line in a range in which the performance as an IR cut filter is satisfied (in a range in which separation of transmission/reflection can be performed) and to limit the shift of the transmittance variation line with respect to the variation in incidence angle of 30° to the allowable range, thereby reducing the incidence angle dependency. Accordingly, it is possible to realize an IR cut filter 1 of low incidence angle dependency which can satisfactorily cope with the low profile of the imaging lens. Therefore, even when the IR cut filter 1 along with the imaging lens is inserted into a camera of a thin portable terminal, it is possible to prevent the central part of a captured image from being reddened to cause unevenness in an in-plane color.

From the viewpoint of decreasing the incidence angle dependency by narrowing the allowable range of the shift of the transmittance variation line with respect to the variation in incidence angle, it is preferable that a difference in wavelength with transmittance of 75% between the incidence angle of 0° and the incidence angle of 30° in the multilayer film 3 be equal to or less than 15 nm and it is more preferable that the difference in wavelength be equal to or less than 11 nm.

From the viewpoint of further decreasing the incidence angle dependency by further decreasing the slope of the transmittance variation line after securing the cut characteristic of near-infrared light, it is preferable that the multilayer film 3 satisfy 0.5%/nm<|ΔT|<2.5%/nm and it is more preferable that the multilayer film 3 satisfy 0.5%/nm<|ΔT|<1.5%/nm.

[Optical Design of Multilayer Film]

The optical design of the multilayer film 3 will be described below. In general, a thin film can be designed using an automatic design, and the automatic design can be performed using the characteristics of (1) to (6) as target conditions in optically designing the multilayer film 3.

According to the optical design using the automatic design, it can be seen that when the multilayer film 3 has at least four cutoff adjustment pairs in which the ratio (H/L) of the optical thickness H of the high refractive index layer 4 and the optical thickness of the low refractive index layer 5 which are adjacent to each other is equal to or greater than 3 and satisfies Δn×nH≧1.5, the characteristics of (1), (2), and (4) to (6) can be easily realized within a range in which the conditional expression of (3) is satisfied. Here, Δn is a value of nH−nL when a maximum refractive index among the refractive indices of layers constituting the multilayer film 3 is nH and a minimum refractive index is nL. The cutoff adjustment pair is defined as a pair of the high refractive index layer 4 closest to the substrate 2 and the low refractive index layer 5 adjacent thereto (stacked thereon) among the high refractive index layers 4 and the low refractive index layers 5 adjacent to each other. Details of the conditions will be described below.

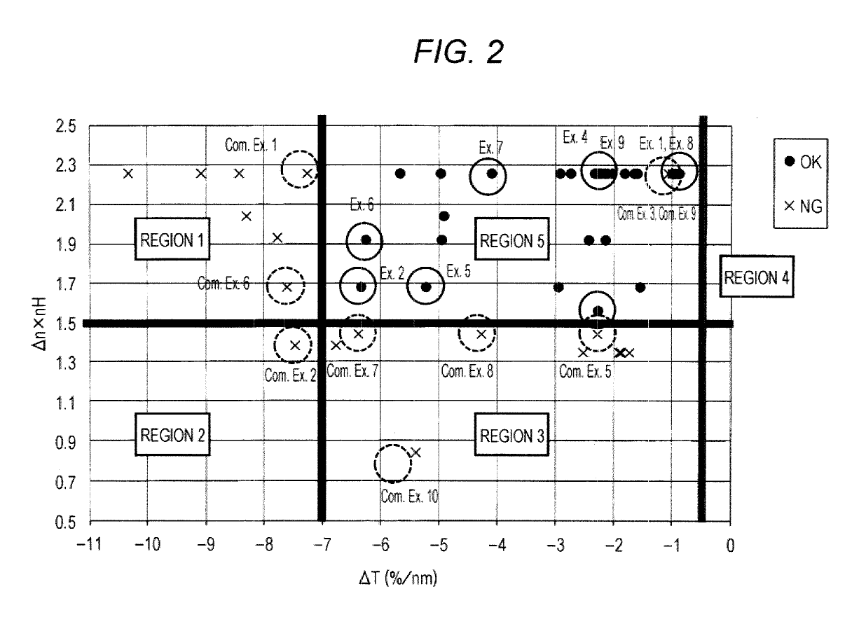

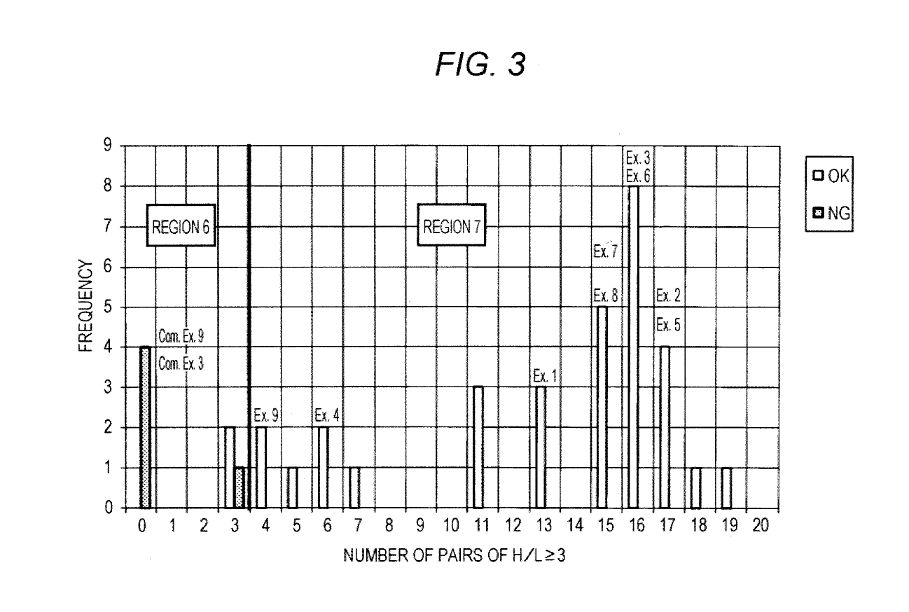

FIG. 2 illustrates a relationship among ΔT, Δn×nH, and acceptance or rejection of performance. Regarding the acceptance or rejection of performance, an IR cut filter satisfying all the characteristics of (1) to (6) is marked by “” (OK) and an IR cut filter not satisfying all the characteristics is marked by “x” (NG). In the results of examples to be described later, “” is surrounded with a solid circle. In the results of comparative examples to be described later, “x” is surrounded with a dotted circle. In FIG. 2, for example, notations of “Ex. 1”, “Ex. 2”, . . . correspond to Example 1-1, Example 1-2, . . . , respectively, and notations of “Com. Ex. 1”, “Com. Ex. 2”, . . . correspond to Comparative Example 1-1, Comparative Example 1-2, . . . , respectively. This is true in FIG. 3.

For the purpose of convenience of explanation, Regions 1 to 5 in FIG. 2 are defined as follows.

Region 1: |ΔT|≧7%/nm and Δn×nH≧1.5

Region 2: |ΔT|≧7%/nm and Δn×nH<1.5

Region 3: 0.5%/nm<|ΔT|<7%/nm and Δn×nH<1.5

Region 4: |ΔT|≦0.5%/nm

Region 5: 0.5%/nm<|ΔT|<7%/nm and Δn×nH≧1.5

In Region 5, since |ΔT|<7%/nm is established and the slope of the transmittance variation line can be sufficiently decreased to lie down, it is possible to decrease the incidence angle dependency. The refractive index difference Δn and the refractive index nH of the high refractive index material are sufficiently great. Accordingly, even when the transmittance variation line lies down, the performance of transmission in a transmission area/reflection in a reflection area can be maintained. As a result, except for cases in which the number of cutoff adjustment pairs to be described later is equal to or less than 3 which is small (including Comparative Examples 1-3 and 1-9), all the characteristics of (1) to (6) can be satisfied.

In Regions 1 and 2, since |ΔT|≧7%/nm is satisfied and the transmittance variation line cannot sufficiently lie down, it is not possible to decrease the incidence angle dependency. In Region 3, since the refractive index difference Δn and the refractive index nH of the high refractive index material are not sufficiently great, it is difficult to maintain the performance of transmission in a transmission area/reflection in a reflection area while causing the transmittance variation line to lie down and the shift of the cutoff wavelength with respect to the variation in incidence angle is likely to increase (the effect of decreasing the incidence angle dependency is small). In Region 4, since the transmittance variation line lies down (the slope is small), the transmission in a transmission area/reflection in a reflection area is not clear and the function as an IR cut filter cannot be satisfactorily exhibited.

FIG. 3 illustrates a relationship among the number of cutoff adjustment pairs in which H/L is equal to or greater than 3, the number of design solutions (frequency) of the IR cut filter, and the acceptance or rejection of performance when the conditions (0.5%/nm<|ΔT|<7%/nm and Δn×nH≧1.5) of Region 5 are satisfied. Regarding the acceptance or rejection of performance, an IR cut filer satisfying all the characteristics of (1) to (6) is indicated by a white bar (OK) and an IR cut filter not satisfying all the characteristics is indicated by a hatched bar (NG). In examples and comparative examples to be described later, a representative solution among the design solutions is selectively described.

Region 7 in FIG. 3 is a region indicating a film configuration including at least four cutoff adjustment pairs in which H/L is equal to or greater than 3. In Region 7, in a state in which the transmittance variation line lies down, it is possible to suppress the shift amount of the transmittance variation line with respect to a variation in incidence angle and satisfy all the characteristics of (1) to (6).

On the other hand, Region 6 is a region indicating a film configuration in which the number of cutoff adjustment pairs in which H/L is equal to or greater than 3 is 3 or less. In Region 6, even when the conditions of Region 5 are satisfied, it cannot be said that all the characteristics of (1) to (6) are satisfied to decrease the incidence angle dependency. For example, when the number of cutoff adjustment pairs is 0 as in Comparative Examples 1-3 and 1-9 to be described later, the wavelength shift (T=50%), the wavelength shift (T=50%), and the wavelength shift (T=50%) at the incidence angle of 0° and the incidence angle of 30° are all greater than 20 nm and the characteristics of (4) to (6) are not satisfied. When the number of cutoff adjustment pairs is 3, all the characteristics of (1) to (6) may be satisfied or may not be satisfied depending on the film configurations.

From the above description, when the multilayer film 3 has a film configuration including at least four cutoff adjustment pairs in which H/L is equal to or greater than 3 and satisfying Δn×nH≧1.5, it can be said to easily or satisfactorily satisfy the characteristics of (1), (2), and (4) to (6) on the assumption that the conditional expression of (3) is satisfied. It is preferable that the number of cutoff adjustment pairs in which H/L is equal to or greater than 3 be 6 (six pairs) and it is more preferable that the number of cutoff adjustment pairs be equal to or greater than 13 (thirteen pairs).

In realizing the film configuration including at least four cutoff adjustment pairs in which H/L is equal to or greater than 3, the optical design can be more easily performed (more design solutions are likely to be obtained) by increasing the total number of layers constituting the multilayer film 3. Accordingly, the total thickness of the multilayer film 3 is preferably equal to or greater than 3000 nm and more preferably equal to or greater than 4000 nm.

[Another Configuration of IR Cut Filter]

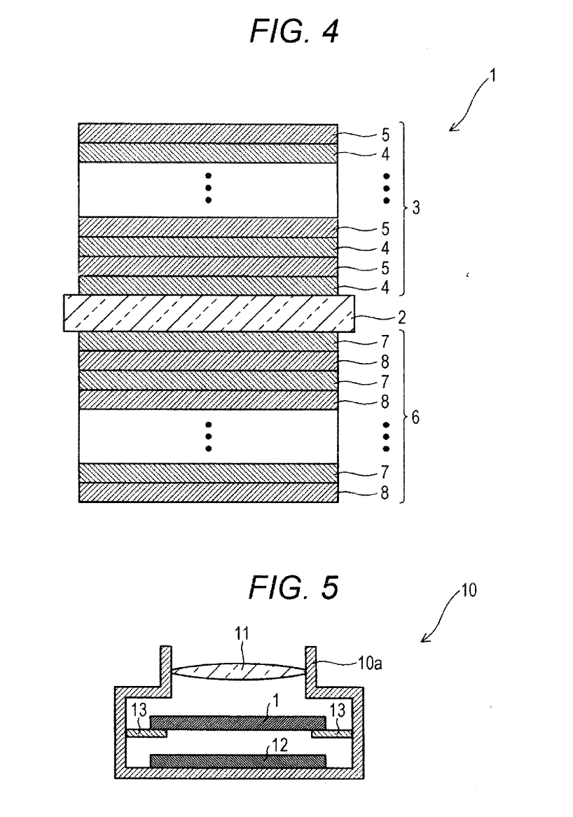

FIG. 4 is a cross-sectional view schematically illustrating another configuration of the IR cut filter 1 according to this embodiment. The IR cut filter 1 may further include a multilayer film 6 (second multilayer film) in addition to the configuration illustrated in FIG. 1.

The multilayer film 6 is an optical film in which a high refractive index layer 7 having a relatively high refractive index and a low refractive index layer 8 having a relatively low refractive index are alternately stacked and is formed on the opposite surface of the substrate 2 to the surface on which the multilayer film 3 is formed. In FIG. 4, a layer of the multilayer film 6 closest to the substrate 2 is the high refractive index layer 7, but the layer may be the low refractive index layer 8. The film configuration (material, thickness, the number of layers, and the like) of the multilayer film 6 may be equal to the film configuration of the multilayer film 3 or may be different therefrom. When the same low incidence angle dependency as the multilayer film 3 is realized for the multilayer film 6, the multilayer film 6 preferably includes at least four cutoff adjustment pairs in which H/L is equal to or greater than 3.

The multilayer film 6 is designed based on the film configuration of the multilayer film 3, and it is preferable that the multilayer film 6 cut light in an IR region of 700 nm to 11.00 nm and have average transmittance of 90% in a wavelength region of 450 nm to 600 nm. In this case, in a state in which both surfaces of the substrate 2 are coated (in a state in which the multilayer film 3 is formed on one surface of the surface 2 and the multilayer film 6 is formed on the opposite surface thereof), average transmittance of 80% or more in a wavelength region of 450 nm to 600 nm and average transmittance of 5% or less in a wavelength region of 720 nm to 1100 nm can be realized. That is, the multilayer film 6 can improve the reflection characteristics of a near-infrared region of 720 nm to 1100 nm without markedly decreasing the transmission characteristics of the wavelength region of 450 nm to 600 nm in a double-side coated state. It is assumed that the substrate 2 is transparent and the influence of the transmittance of the substrate 2 on the spectral characteristics of the IR cut filter 1 as a whole can be almost neglected.

Accordingly, even when the transmittance of the near-infrared region cannot be satisfactorily decreased by only the multilayer film 3, it is possible to satisfactorily cut off light of the near-infrared region using the IR cut filter 1 by forming the multilayer film 6. By forming the multilayer film 6 on the opposite surface of the substrate 2 to the surface on which the multilayer film 3 is formed, distortion due to a stress of the multilayer film 3 can be cancelled by the multilayer film 6.

Preferably, in the state in which both surfaces of the substrate 2 are coated, the multilayer film 6 has spectral characteristics in which:

the wavelength with transmittance of 50% at the incidence angle of 0° is in a range of 650±25 nm,

the conditional expression of 0.5%/nm<|ΔT|<7%/nm is satisfied,

the difference in wavelength with transmittance of 50% between the incidence angle of 0° and the incidence angle of 30° in the wavelength region of 600 nm to 700 nm is equal to or less than 8 nm,

the difference in wavelength with transmittance of 25% between the incidence angle of 0° and the incidence angle of 30° is equal to or less than 20 nm, and

the difference in wavelength with transmittance of 75% between the incidence angle of 0° and the incidence angle of 30° is equal to or less than 20 nm. In other words, the multilayer film 6 preferably has spectral characteristics of not damaging the characteristics of (2) to (6) of the multilayer film 3. In this case, by forming the multilayer film 6, it is possible to prevent the effect of decreasing the incidence angle dependency due to the multilayer film 3 from being damaged.

As characteristics of only the multilayer film 6, it is preferable that the average transmittance in the wavelength region of 450 nm to 600 nm be equal to or greater than 90% and the wavelength with transmittance of 50% at the incidence angle of 0° be located on a longer wavelength side than the wavelength with transmittance of 50% at the incidence angle of 0° in the multilayer film 3. That is, the cutoff wavelength at the incidence angle of 0° of the multilayer film 6 is preferably located on a longer wavelength side than the cutoff wavelength at the incidence angle of 0° of the multilayer film 3.

In this case, for example, when the spectral characteristics of the multilayer film 6 and the spectral characteristics of the multilayer film 3 at the incidence angle of 0° are superimposed around a wavelength of 700 nm by decreasing the difference between the cutoff wavelength of the multilayer film 6 and the cutoff wavelength of the multilayer film 3, it is possible to further improve the cut characteristic of near-infrared light. On the contrary, when the difference between the cutoff wavelength of the multilayer film 6 and the cutoff wavelength of the multilayer film 3 increases, the cutoff wavelength of the multilayer film 6 can be prevented from passing over the cutoff wavelength of the multilayer film 3 and being shifted to a short wavelength side with a variation in incidence angle. Accordingly, the effect of decreasing the incidence angle dependency due to the multilayer film 3 can be prevented from being damaged by the spectral characteristics of the multilayer film 6.

The multilayer film 6 preferably has the following characteristics.

(a) The transmittance of a wavelength of 710 nm at the incidence angle of 0° is equal to or less than 5%.

(b) T_{A}50% λ(30°)−T_{B}50% λ(30°)≦8 nm is satisfied,

where T_{A}50% λ(30°): a wavelength (nm) with transmittance of 50% in the wavelength region of 600 nm to 700 nm at the incidence angle of 30° in the multilayer film 3

T_{B}50% λ(30°): a wavelength (nm) with transmittance of 50% in the wavelength region of 600 nm to 700 nm at the incidence angle of 30° in the multilayer film 6. The point that the multilayer film 6 preferably has the above-mentioned characteristics is true in a second embodiment to be described later.

From the characteristic of (a), the reflection characteristics of near-infrared light which is on a longer wavelength side than the cutoff wavelength and which is in the vicinity of a wavelength region of 700 nm to 710 nm can be satisfactorily secured. Accordingly, even when the transmittance of the near-infrared region cannot be satisfactorily decreased by only the multilayer film 3, it is possible to satisfactorily cut off light of the near-infrared region using the IR cut filter 1 by forming the multilayer film 6. By forming the multilayer film 6 on the opposite surface (also referred to as Surface B) of the substrate 2 to the surface (also referred to as Surface A) on which the multilayer film 3 is formed, distortion due to a stress of the multilayer film 3 can be cancelled by the multilayer film 6.

The characteristic of (b) defines an appropriate range of a difference (hereinafter, also referred to as a 30° cutoff wavelength difference) between the cutoff wavelength at the incidence angle of 30° of the multilayer film 3 and the cutoff wavelength at the incidence angle of 30° of the multilayer film 6. FIG. 72 schematically illustrates the spectral characteristics of the multilayer film 3 and the multilayer film 6 at the incidence angle of 30° on in the wavelength region of 600 nm to 700 nm. In a configuration in which the cutoff wavelength of the IR cut filter 1 as a whole is in the range of 650±25 nm and the cutoff wavelength of only the multilayer film 3 is in the range of multilayer film 3, when the multilayer film 3 on Surface A has the low incidence angle dependency as described above and the multilayer film 6 on Surface B has the characteristic of (a) (the transmittance of the wavelength of 710 nm is equal to or less than 5%), the slope of the transmittance variation line in the wavelength region of 600 nm to 700 nm is greater in the multilayer film 6 on Surface B than in the multilayer film 3 on Surface A. In this case, when the 30° cutoff wavelength difference is greater than 8 nm (when the cutoff wavelength of the multilayer film 6 at the incidence angle of 30° is located on an excessively shorter wavelength side than the cutoff wavelength of the multi-layer film 3 at the incidence angle of 30°), the angle dependency which is suppressed by the spectral characteristics of the multilayer film 3 on Surface A is collapsed by the spectral characteristics of the multilayer film 6 on Surface B and thus the low incidence angle dependency is greatly damaged.

Accordingly, by satisfying the conditional expression of (b), it is possible to satisfactorily secure the reflection characteristic of near-infrared light using the multilayer film 6 on Surface B without greatly damaging the low incidence angle dependency which is achieved by the multilayer film 3 on Surface A.

In order to satisfactorily secure the reflection characteristic of near-infrared light around the wavelength 700 nm while satisfactorily suppressing damage of the low incidence angle dependency which is achieved by the multilayer film 3 on Surface A, the multilayer film 6 preferably has characteristics that the transmittance of the wavelength of 700 nm at the incidence angle of 0° is equal to or less than 2% and T_{A}50% λ(30°)−T_{B}50% λ(30°)≦2 nm is satisfied.

[Image Capturing Device]

An application example of the IR cut filter 1 will be described below. FIG. 5 is a cross-sectional view schematically illustrating a configuration of an image capturing device 10 according to this embodiment. The image capturing device 10 is a camera unit that includes the IR cut filter 1 according to this embodiment, an imaging lens 11, and an imaging element 12 in a housing 10a. The IR cut filter 1 is supported on a side wall of the housing 10a with a support member 13 interposed therebetween. The image capturing device 10 may be applied to a digital camera or may be applied to an imaging unit built in a portable terminal.

The imaging lens 11 is disposed on a light incidence side of the IR cut filter 1 and focuses incident light on a light-receiving surface of the imaging element 12. The imaging element 12 is a photoelectric element that receives light (image light) incident through the imaging lens 11 and the IR cut filter 1, converts the received light into an electrical signal, and outputs the electrical signal to the outside (for example, a display device), and is constituted by a CCD or a complementary metal oxide semiconductor (CMOS).

In this embodiment, as described above, the IR cut filter 1 of low incidence angle dependency which can satisfactorily cope with the low profile of the imaging lens 11 can be realized. Accordingly, it is possible to realize the image capturing device 10 which can decrease unevenness in an in-plane color of a captured image with a thin configuration by employing the IR cut filter 3.

On the other hand, IR cut filters according to second to fourth embodiments to be described later can also be applied to the image capturing device 10 illustrated in FIG. 5.

### EXAMPLES

Specific examples of the IR cut filter according to this embodiment will be described below. Comparative examples will also be described for the purpose of comparison with the examples. The film configuration of a first multilayer film (which corresponds to the multilayer film 3 illustrated in FIGS. 1 and 4) and a second multilayer film (which corresponds to the multilayer film 6 illustrated in FIG. 4) of an IR cut filter is acquired by the optical design and the spectral characteristics at that time are acquired.

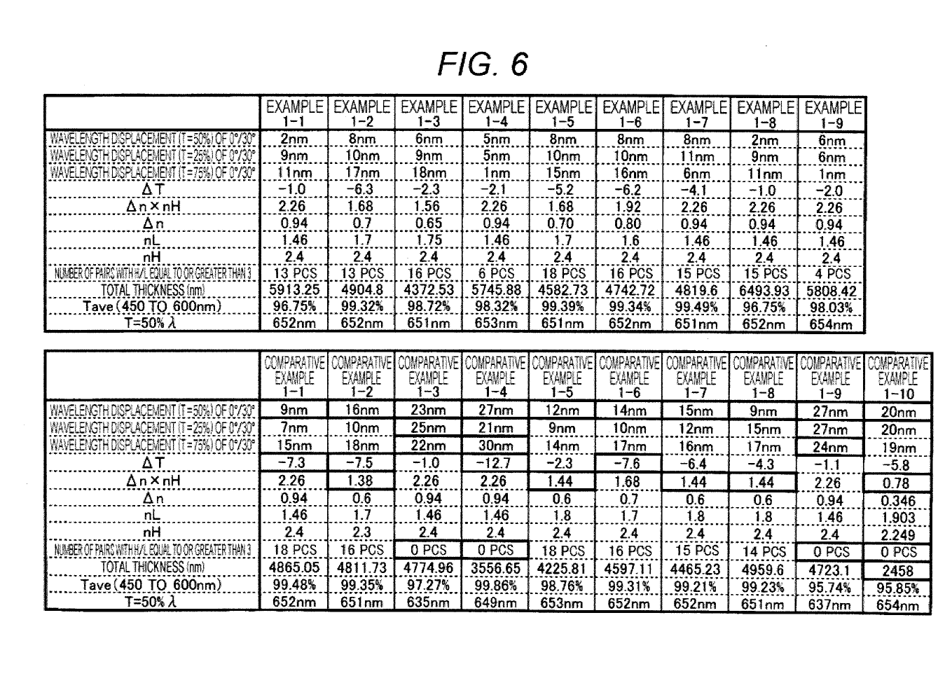

FIG. 6 illustrates characteristics of the first multilayer films according to examples and comparative examples to be described below. In the drawing, T represents the transmittance (%) and is distinguished from ΔT which represents the slope of the transmittance variation line. Tave represents the average transmittance (%), and T=50% λ represents the wavelength (cutoff wavelength of which the unit is nm) with transmittance of 50%. The average transmittance and the cutoff wavelength are values at the incidence angle of 0°. Details of the examples and the comparative examples will be described below. Only representative examples of the IR cut filter of which both surfaces are coated will be described.

### Example 1-1

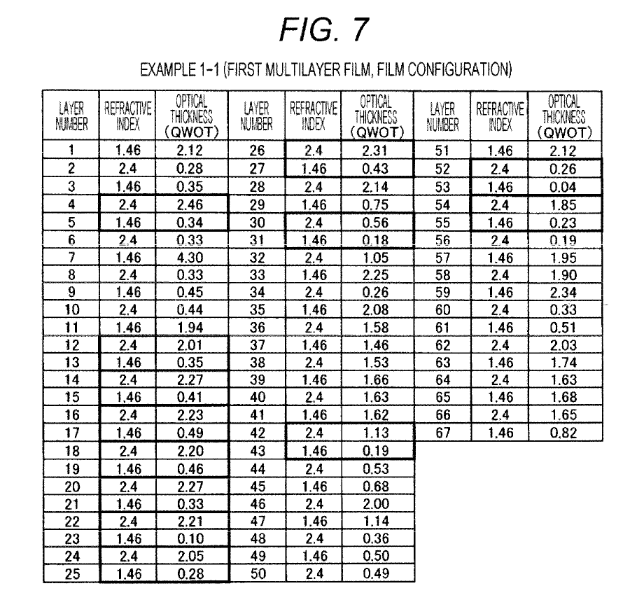

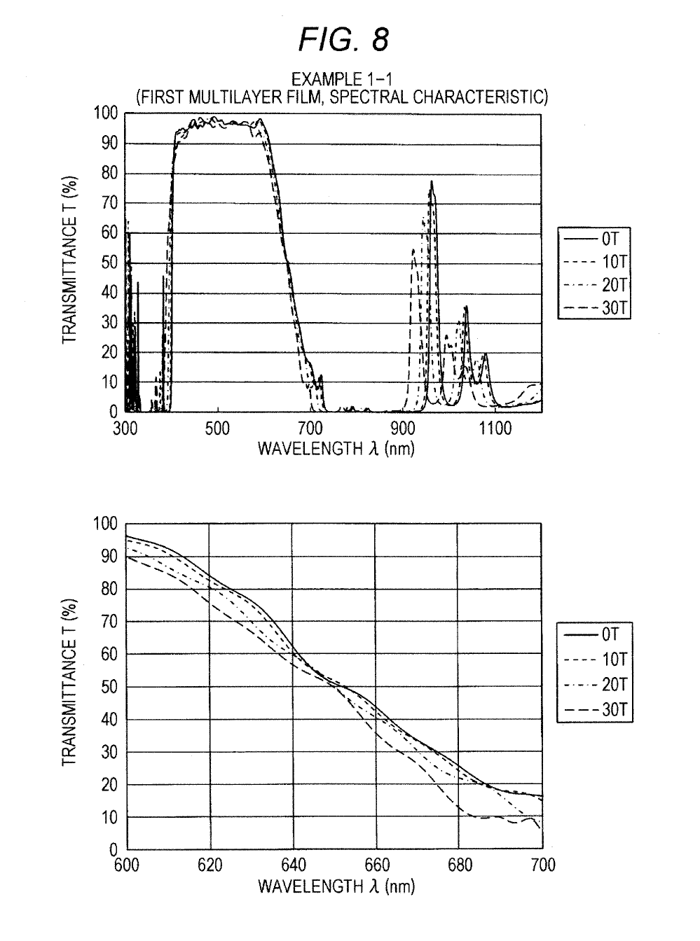

FIG. 7 is a diagram illustrating a film configuration of a first multilayer film of an IR cut filter according to Example 1-1. In FIG. 7, layers are numbered sequentially from a layer closest from the substrate and the optical thickness of each layer is expressed by quarter-wave optical thickness (QWOT). When a physical thickness is d (μm), a refractive index is n, and a design wavelength is λ (nm), QWOT=4·n·d/λ. Here, γ=550 nm is assumed. FIG. 8 is a graph illustrating spectral characteristics of the first multilayer film, where a part of wavelength region in the upper part of the drawing is enlarged in the lower part. In the graph illustrated in FIG. 8, 0T, 10T, 20T, and 30T indicate transmittance variations at incidence angles of 0°, 10°, 20°, and 30°, respectively. This notation is similarly applied to the other drawings.

The first multilayer film according to Example 1-1 is formed by alternately stacking a high refractive index layer (with a refractive index of 2.4) and a low refractive index layer (with a refractive index of 1.46). For example, TiO₂ can be used as a high refractive index material with a refractive index of 2.4 and, for example, SiO₂ can be used as a low refractive index material with a refractive index of 1.46.

The first multilayer film is configured to have 13 cutoff adjustment pairs in which H/L is equal to or greater than 3, where Δn×nH=2.26 and ΔT=−1.0%/nm. The spectral characteristics of the first multilayer film satisfy all the following five items of (A) to (E) and performance of low incidence angle dependency is realized. In FIG. 7, a cutoff adjustment pair is surrounded with a solid frame (the same is true of the other drawings).

(A) The average transmittance in a wavelength region of 450 nm to 600 nm is equal to or greater than 90%.

(B) The wavelength with transmittance of 50% at the incidence angle of 0° is in the range of 650±25 nm.

(C) The difference in wavelength with transmittance of 50% between the incidence angle of 0° and the incidence angle of 30° in a wavelength region of 600 nm to 700 nm is equal to or less than 8 nm.

(D) The difference in wavelength with transmittance of 25% between the incidence angle of 0° and the incidence angle of 30° in the wavelength region is equal to or less than 20 nm.

(E) The difference in wavelength with transmittance of 75% between the incidence angle of 0° and the incidence angle of 30° in the wavelength region is equal to or less than 20 nm.

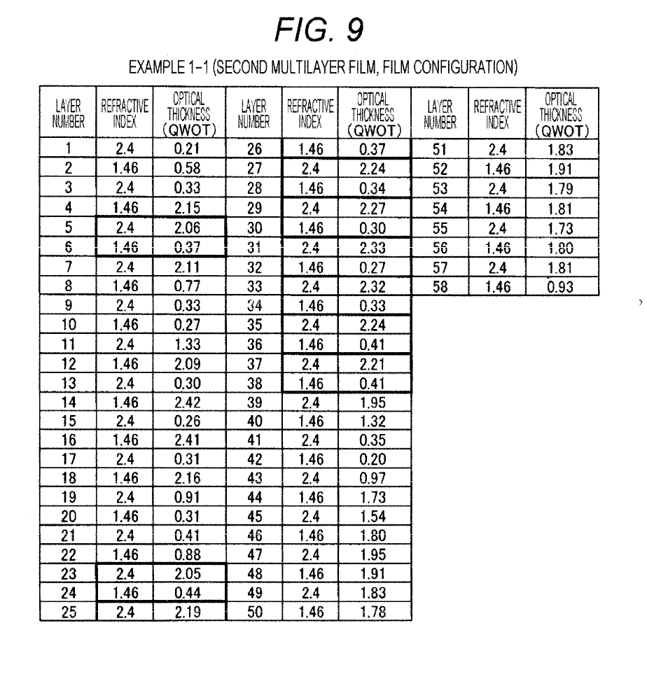

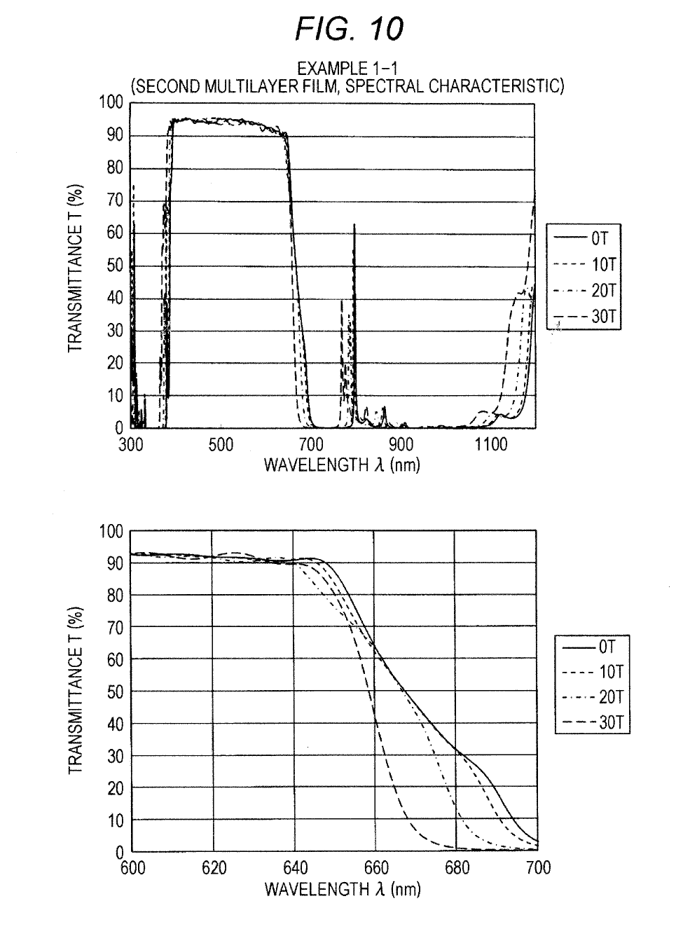

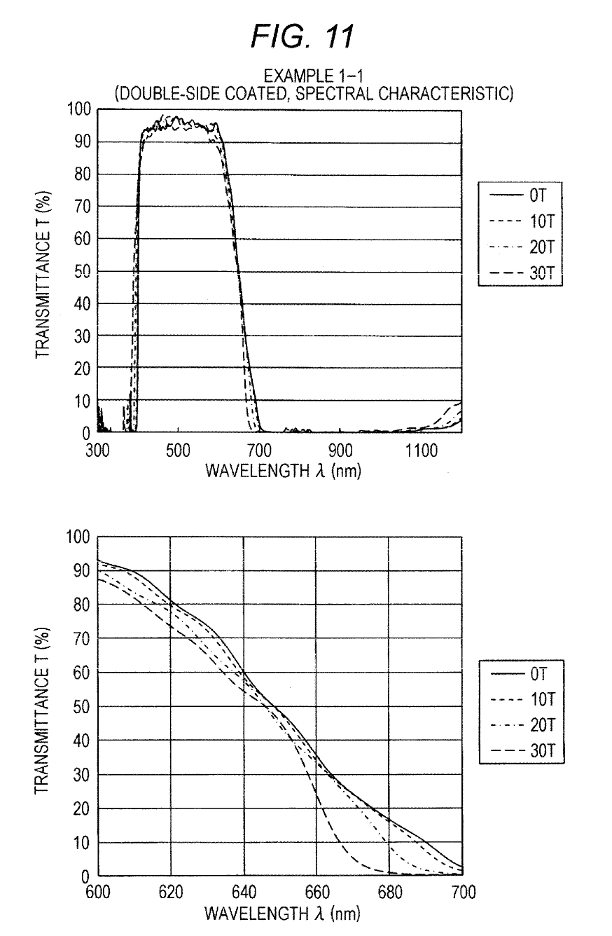

FIG. 9 is a diagram illustrating the film configuration of the second multilayer film which is formed on the opposite surface of the substrate of the IR cut filter to the first multilayer film in the IR cut filter. FIG. 10 is a graph illustrating the spectral characteristics of the second multilayer film. FIG. 11 is a graph illustrating the spectral characteristics of the IR cut filter in a double-side coated state. The same materials as in the first multilayer film can be used as materials of the high refractive index layer and the low refractive index layer of the second multilayer film. The second multi layer film is configured to have 9 cutoff adjustment pairs in which H/L is equal to or greater than 3.

In the second multilayer film, the average transmittance in the wavelength region of 450 nm to 600 nm is 94.41%, the average transmittance in the wavelength region of 720 nm to 1100 nm is 1.09%, and the cutoff wavelength with transmittance of 50% at the incidence angle of 0° is 667 nm.

FIG. 12 illustrates characteristics of the IR cut filter in the double-side coated state. From the drawing, it can be said that the second multilayer film in the double-side coated state has spectral characteristics that:

(a) The average transmittance in the wavelength region of 450 nm to 600 nm is equal to or greater than 80%.

(b) The average transmittance in the wavelength region of 720 nm to 1100 nm is equal to or less than 5%.

(c) The wavelength with transmittance of 50% at the incidence angle of 0° is in the range of 650±25 nm.

(d) 0.5%/nm<|ΔT|<7%/nm is satisfied.

In the wavelength region of 600 nm to 700 nm:

(e) The difference in wavelength with transmittance of 50% between the incidence angle of 0° and the incidence angle of 30° is equal to or less than 8 nm.

(f) The difference in wavelength with transmittance of 25% between the incidence angle of 0° and the incidence angle of 30° is equal to or less than 20 nm.

(g) The difference in wavelength with transmittance of 75% between the incidence angle of 0° and the incidence angle of 30° is equal to or less than 20 nm.

As illustrated in FIG. 8, only a part of near-infrared light can be cut off by only the first multilayer film, but it is possible to realize an IR cut filter of low incidence angle dependency as a whole which can cut off near-infrared light in a broader wavelength region as illustrated in FIG. 11 by forming the second multilayer film on the opposite surface of the substrate.

Particularly, since the cutoff wavelength (667 nm) of the second multilayer film is located on a longer wavelength side than the cutoff wavelength (652 nm) of the first multilayer film, it is possible to improve the cut characteristic of near-infrared light by superimposing the spectral characteristics of the second multilayer film on the spectral characteristics of the first multilayer film around a wavelength of 700 nm.

In Example 1-1, it can be seen that the transmittance of a wavelength 710 nm at the incidence angle of 0° in the second multilayer film is 0.52% which is equal to or less than 5%. Accordingly, it is possible to satisfactorily secure the reflection characteristic of near-infrared light (around wavelengths of 700 nm to 710 nm) using the second multilayer film.

In Example 1-1, T_{A}50% λ(30°)=650 nm and T_{B}50% λ(30°)=659 nm can be seen. In this case, T_{A}50% λ(30°)−T_{B}50% λ(30°)=−9 nm which is equal to or less than 8 nm. Accordingly, it is possible to satisfactorily secure the reflection characteristic of near-infrared light using the second multilayer film without greatly damaging the low incidence angle dependency which is achieved by the first multilayer film.

### Example 1-2

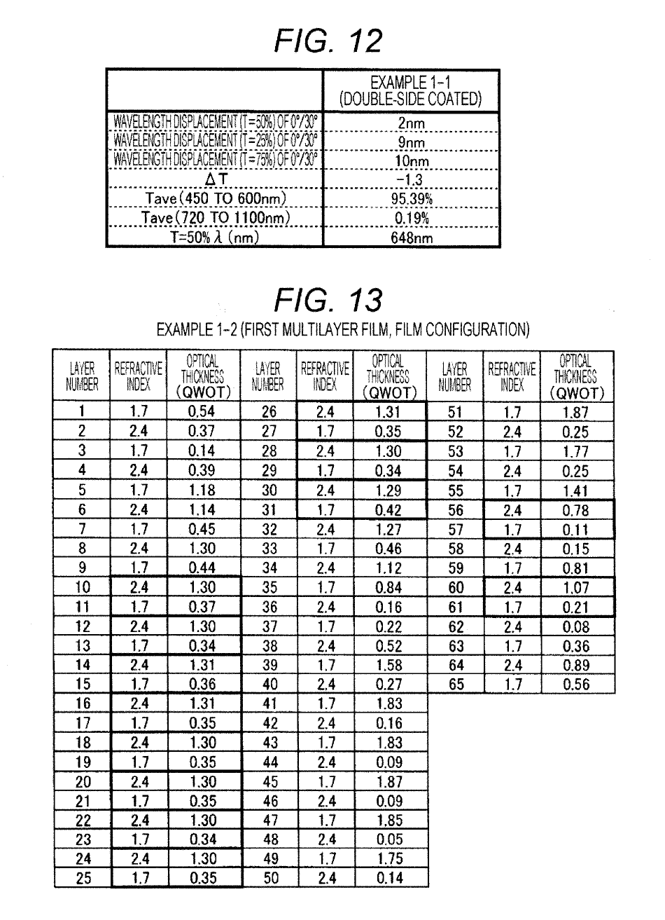

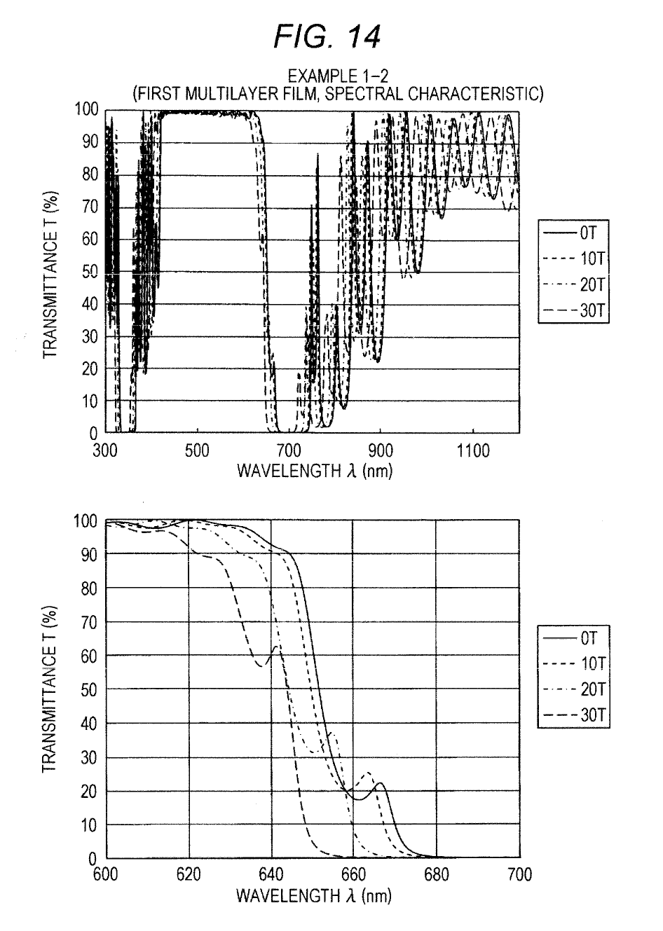

FIG. 13 is a diagram illustrating a film configuration of a first multilayer film of an IR cut filter according to Example 1-2. FIG. 14 is a graph illustrating spectral characteristics of the first multilayer film. The first multilayer film according to Example 1-2 is formed by alternately stacking a high refractive index layer (with a refractive index of 2.4) and a low refractive index layer (with a refractive index of 1.7). For example, TiO₂ can be used as a high refractive index material with a refractive index of 2.4 as in Example 1-1 and, for example, substance M2 (which is a mixture of Al₂O₃ and La₂O₂) made by Merck KGaA can be used as a low refractive index material with a refractive index of 1.7.

The first multilayer film is configured to have 13 cutoff adjustment pairs in which H/L is equal to or greater than 3, where Δn×nH=1.68 and ΔT=−6.3%/nm. The spectral characteristics of the first multilayer film satisfy all the five items of (A) to (E) and performance of low incidence angle dependency is realized.

### Example 1-3

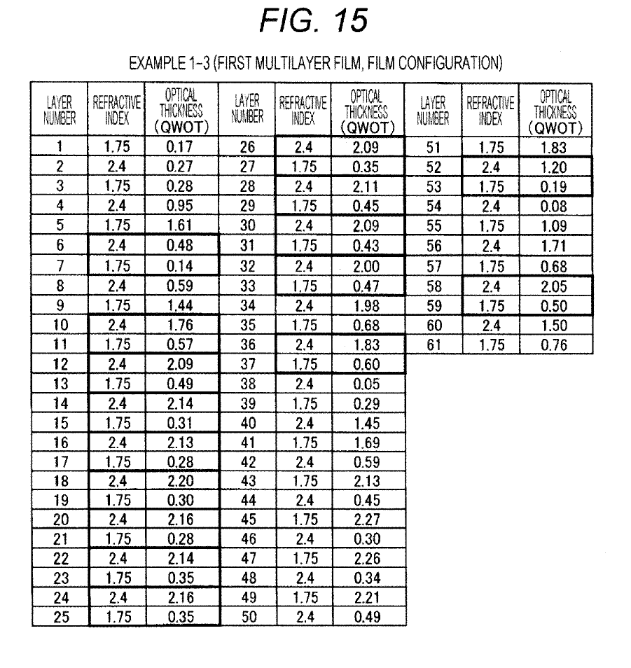

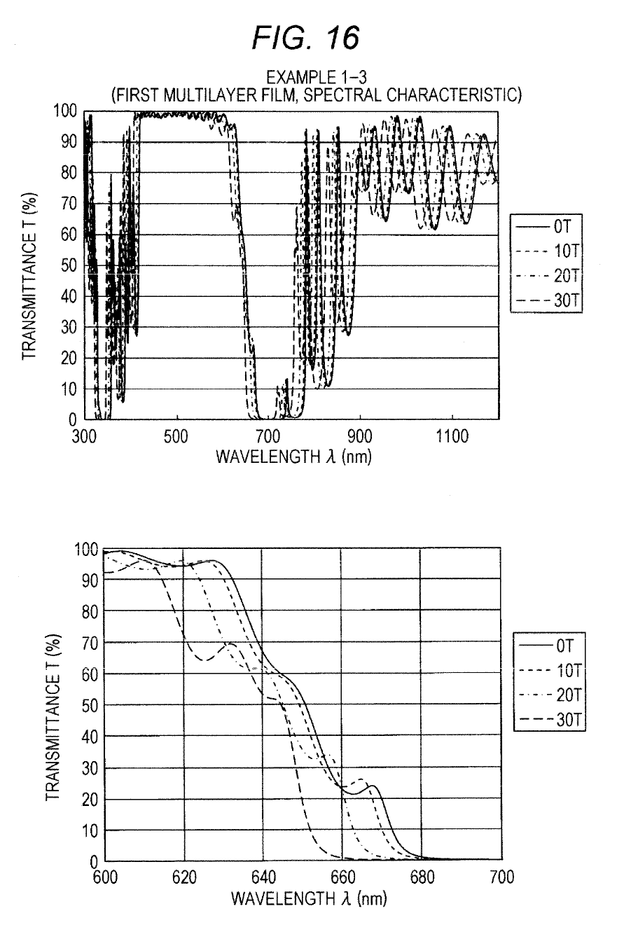

FIG. 15 is a diagram illustrating a film configuration of a first multilayer film of an IR cut filter according to Example 1-3. FIG. 16 is a graph illustrating spectral characteristics of the first multilayer film. The first multilayer film according to Example 1-3 is formed by alternately stacking a high refractive index layer (with a refractive index of 2.4) and a low refractive index layer (with a refractive index of 1.75). For example, TiO₂ can be used as a high refractive index material with a refractive index of 2.4 and, for example, substance M2 (made by Merck KGaA) can be used as a low refractive index material with a refractive index of 1.75. Even when the same low refractive index material as in Example 1-2 is used, a low refractive index layer having a refractive index different from that in Example 1-2 can be formed by changing the film formation conditions (such as a film formation temperature and a degree of vacuum).

The first multilayer film is configured to have 16 cutoff adjustment pairs in which H/L is equal to or greater than 3, where Δn×nH=1.56 and ΔT=−2.3%/nm. The spectral characteristics of the first multilayer film satisfy all the five items of (A) to (E) and performance of low incidence angle dependency is realized.

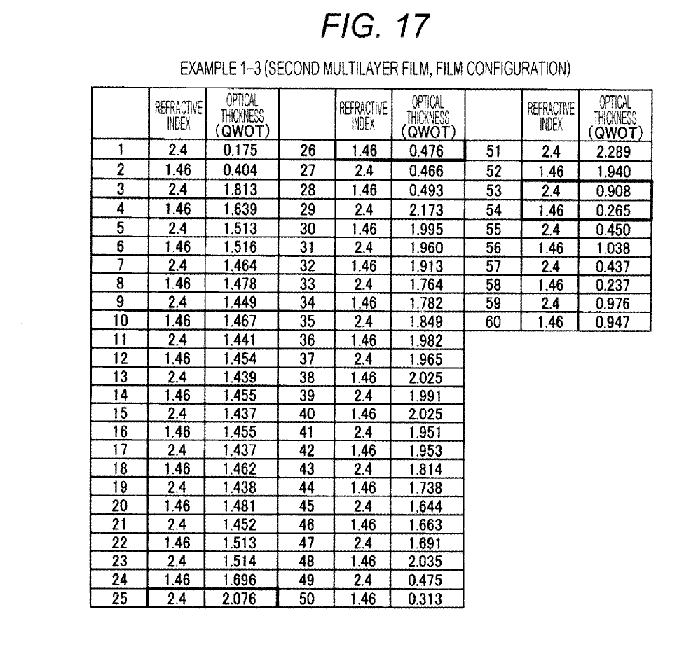

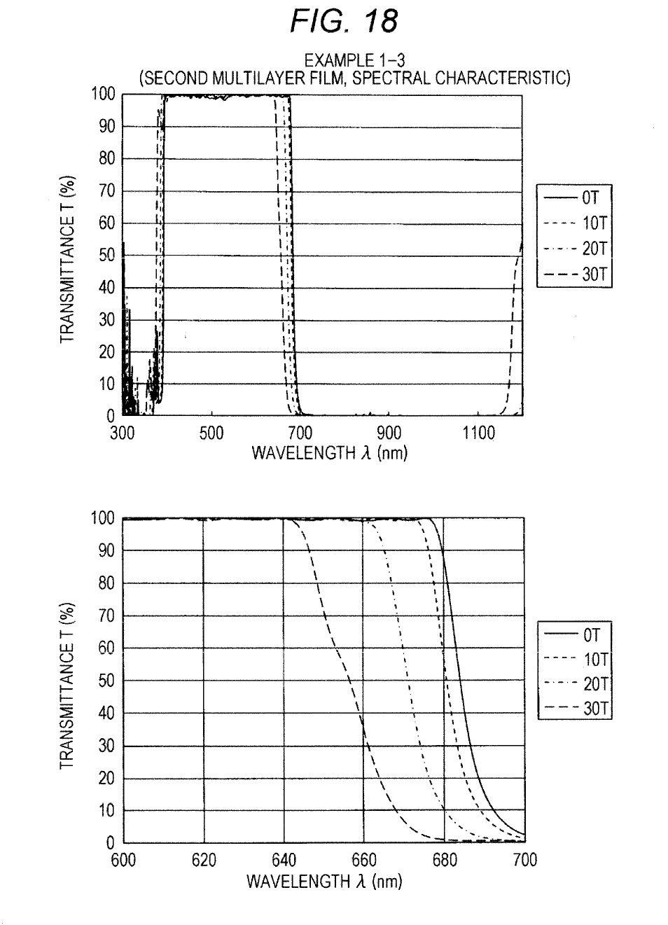

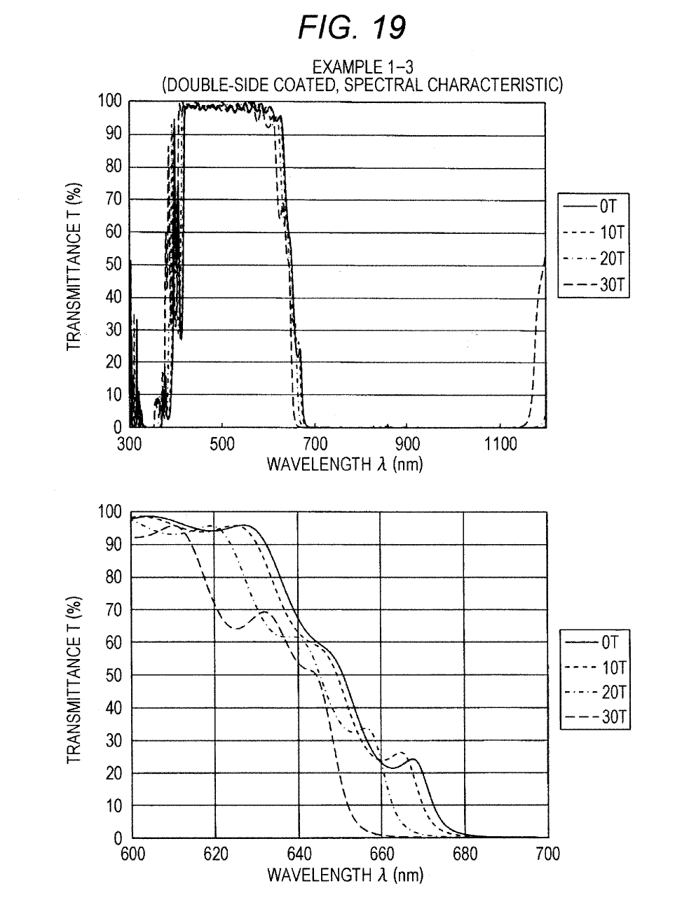

FIG. 17 is a diagram illustrating the film configuration of the second multilayer film which is formed on the opposite surface of the substrate of the IR cut filter to the first multilayer film in the IR cut filter according to Example 1-3. FIG. 18 is a graph illustrating the spectral characteristics of the second multilayer film. FIG. 19 is a graph illustrating the spectral characteristics of the IR cut filter in the double-side coated state. The same materials as the first multilayer film of Example 1-1 can be used as materials of the high refractive index layer and the low refractive index layer of the second multi layer film. The second multi layer film is configured to have 2 cutoff adjustment pairs in which H/L is equal to or greater than 3.

In the second multilayer film, the average transmittance in the wavelength region of 450 nm to 600 nm is 99.39%, the average transmittance in the wavelength region of 720 nm to 1100 nm is 0.02%, and the cutoff wavelength with transmittance of 50% at the incidence angle of 0° is 684 nm.

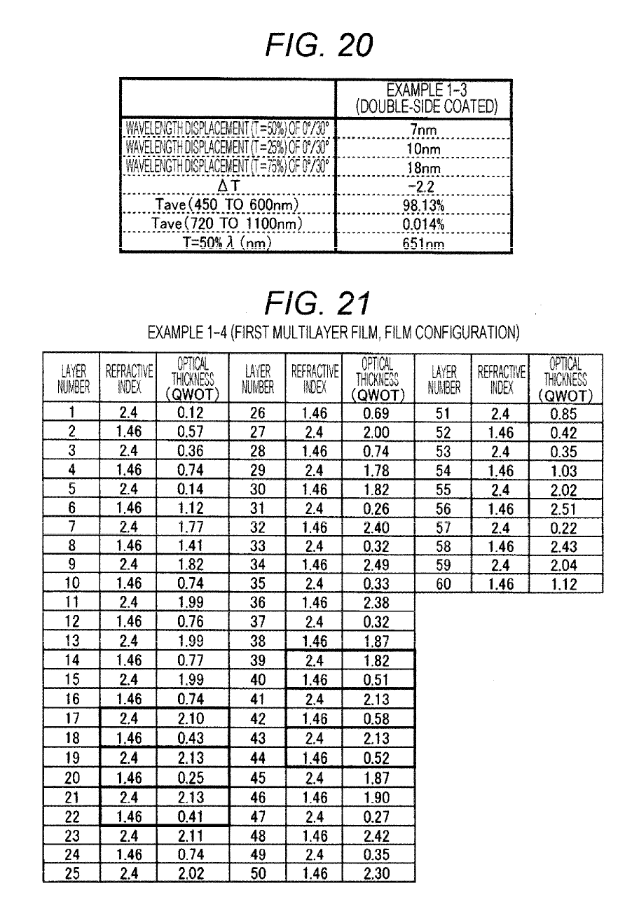

FIG. 20 illustrates characteristics of the IR cut filter in the double-side coated state. From the drawing, it can be said that the second multilayer film in the double-side coated state has spectral characteristics satisfying all the seven items of (a) to (g).

From FIG. 19, it can be seen that it is possible to realize an IR cut filter of low incidence angle dependency as a whole which can satisfactorily cut off near-infrared light in a broader wavelength region by performing double-side coating.

Particularly, the cutoff wavelength (684 nm) of the second multilayer film is closer to a long wavelength side than the cutoff wavelength (651 nm) of the first multilayer film and the difference is equal to or greater than 30 nm which is great. Accordingly, even when the incidence angle dependency of the second multilayer film is great, the cutoff wavelength of the second multilayer film can be prevented from passing over the cutoff wavelength of the first multilayer film and being shifted to a short wavelength side with a variation in incidence angle. Accordingly, the effect of decreasing the incidence angle dependency due to the first multilayer film can be prevented from being damaged by the spectral characteristics (incidence angle dependency) of the second multilayer film.

In Example 1-3, it can be seen that the transmittance of a wavelength 710 nm at the incidence angle of 0° in the second multilayer film is 0.51% which is equal to or less than 5%. Accordingly, it is possible to satisfactorily secure the reflection characteristic of near-infrared light using the second multilayer film.

In Example 1-3, T_{A}50% λ(30°)=644 nm and T_{B}50% λ(30°)=657 nm can be seen. In this case, T_{A}50%(30°)−T_{B}50% λ(30°)=−13 nm which is equal to or less than 8 nm. Accordingly, it is possible to satisfactorily secure the reflection characteristic of near-infrared light using the second multilayer film without greatly damaging the low incidence angle dependency which is achieved by the first multilayer film.

### Example 1-4

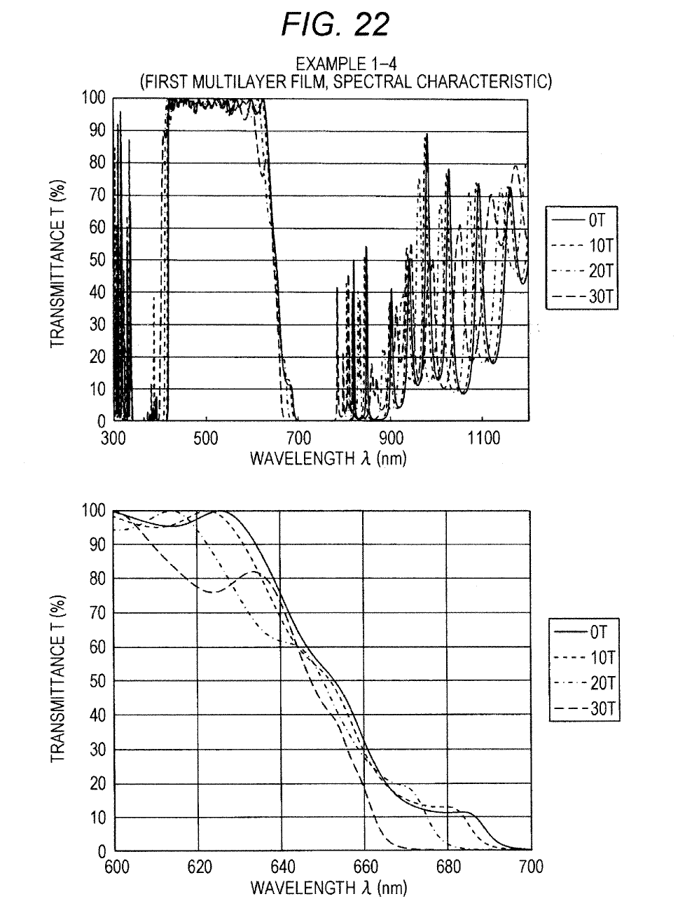

FIG. 21 is a diagram illustrating a film configuration of a first multilayer film of an IR cut filter according to Example 1-4. FIG. 22 is a graph illustrating spectral characteristics of the first multilayer film. The first multilayer film according to Example 1-4 is formed by alternately stacking a high refractive index layer (with a refractive index of 2.4) and a low refractive index layer (with a refractive index of 1.46). For example, the same materials as in Example 1-1 can be used as a high refractive index material with a refractive index of 2.4 and a low refractive index material with a refractive index of 1.46.

The first multilayer film is configured to have 6 cutoff adjustment pairs in which H/L is equal to or greater than 3, where Δn×nH=2.26 and ΔT=−2.1%/nm. The spectral characteristics of the first multilayer film satisfy all the five items of (A) to (E) and performance of low incidence angle dependency is realized.

### Example 1-5

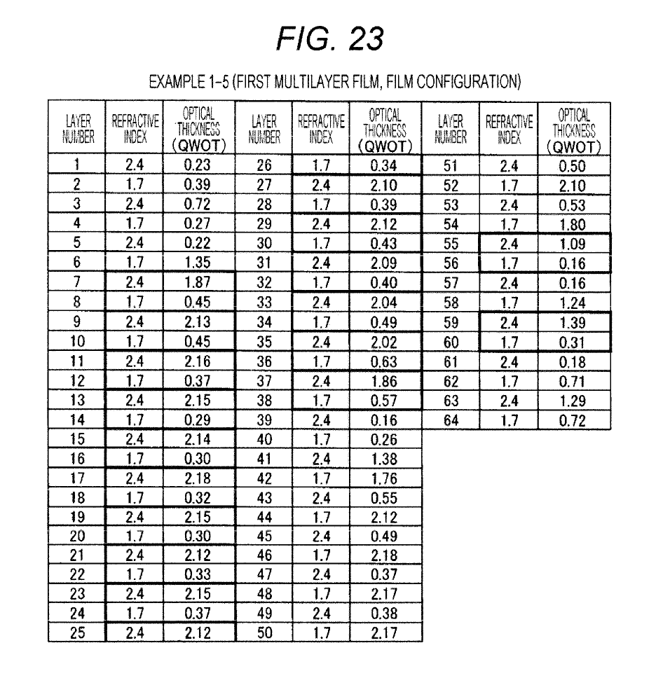

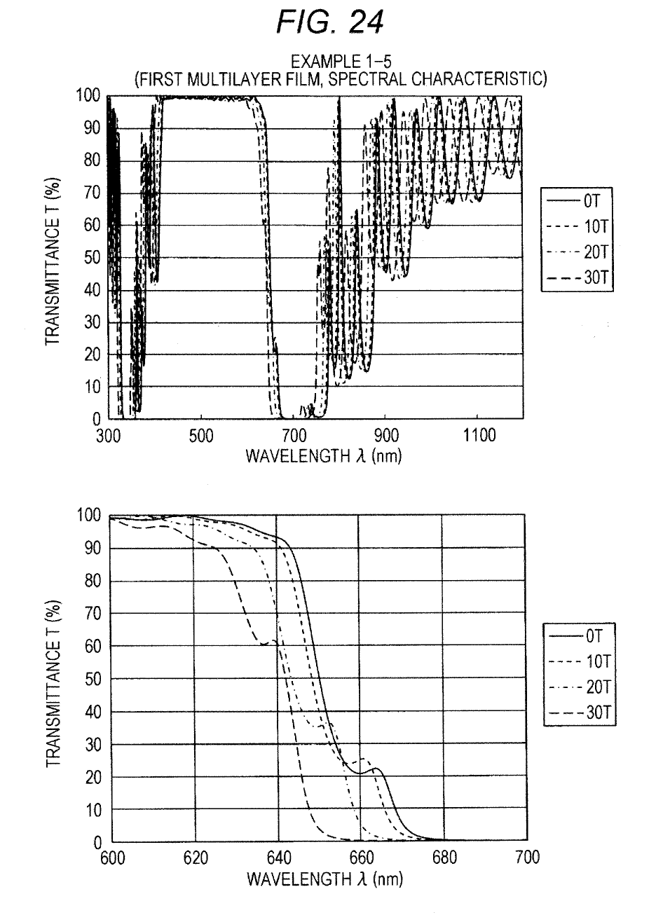

FIG. 23 is a diagram illustrating a film configuration of a first multilayer film of an IR cut filter according to Example 1-5. FIG. 24 is a graph illustrating spectral characteristics of the first multilayer film. The first multilayer film according to Example 1-5 is formed by alternately stacking a high refractive index layer (with a refractive index of 2.4) and a low refractive index layer (with a refractive index of 1.7). For example, the same materials as in Example 1-2 can be used as a high refractive index material with a refractive index of 2.4 and a low refractive index material with a refractive index of 1.7.

The first multilayer film is configured to have 18 cutoff adjustment pairs in which H/L is equal to or greater than 3, where Δn×nH=1.68 and ΔT=−5.2%/nm. The spectral characteristics of the first multilayer film satisfy all the five items of (A) to (E) and performance of low incidence angle dependency is realized.

### Example 1-6

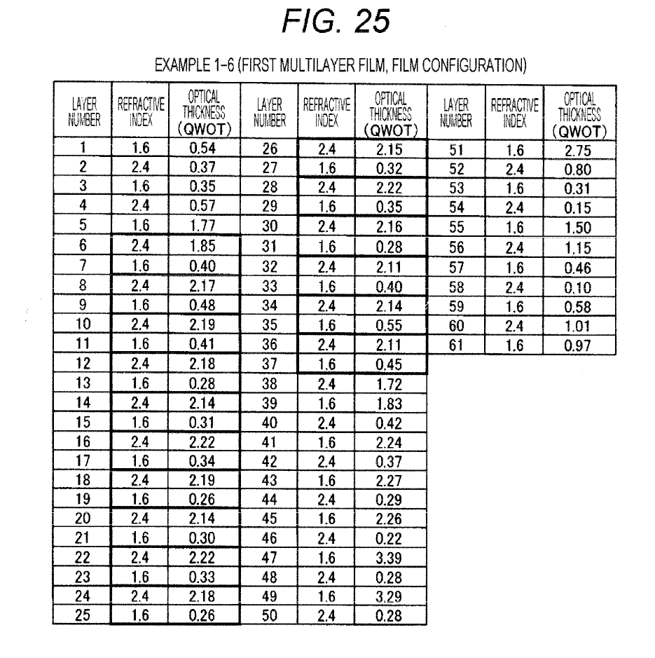

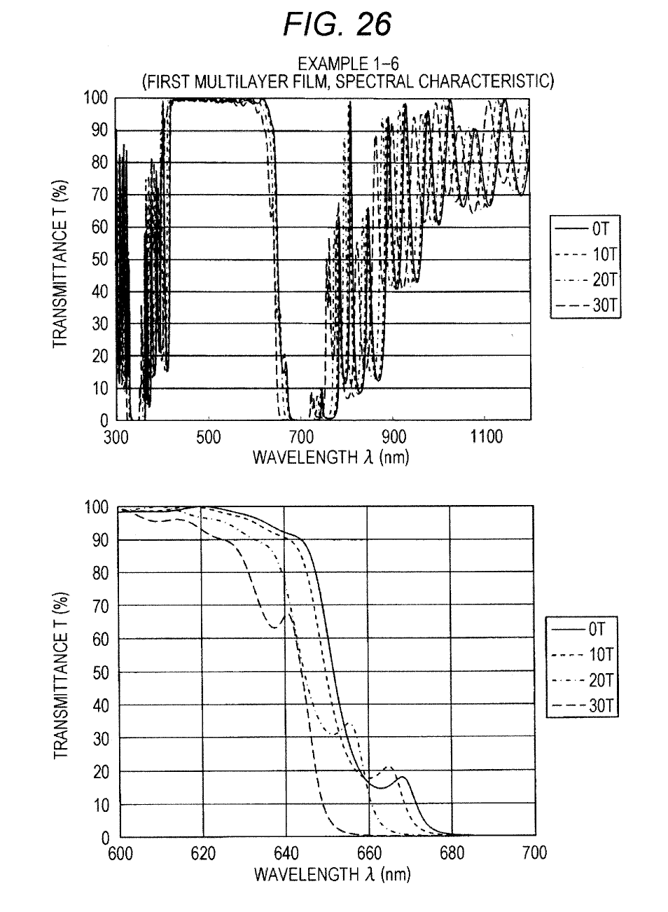

FIG. 25 is a diagram illustrating a film configuration of a first multilayer film of an IR cut filter according to Example 1-6. FIG. 26 is a graph illustrating spectral characteristics of the first multilayer film. The first multilayer film according to Example 1-6 is formed by alternately stacking a high refractive index layer (with a refractive index of 2.4) and a low refractive index layer (with a refractive index of 1.6). For example, the same material as in Example 1-1 can be used as a high refractive index material with a refractive index of 2.4 and, for example, Al₂O₃ can be used as a low refractive index material with a refractive index of 1.6.

The first multilayer film is configured to have 16 cutoff adjustment pairs in which H/L is equal to or greater than 3, where Δn×nH=1.92 and ΔT=−6.2%/nm. The spectral characteristics of the first multilayer film satisfy all the five items of (A) to (E) and performance of low incidence angle dependency is realized.

### Example 1-7

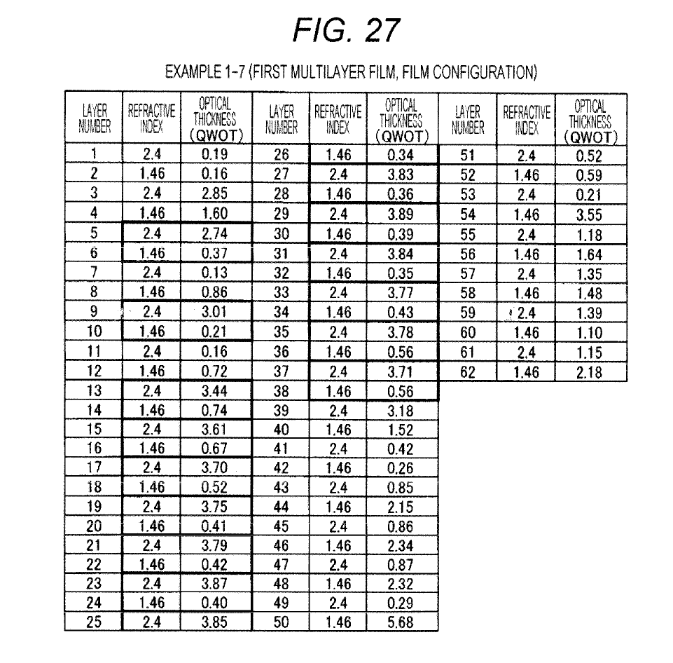

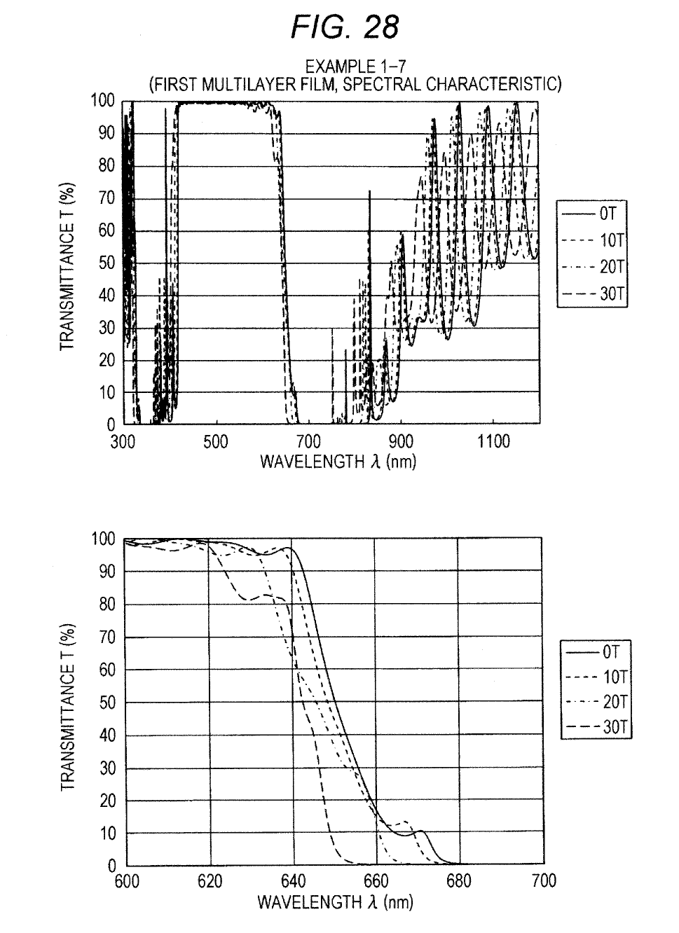

FIG. 27 is a diagram illustrating a film configuration of a first multilayer film of an IR cut filter according to Example 1-7. FIG. 28 is a graph illustrating spectral characteristics of the first multilayer film. The first multilayer film according to Example 1-7 is formed by alternately stacking a high refractive index layer (with a refractive index of 2.4) and a low refractive index layer (with a refractive index of 1.46). For example, the same materials as in Example 1-1 can be used as a high refractive index material with a refractive index of 2.4 and a low refractive index material with a refractive index of 1.46.

The first multilayer film is configured to have 15 cutoff adjustment pairs in which H/L is equal to or greater than 3, where Δn×nH=2.26 and ΔT=−4.1%/nm. The spectral characteristics of the first multilayer film satisfy all the five items of (A) to (E) and performance of low incidence angle dependency is realized.

### Example 1-8

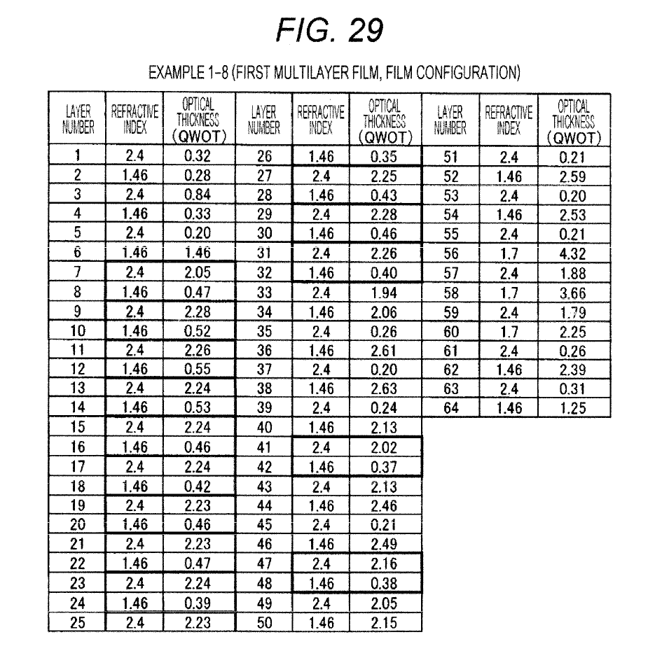

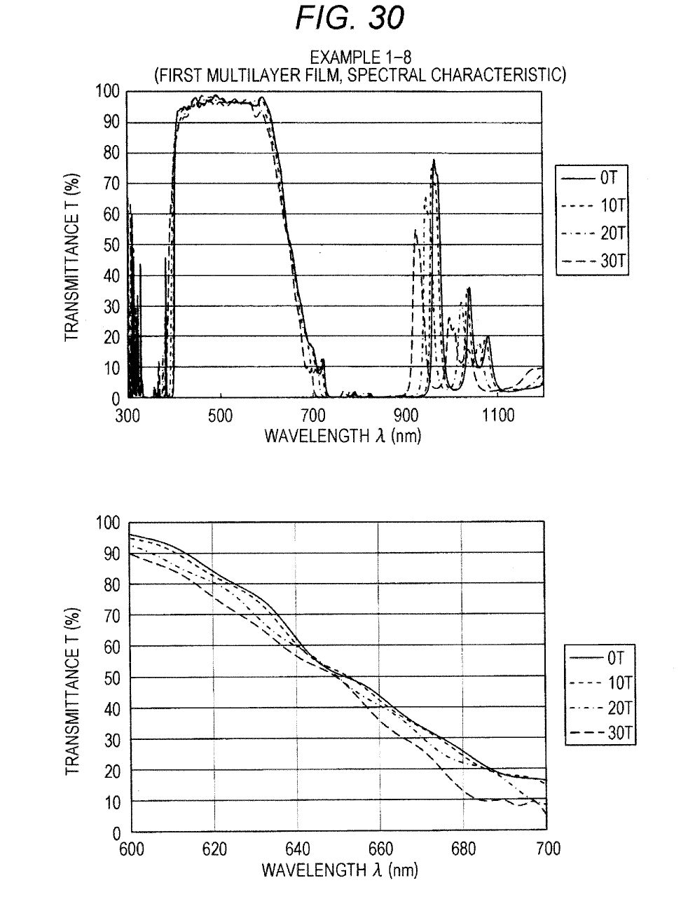

FIG. 29 is a diagram illustrating a film configuration of a first multilayer film of an IR cut filter according to Example 1-8. FIG. 30 is a graph illustrating spectral characteristics of the first multilayer film. The first multilayer film according to Example 1-8 is formed by alternately stacking a high refractive index layer and a low refractive index layer using three types of materials having different refractive indices. More specifically, materials having refractive indices of 2.4, 1.46, and 1.7 are used as the three types of materials having different refractive indices. For example, TiO₂ can be used as the material with a refractive index of 2.4, for example, SiO₂ can be used as the material with a refractive index of 1.46, and for example, substance M2 (made by Merck KGaA) can be used as the material with a refractive index of 1.7.

Since the average refractive index of the three types of layers having different refractive indices is 1.853, the layer with a refractive index of 2.4 of which the refractive index is greater than the average value is considered as a high refractive index layer and the other layers (the layers with refractive indices of 1.46 and 1.7) of which the refractive index is less than the average value is considered as a low refractive index layer in Example 1-8. Since the maximum refractive index nH among the refractive indices of the three types of layers is 2.4 and the minimum refractive index nL is 1.46, Δn=nH−nL=0.94 is obtained.

The first multilayer film is configured to have 15 cutoff adjustment pairs in which H/L is equal to or greater than 3, where Δn×nH=2.26 and ΔT=−1.0%/nm. The spectral characteristics of the first multilayer film satisfy all the five items of (A) to (E) and performance of low incidence angle dependency is realized.

### Example 1-9

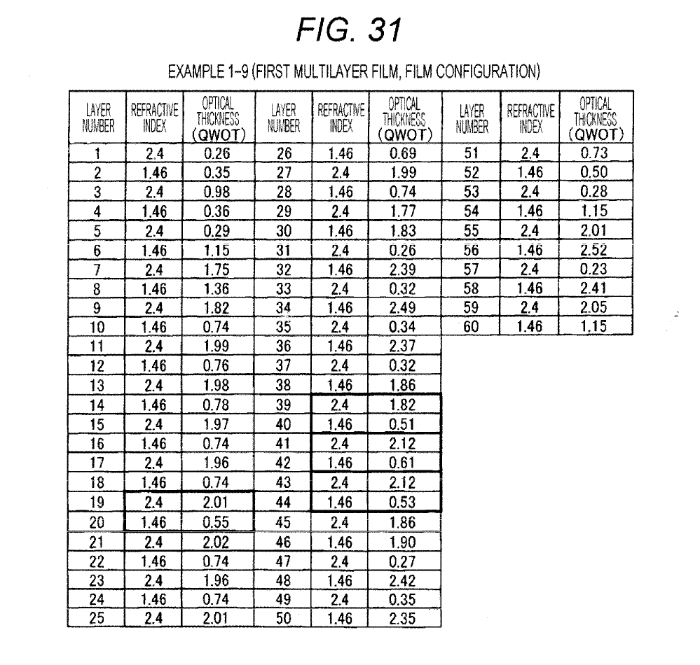

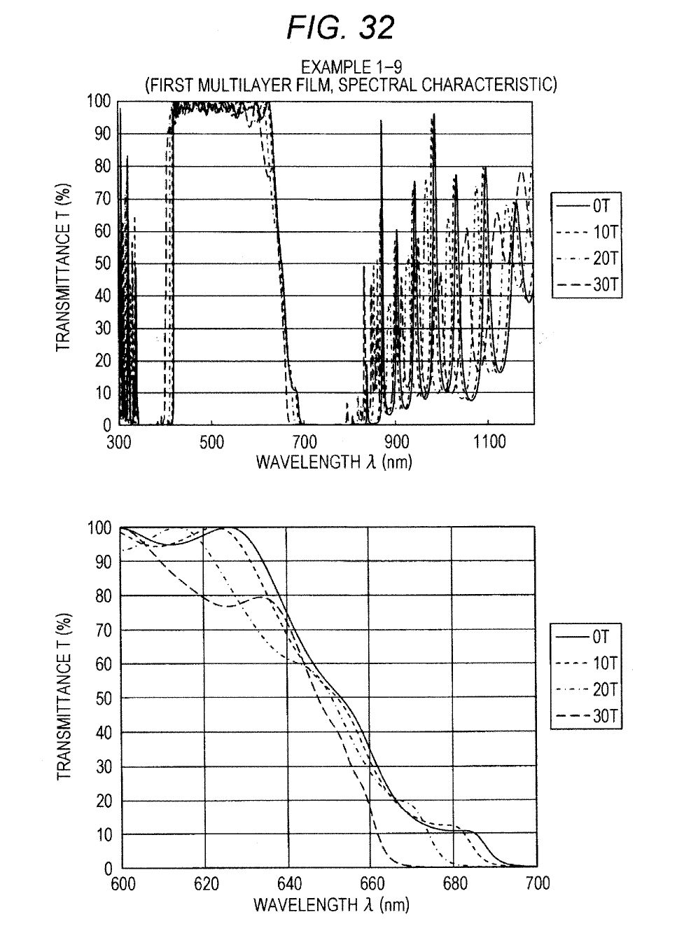

FIG. 31 is a diagram illustrating a film configuration of a first multilayer film of an IR cut filter according to Example 1-9. FIG. 32 is a graph illustrating spectral characteristics of the first multilayer film. The first multilayer film according to Example 1-9 is formed by alternately stacking a high refractive index layer (with a refractive index of 2.4) and a low refractive index layer (with a refractive index of 1.46). For example, TiO₂ and SiO₂ can be used as a high refractive index material with a refractive index of 2.4 and a low refractive index material with a refractive index of 1.46 as in Example 1-1.

The first multilayer film is configured to have 4 cutoff adjustment pairs in which H/L is equal to or greater than 3, where Δn×nH=2.26 and ΔT=−2.0%/nm. The spectral characteristics of the first multilayer film satisfy all the five items of (A) to (E) and performance of low incidence angle dependency is realized.

### Comparative Example 1-1

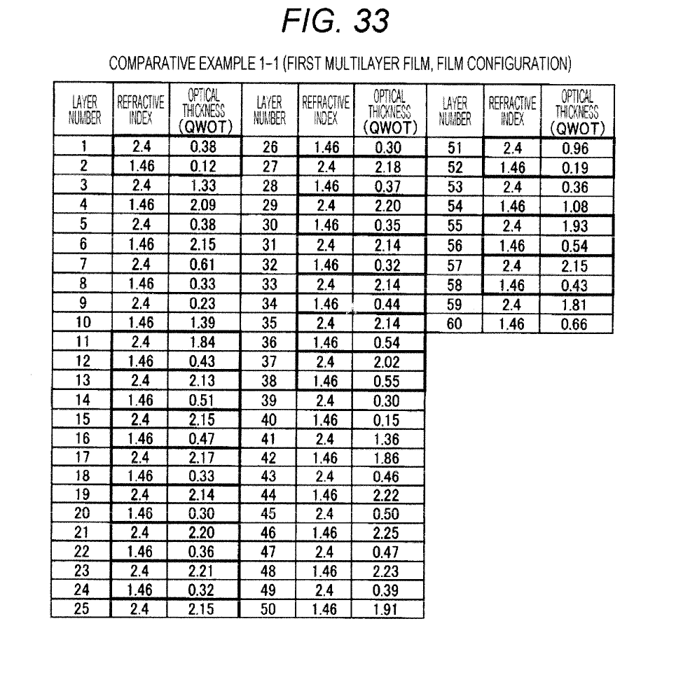

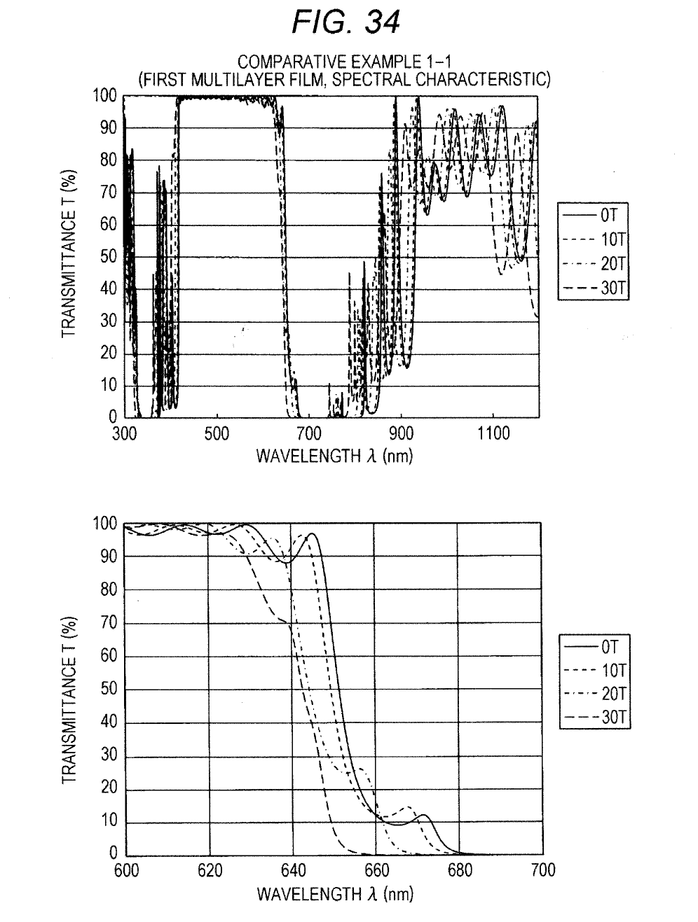

FIG. 33 is a diagram illustrating a film configuration of a first multilayer film of an IR cut filter according to Comparative Example 1-1. FIG. 34 is a graph illustrating spectral characteristics of the first multilayer film. The first multilayer film according to Comparative Example 1-1 is formed by alternately stacking a high refractive index layer (with a refractive index of 2.4) and a low refractive index layer (with a refractive index of 1.46). For example, TiO₂ and SiO₂ can be used as a high refractive index material with a refractive index of 2.4 and a low refractive index material with a refractive index of 1.46 as in Example 1-1.

The first multilayer film is configured to have 18 cutoff adjustment pairs in which H/L is equal to or greater than 3, where Δn×nH=2.26 and ΔT=−7.8%/nm which does not satisfy |ΔT|<7%/nm. The wavelength shift (T=50%) between the incidence angle of 0° and the incidence angle of 30° is 9 nm which is greater than 8 nm. As a result, it cannot be said in Comparative Example 1-1 that the low incidence angle dependency is realized.

### Comparative Example 1-2

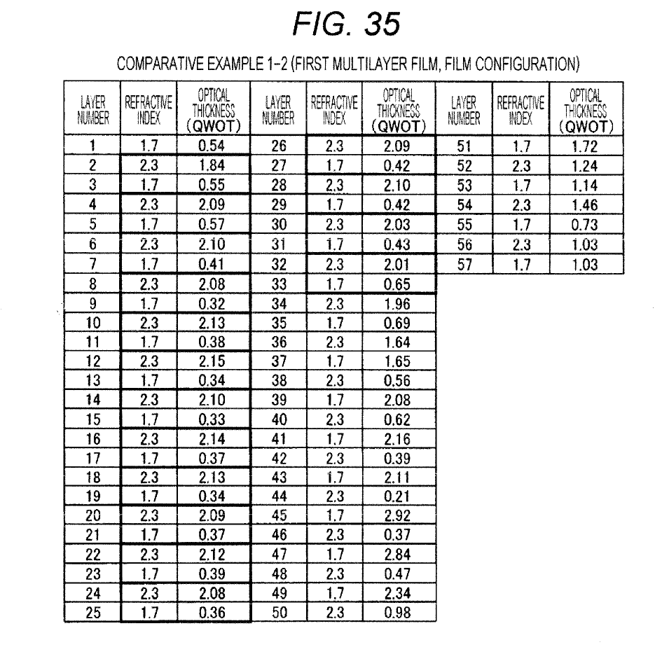

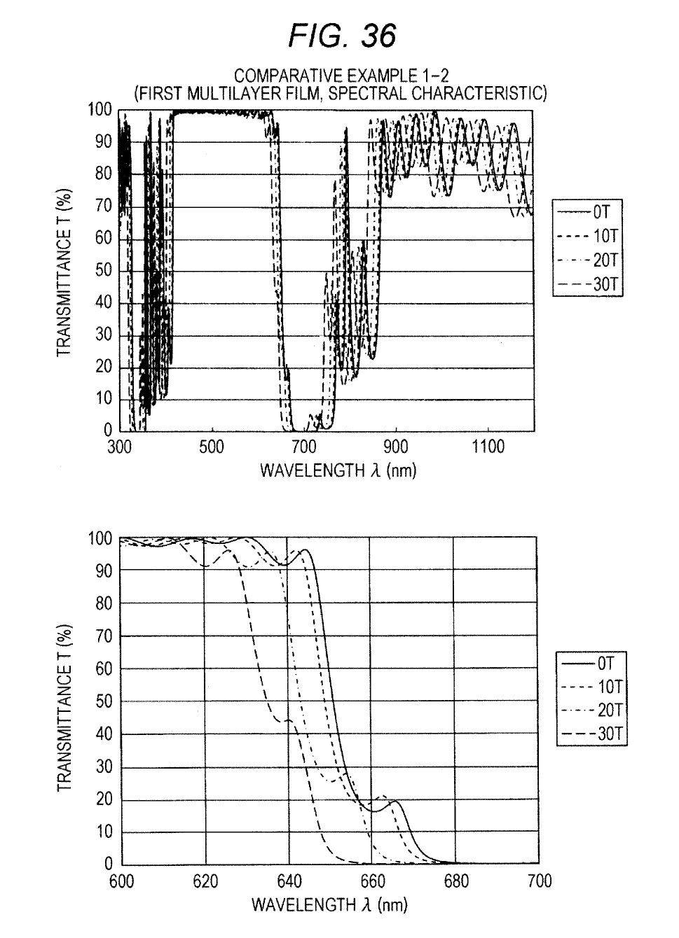

FIG. 35 is a diagram illustrating a film configuration of a first multilayer film of an IR cut filter according to Comparative Example 1-2. FIG. 36 is a graph illustrating spectral characteristics of the first multilayer film. The first multilayer film according to Comparative Example 1-2 is formed by alternately stacking a high refractive index layer (with a refractive index of 2.3) and a low refractive index layer (with a refractive index of 1.7). For example, Nb₂O₅ can be used as a high refractive index material with a refractive index of 2.3 and, for example, substance M2 (made by Merck KGaA) can be used as a low refractive index material with a refractive index of 1.7.

In the first multilayer film, ΔT=−7.5%/nm which does not satisfy |ΔT|<7%/nm. The wavelength shift (T=50%) between the incidence angle of 0° and the incidence angle of 30° is 16 nm which is much greater than 8 nm. As a result, it cannot be said in Comparative Example 1-2 that the low incidence angle dependency is realized.

The first multilayer film according to Comparative Example 1-2 is configured to have 16 cutoff adjustment pairs in which H/L is equal to or greater than 3, where Δn×nH=1.38 which does not satisfy Δn×nH≧1.5. This is considered to affect the wavelength shift (T=50%).

### Comparative Example 1-3

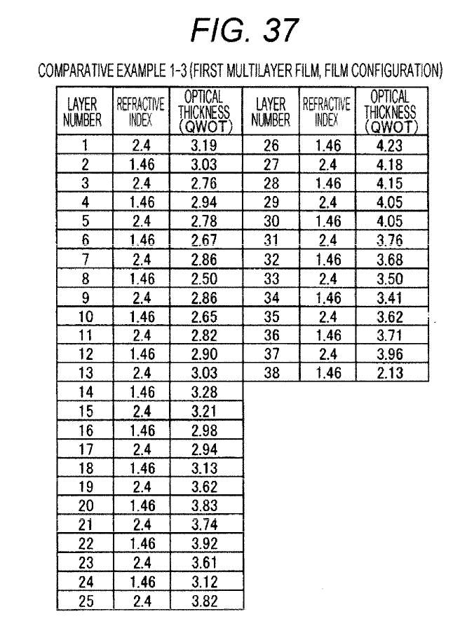

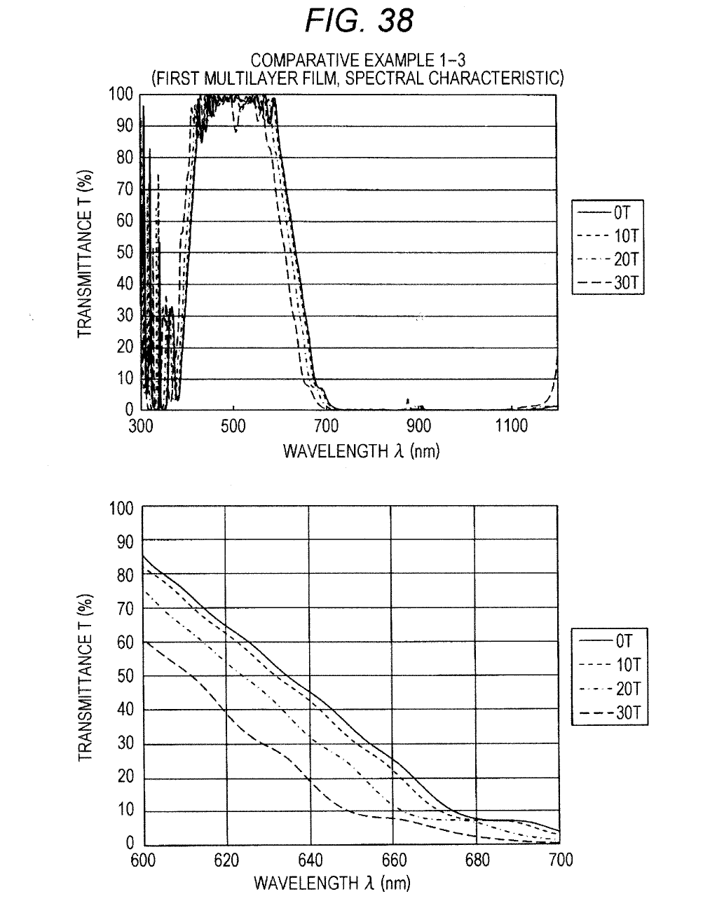

FIG. 37 is a diagram illustrating a film configuration of a first multilayer film of an IR cut filter according to Comparative Example 1-3. FIG. 38 is a graph illustrating spectral characteristics of the first multilayer film. The first multilayer film according to Comparative Example 1-3 is formed by alternately stacking a high refractive index layer (with a refractive index of 2.4) and a low refractive index layer (with a refractive index of 1.46). For example, TiO₂ and SiO₂ can be used as a high refractive index material with a refractive index of 2.4 and a low refractive index material with a refractive index of 1.46 as in Example 1-1.

In the first multilayer film, ΔT=−1.0%/nm which satisfies 0.5%/nm<|ΔT|<7%/nm, but the wavelength shift (T=50%) between the incidence angle of 0° and the incidence angle of 30° is 23 nm which is much greater than 8 nm. The wavelength shift (T=25%) between the incidence angle of 0° and the incidence angle of 30° and the wavelength shift (T=75%) between the incidence angle of 0° and the incidence angle of 30° are 25 nm and 22 nm, respectively, which are greater than 20 nm. Accordingly, it cannot be said in Comparative Example 1-3 that the low incidence angle dependency is realized.

In the first multilayer film according to Comparative Example 1-3, Δn×nH=2.26 which satisfies Δn×nH≧1.5, but there is no cutoff adjustment pair in which H/L is equal to or greater than 3. This is considered to affect the wavelength shifts.

### Comparative Example 1-4

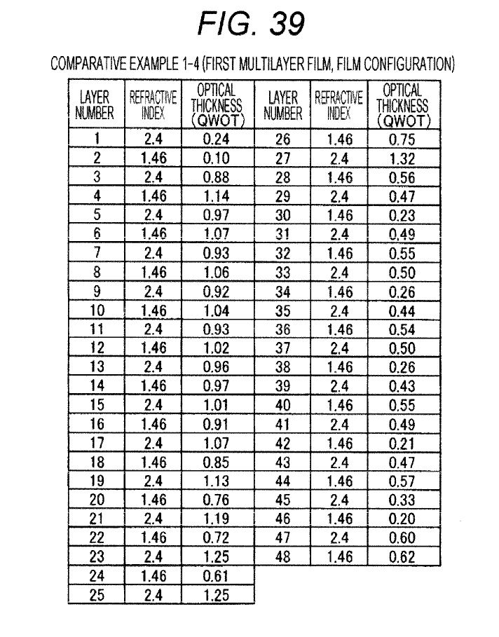

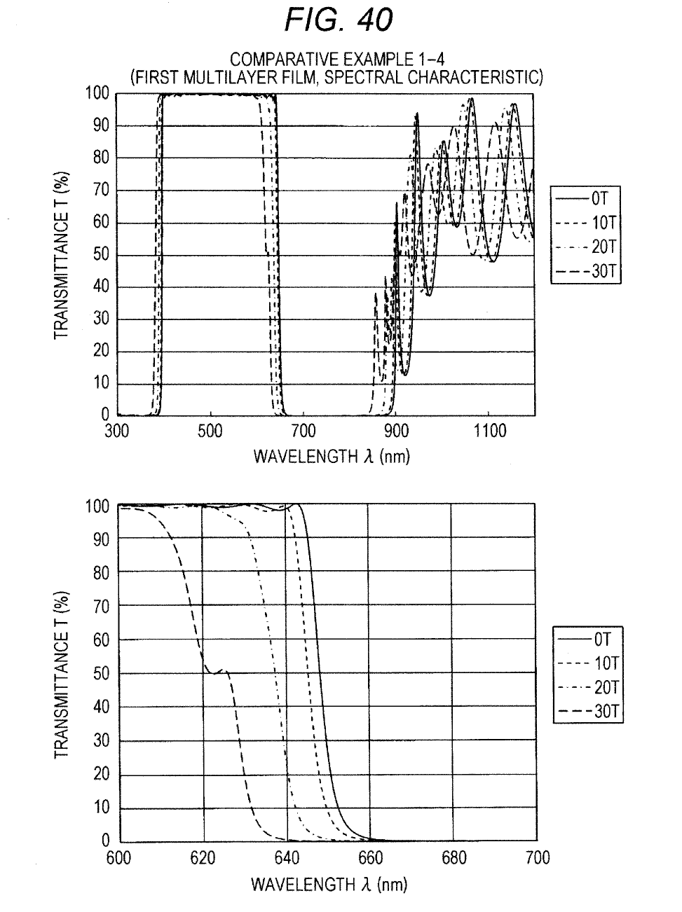

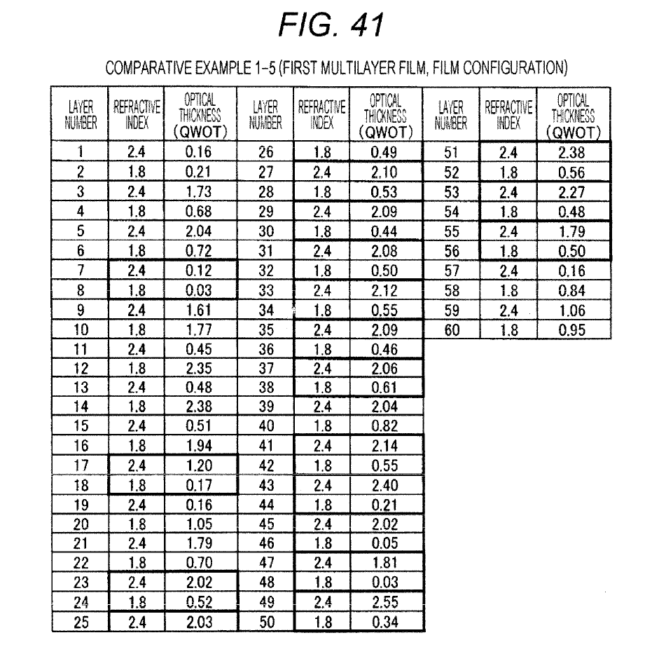

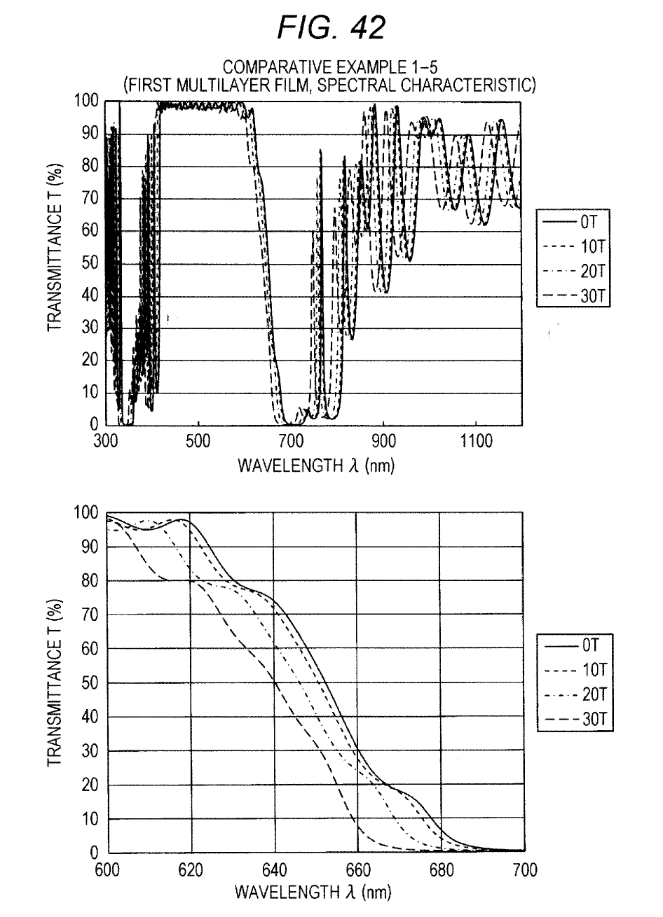

FIG. 39 is a diagram illustrating a film configuration of a first multilayer film of an IR cut filter according to Comparative Example 1-4. FIG. 40 is a graph illustrating spectral characteristics of the first multilayer film. The first multilayer film according to Comparative Example 1-4 is formed by alternately stacking a high refractive index layer (with a refractive index of 2.4) and a low refractive index layer (with a refractive index of 1.46). For example, TiO₂ and SiO₂ can be used as a high refractive index material with a refractive index of 2.4 and a low refractive index material with a refractive index of 1.46 as in Example 1-1.

In the first multilayer film, ΔT=−12.7%/nm which does not satisfy |ΔT|<7%/nm. The wavelength shift (T=50%) between the incidence angle of 0° and the incidence angle of 30°, the wavelength shift (T=25%) between the incidence angle of 0° and the incidence angle of 30°, and the wavelength shift (T=75%) between the incidence angle of 0° and the incidence angle of 30° are 27 nm, 21 nm and 30 nm which are greater than 8 nm, 20 nm, and 20 nm, respectively. Accordingly, it cannot be said in Comparative Example 1-4 that the low incidence angle dependency is realized.

In the first multilayer film according to Comparative Example 1-4, Δn×nH=2.26 which satisfies Δn×nH≧1.5, but there is no cutoff adjustment pair in which H/L is equal to or greater than 3. This is considered to affect the wavelength shifts.

### Comparative Example 1-5

FIG. 41 is a diagram illustrating a film configuration of a first multilayer film of an IR cut filter according to Comparative Example 1-5. FIG. 42 is a graph illustrating spectral characteristics of the first multilayer film. The first multilayer film according to Comparative Example 1-5 is formed by alternately stacking a high refractive index layer (with a refractive index of 2.4) and a low refractive index layer (with a refractive index of 1.8). For example, TiO₂ can be used as a high refractive index material with a refractive index of 2.4 and, for example, substance M3 (a mixture of Al₂O₃ and La₂O₂) made by Merck KGaA can be used as a low refractive index material with a refractive index of 1.8.

In the first multilayer film, ΔT=−2.3%/nm which satisfies 0.5%/nm<|ΔT|<7%/nm, but the wavelength shift (T=50%) between the incidence angle of 0° and the incidence angle of 30° is 12 nm which is greater than 8 nm. Accordingly, it cannot be said in Comparative Example 1-5 that the low incidence angle dependency is realized.

The first multilayer film according to Comparative Example 1-5 is configured to have 18 cutoff adjustment pairs in which H/L is equal to or greater than 3, where Δn×nH=1.44 which does not satisfy Δn×nH≧1.5. This is considered to affect the wavelength shift (T=50%).

### Comparative Example 1-6

FIG. 43 is a diagram illustrating a film configuration of a first multilayer film of an IR cut filter according to Comparative Example 1-6. FIG. 44 is a graph illustrating spectral characteristics of the first multilayer film. The first multilayer film according to Comparative Example 1-6 is formed by alternately stacking a high refractive index layer (with a refractive index of 2.4) and a low refractive index layer (with a refractive index of 1.7). For example, TiO₂ can be used as a high refractive index material with a refractive index of 2.4 and, for example, substance M2 (made by Merck KGaA) can be used as a low refractive index material with a refractive index of 1.7.

The first multilayer film is configured to have 16 cutoff adjustment pairs in which H/L is equal to or greater than 3, where Δn×nH=1.68 which satisfies Δn×nH≧1.5 and ΔT=−7.6%/nm which does not satisfy |ΔT|<7%/nm. The wavelength shift (T=50%) between the incidence angle of 0° and the incidence angle of 30° is 14 nm which is greater than 8 nm. Accordingly, it cannot be said in Comparative Example 1-6 that the low incidence angle dependency is realized.

### Comparative Example 1-7

FIG. 45 is a diagram illustrating a film configuration of a first multilayer film of an IR cut filter according to Comparative Example 1-7. FIG. 46 is a graph illustrating spectral characteristics of the first multilayer film. The first multilayer film according to Comparative Example 1-7 is formed by alternately stacking a high refractive index layer (with a refractive index of 2.4) and a low refractive index layer (with a refractive index of 1.8). For example, TiO₂ can be used as a high refractive index material with a refractive index of 2.4 and, for example, substance M3 (made by Merck KGaA) can be used as a low refractive index material with a refractive index of 1.8.

In the first multilayer film, ΔT=−6.4%/nm which satisfies 0.5%/nm<|ΔT|<7%/nm, but the wavelength shift (T=50%) between the incidence angle of 0° and the incidence angle of 30° is 15 nm which is greater than 8 nm. Accordingly, it cannot be said in Comparative Example 1-7 that the low incidence angle dependency is realized.

The first multilayer film according to Comparative Example 1-7 is configured to have 15 cutoff adjustment pairs in which H/L is equal to or greater than 3, where Δn×nH=1.44 which does not satisfy Δn×nH≧1.5. This is considered to affect the wavelength shift (T=50%).

### Comparative Example 1-8

FIG. 47 is a diagram illustrating a film configuration of a first multilayer film of an IR cut filter according to Comparative Example 1-8. FIG. 48 is a graph illustrating spectral characteristics of the first multilayer film. The first multilayer film according to Comparative Example 1-8 is formed by alternately stacking a high refractive index layer (with a refractive index of 2.4) and a low refractive index layer (with a refractive index of 1.8). For example, TiO₂ can be used as a high refractive index material with a refractive index of 2.4 and, for example, substance M3 (made by Merck KGaA) can be used as a low refractive index material with a refractive index of 1.8.

In the first multilayer film, ΔT=−4.3%/nm which satisfies 0.5%/nm<|ΔT|<7%/nm, but the wavelength shift (T=50%) between the incidence angle of 0° and the incidence angle of 30° is 9 nm which is greater than 8 nm. Accordingly, it cannot be said in Comparative Example 1-8 that the low incidence angle dependency is realized.

The first multilayer film according to Comparative Example 1-8 is configured to have 14 cutoff adjustment pairs in which H/L is equal to or greater than 3, where Δn×nH=1.44 which does not satisfy Δn×nH≧1.5. This is considered to affect the wavelength shift (T=50%).

### Comparative Example 1-9

FIG. 49 is a diagram illustrating a film configuration of a first multilayer film of an IR cut filter according to Comparative Example 1-9. FIG. 50 is a graph illustrating spectral characteristics of the first multilayer film. The first multilayer film according to Comparative Example 1-9 corresponds to the multilayer film having 38 layers in Patent Literature 1, and is formed by alternately stacking a high refractive index layer (with a refractive index of 2.4) and a low refractive index layer (with a refractive index of 1.46). For example, TiO₂ and SiO₂ can be used as a high refractive index material with a refractive index of 2.4 and a low refractive index material with a refractive index of 1.46, respectively.

In the first multilayer film, ΔT=−1.1%/nm which satisfies 0.5%/nm<|ΔT|<7%/nm, but the wavelength shift (T=50%) between the incidence angle of 0° and the incidence angle of 30° is 27 nm which is much greater than 8 nm. The wavelength shift (T=25%) between the incidence angle of 0° and the incidence angle of 30° and the wavelength shift (T=75%) between the incidence angle of 0° and the incidence angle of 30° are 27 nm and 24 nm, respectively, which are greater than 20 nm. Accordingly, it cannot be said in Comparative Example 1-9 that the low incidence angle dependency is realized.

In the first multilayer film according to Comparative Example 1-9, Δn×nH=2.26 which satisfies Δn×nH≧1.5, but there is no cutoff adjustment pair in which H/L is equal to or greater than 3. This is considered to affect the wavelength shifts.

### Comparative Example 1-10

FIG. 51 is a diagram illustrating a film configuration of a first multilayer film of an IR cut filter according to Comparative Example 1-10. FIG. 52 is a graph illustrating spectral characteristics of the first multilayer film. The first multilayer film according to Comparative Example 1-10 corresponds to the multilayer film having 30 layers in Patent Literature 2, and is formed by alternately stacking a high refractive index layer (with a refractive index of 2.249) and a low refractive index layer (with a refractive index of 1.903). The high refractive index layer with a refractive index of 2.249 is formed of a mixture material in which SiO₂ with a refractive index of 1.46 and Nb₂O₅ with a refractive index of 2.330 are mixed at a ratio of 10:90. The low refractive index layer with a refractive index of 1.903 is formed of a mixture material in which SiO₂ and Nb₂O₅ are mixed at a ratio of 50:50.

In the first multilayer film, ΔT=−5.8%/nm which satisfies 0.5%/nm<|ΔT|<7%/nm, but the wavelength shift (T=50%) between the incidence angle of 0° and the incidence angle of 30° is 20 nm which is much greater than 8 nm. Accordingly, it cannot be said in Comparative Example 1-10 that the low incidence angle dependency is realized.

The first multilayer film according to Comparative Example 1-10 has no cutoff adjustment pair in which H/L is equal to or greater than 3. Δn×nH=0.78 which does not satisfy Δn×nH≧1.5. This is considered to affect the wavelength shift (T=50%).

[Supplement]

In the first multilayer film (multilayer film 3), the wavelength with transmittance of 25% in the wavelength region of 600 nm to 700 nm is located on a longer wavelength side than the cutoff wavelength (for example, 650 nm) with transmittance of 50% (for example, see FIG. 8). Accordingly, the sensitivity of the imaging element 12 of the image capturing device 10 illustrated in FIG. 7 is lower on a wavelength side longer than 650 nm than on a wavelength side shorter than 650 nm. For this reason and since the intensity of light on a wavelength side longer than 650 nm is small, the influence of the wavelength shift at transmittance of 25% is less than the influence of the wavelength shift at transmittance of 75% as a whole. Accordingly, even when one of the above-mentioned conditions, that is, the condition that the difference in wavelength with transmittance of 25% between the incidence angle of 0° and the incidence angle of 30° is equal to or less than 20 nm, is not satisfied, it is possible to realize the IR cut filter 1 of low incidence angle dependency. From the viewpoint of surely achieving the effect, it is preferable that the above-mentioned condition be satisfied. This is true when the first multilayer film is formed on one surface of the substrate and the second multilayer film (multilayer film 6) is formed on the opposite surface.

As a result, the IR cut filter according to the first embodiment may have the following configuration.

That is, the IR cut filter is an IR cut filter having a substrate and a multilayer film formed on the substrate, the multilayer film includes a high refractive index layer and a low refractive index layer which are alternately stacked, and in the multilayer film,

the average transmittance in a wavelength region of 450 nm to 600 nm is equal to or greater than 90%,

the wavelength with transmittance of 50% at the incidence angle of 0° is in a range of 650±25 nm,

0.5%/nm<|ΔT|<7%/nm is satisfied,

the difference in wavelength with transmittance of 50% between the incidence angle of 0° and the incidence angle of 30° in a wavelength region of 600 nm to 700 nm is equal to or less than 8 nm, and

the difference in wavelength with transmittance of 75% between the incidence angle of 0° and the incidence angle of 30° in the wavelength region is equal to or less than 20 nm,

|ΔT|: value (%/nm) of |(T_{70%}−T_{30%})/(λ_{70%}−λ_{30%})| at the incidence angle of 0°

T_{70%}: transmittance value of 70%

T_{30%}: transmittance value of 30%

λ_{70%}: wavelength (nm) with transmittance of 70%

λ_{30%}: wavelength (nm) with transmittance of 30%.

According to this configuration, it is possible to suppress a variation in spectral characteristics with respect to a great variation in incidence angle (for example, a variation of 30°) and thus to realize an IR cut filter of low incidence angle dependency which can satisfactorily cope with the low profile of the imaging lens.

In the multilayer film, it is preferable that the difference in wavelength with transmittance of 25% between the incidence angle of 0° and the incidence angle of 30° in the wavelength region of 600 nm to 700 nm be equal to or less than 20 nm.

It is preferable that the multilayer film include at least four cutoff adjustment pairs in which an optical thickness ratio between the high refractive index layer and the low refractive index layer adjacent to each other is equal to or greater than 3, and that when a difference between a maximum refractive index and a minimum refractive index among the refractive indices of layers constituting the multilayer film is Δn and the maximum refractive index is nH, Δn×nH≧1.5 be satisfied.

The total thickness of the multilayer film may be equal to or greater than 3000 nm.

It is preferable that when the multilayer film is a first multilayer film, a second multilayer film be formed on the opposite surface of the substrate to the surface on which the first multilayer film is formed, and that the second multilayer film have a spectral characteristics in which average transmittance in the wavelength region of 450 nm to 600 nm is equal to or greater than 80% and average transmittance in a wavelength region of 720 nm to 1100 nm is equal to or less than 5% in a state in which the first multilayer film is formed on one surface of the substrate and the second multilayer film is formed on the opposite surface of the substrate.

It is preferable that the second multilayer film have a spectral characteristic that in the state in which the first multilayer film is formed on one surface of the substrate and the second multilayer film is formed on the opposite surface of the substrate,

a wavelength with transmittance of 50% at the incidence angle of 0° is in a range of 650±25 nm,

0.5%/nm<|ΔT|<7%/nm is satisfied,

the difference in wavelength with transmittance of 50% between the incidence angle of 0° and the incidence angle of 30° in a wavelength region of 600 nm to 700 nm is equal to or less than 8 nm, and

the difference in wavelength with transmittance of 75% between the incidence angle of 0° and the incidence angle of 30° in the wavelength region is equal to or less than 20 nm.

It is preferable that the second multilayer film have a spectral characteristic that in the state in which the first multilayer film is formed on one surface of the substrate and the second multilayer film is formed on the opposite surface of the substrate,

the difference in wavelength with transmittance of 25% between the incidence angle of 0° and the incidence angle of 30° in the wavelength region of 600 nm to 700 nm is equal to or less than 20 nm.

It is preferable that the average transmittance in the wavelength region of 450 nm to 600 nm in the second multilayer film be equal to or greater than 90%, and the wavelength with transmittance of 50% at the incidence angle of 0° in the second multilayer film be located on a longer wavelength side than the wavelength with transmittance of 50% at the incidence angle of 0° in the first multilayer film.

The IR cut filter may further include a resin layer having an absorption peak in the wavelength region of 600 nm to 700 nm, which will be described in a fourth embodiment to be described later.

### Second Embodiment

A second embodiment of the present invention will be described below with reference to the accompanying drawings as follows. An IR cut filter 1 according to this embodiment is the same as the configuration of the first embodiment illustrated in FIG. 1, in that the IR cut filter includes a multilayer film 3 (first multilayer film) on a transparent substrate 2.

The multilayer film 3 has the following characteristics.

(1) The average transmittance in a wavelength region of 450 nm to 600 nm is equal to or greater than 90%.

(2) The wavelength with transmittance of 50% at an incidence angle of 0° is in a range of 650±25 nm. Hereinafter, this wavelength is also referred to as a cutoff wavelength.

(3) A conditional expression of 0.5%/nm<|ΔT|<7%/nm is satisfied in a wavelength region of 600 nm to 700 nm. Here, definitions are as follows.

|ΔT|: value (%/nm) of |(T_{70%}−T_{30%})/(λ_{70%}−λ_{30%})| at an incidence angle of 0°

T_{70%}: transmittance value of 70%

T_{30%}: transmittance value of 30%

λ_{70%}: wavelength (nm) with transmittance of 70%

λ_{30%}: wavelength (nm) with transmittance of 70%

That is, |ΔT| indicates a slope of a straight line (ratio of a variation in transmittance to a variation in wavelength when a graph indicating the variation in transmittance is the straight line in a wavelength region in which the transmittance is lowered from 70% to 30% at an incidence angle of 0°. Hereinafter, |ΔT| is also referred to as a slope of a transmittance variation line.

(4) When a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,

$${\sum }_{n = 50}^{80} \vert Tn \% λ ( 0 ° ) - Tn \% λ ( 30 ° ) \vert ≦ 350 nm . \qquad [ Expression 1 ]$$

The units of Tn % λ(0°) and Tn % λ(30°) are both nm. In the below description, the left side of Expression 1 may be simply referred to as “total sum of wavelength differences” to simplify the description.

From the characteristics (1) and (2), spectral characteristics in which the transmittance on a shorter wavelength side than the cutoff wavelength is higher and the transmittance on a longer wavelength side than the cutoff wavelength is lower can be realized as the spectral characteristics of the multilayer film 3. Accordingly, it is possible to realize an IR cut filter 1 that mainly transmits light on a shorter wavelength side than the cutoff wavelength and mainly reflects light (including near-infrared light of a wavelength of 700 nm or greater) on a longer wavelength side than the cutoff wavelength.

The conditional expression described in the characteristic of (3) defines an appropriate range of the slope of the transmittance variation line at an incidence angle of 0° in the wavelength region of 600 nm to 700 nm. When |ΔT| is equal to or less than the lower limit of the conditional expression, the slope of the transmittance variation line is excessively small (the transmittance variation line lies down) and thus separation of transmission/reflection with the cutoff wavelength as an interface is not clear. Accordingly, the cut characteristics of near-infrared light get worse and the performance as the IR cut filter is not sufficient. On the contrary, when |ΔT| is equal to or greater than the upper limit of the conditional expression, the slope of the transmittance variation line is great and the characteristics as the IR cut filter are sharpened, but the incidence angle dependency increases. That is, when the incidence angle is changed, for example, from 0° to 30°, the transmittance variation line is shifted to a short wavelength side, and the shift amount at that time increases.

The conditional expression of (4) defines that the total sum of differences (absolute values) between a wavelength (Tn % λ(0°)) with transmittance of n % at the incidence angle of 0° and a wavelength (Tn % λ(30°)) in the wavelength region of 600 nm to 700 nm with transmittance of n % at the incidence angle of 30° is equal to or less than 350 (nm) when the differences in wavelength are calculated for each transmittance of 1% over a section from transmittance of 50% to transmittance of 80%.

FIG. 53 illustrates the spectral characteristics of the multilayer film 3 in the wavelength region of 600 nm to 700 nm at the incidence angle of 0 and the incidence angle of 30°. As illustrated in the drawing, when the spectral characteristics (graph) of the multilayer film 3 is expressed with the wavelength λ (nm) as the horizontal axis and with the transmittance T (%) as the vertical axis, the total sum of the wavelength differences corresponds to the area of the hatched part in the drawing. Accordingly, by setting the total sum of the wavelength differences to be equal to or less than a predetermined, it is possible to suppress the area and to suppress the shift (shift amount) of the transmittance variation line with respect to the variation in incidence angle of 30° within an allowable range.

Accordingly, by satisfying the characteristics of (3) and (4), it is possible to decrease the slope of the transmittance variation line in a range in which the performance as an IR cut filter is satisfied (in a range in which separation of transmission/reflection can be performed) and to limit the shift of the transmittance variation line with respect to the variation in incidence angle of 30° to the allowable range, thereby reducing the incidence angle dependency. Accordingly, it is possible to realize an IR cut filter 1 of low incidence angle dependency which can satisfactorily cope with the low profile of the imaging lens. Therefore, even when the IR cut filter 1 along with the imaging lens is inserted into a camera of a thin portable terminal, it is possible to prevent the central part of a captured image from being reddened to cause unevenness in an in-plane color.

From the viewpoint of further decreasing the incidence angle dependency by further decreasing the shift of the transmittance variation line with respect to the variation in incidence angle of 30°, the multilayer film 3 preferably satisfies Expression 2 and more preferably Expression 3.

$$\begin{matrix}{\sum }_{n = 50}^{80} \vert Tn \% λ ( 0 ° ) - Tn \% λ ( 30 ° ) \vert ≦ 300 nm & [ Expression 2 ] \\ {\sum }_{n = 50}^{80} \vert Tn \% λ ( 0 ° ) - Tn \% λ ( 30 ° ) \vert ≦ 260 nm & [ Expression 3 ]\end{matrix}$$

From the viewpoint of further decreasing the incidence angle dependency by further decreasing the slope of the transmittance variation line after securing the cut characteristic of near-infrared light, it is preferable that the multilayer film 3 satisfy 0.5%/nm<|ΔT|<2.5%/nm and it is more preferable that the multilayer film 3 satisfy 0.5%/nm<|ΔT|<1.5%/nm.

[Optical Design of Multilayer Film]

The optical design of the multilayer film 3 will be described below. In general, a thin film can be designed using an automatic design, and the automatic design can be performed using the characteristics of (1) to (4) as target conditions in optically designing the multilayer film 3.

According to the optical design using the automatic design, it can be seen that when the multilayer film 3 has at least four cutoff adjustment pairs in which the ratio (H/L) of the optical thickness H of the high refractive index layer 4 and the optical thickness of the low refractive index layer 5 which are adjacent to each other is equal to or greater than 3 and satisfies Δn×nH≧1.5, the characteristics of (1), (2), and (4) can be easily realized within a range in which the conditional expression of (3) is satisfied. Here, Δn is a value of nH−nL when a maximum refractive index among the refractive indices of layers constituting the multilayer film 3 is nH and a minimum refractive index is nL. The cutoff adjustment pair is defined as a pair of the high refractive index layer 4 closest to the substrate 2 and the low refractive index layer 5 adjacent thereto (stacked thereon) among the high refractive index layers 4 and the low refractive index layers 5 adjacent to each other. Details of the conditions will be described below.

FIG. 54 illustrates a relationship among ΔT, Δn×nH, and acceptance or rejection of performance. Regarding the acceptance or rejection of performance, an IR cut filter satisfying all the characteristics of (1) to (4) is marked by “” (OK) and an IR cut filter nor satisfying all the characteristics is marked by “x” (NCG). In the results of examples to be described later, “” is surrounded with a solid circle. In the results of comparative examples to be described later, “x” is surrounded with a dotted circle. In FIG. 54, for example, notations of “Ex. 1”, “Ex. 2”, . . . correspond to Example 2-1, Example 2-2, . . . , respectively, and notations of “Com. Ex. 1”, “Com. Ex. 2”, . . . correspond to Comparative Example 2-1, Comparative Example 2-2, . . . , respectively. This is true in FIG. 55.

For the purpose of convenience of explanation, Regions 1 to 5 in FIG. 54 are defined as follows.

Region 1: |ΔT|≧7%/nm and Δn×nH≧1.5

Region 2: |ΔT|≧7%/m and Δn×nH<1.5

Region 3: 0.5%/nm<|ΔT|<7%/nm and Δn×nH<1.5

Region 4: |ΔT|≦0.5%/nm

Region 5: 0.5%/nm<|ΔT|<7%/nm and Δn×nH≧1.5

In Region 5, since |ΔT|<7%/nm is established and the slope of the transmittance variation line can be sufficiently decreased to lie down, it is possible to decrease the incidence angle dependency. The refractive index difference Δn and the refractive index nH of the high refractive index material are sufficiently great. Accordingly, even when the transmittance variation line lies down, the performance of transmission in a transmission area/reflection in a reflection area can be maintained. As a result, except for cases in which the number of cutoff adjustment pairs to be described later is equal to or less than 3 which is small (including Comparative Examples 2-3, 2-9, and 2-11), all the characteristics of (1) to (4) can be satisfied.

In Regions 1 and 2, since |ΔT|≧7%/nm is established and the slope transmittance variation line cannot sufficiently lie down, it is not possible to decrease the incidence angle dependency. In Region 3, since the refractive index difference Δn and the refractive index nH of the high refractive index material are not sufficiently great, it is difficult to maintain the performance of transmission in a transmission area/reflection in a reflection area while causing the transmittance variation line to lie down and the shift of the cutoff wavelength with respect to the variation in incidence angle is likely to increase (the effect of decreasing the incidence angle dependency is small). In Region 4, since the transmittance variation line lies down (the slope is small), the transmission in a transmission area/reflection in a reflection area is not clear and the function as an IR cut filter cannot be satisfactorily exhibited.

FIG. 55 illustrates a relationship among the number of cutoff adjustment pairs in which H/L is equal to or greater than 3, the number of design solutions (frequency) of the IR cut filter, and the acceptance or rejection of performance when the conditions (0.5%/nm<|ΔT|<7%/nm and Δn×nH≧1.5) of Region 5 are satisfied. Regarding the acceptance or rejection of performance, an IR cut filer satisfying all the characteristics of (1) to (4) is indicated by a white bar (OK) and an IR cut filter not satisfying all the characteristics is indicated by a hatched bar (NG). In examples and comparative examples to be described later, a representative solution among the design solutions is selectively described.

Region 7 in FIG. 55 is a region indicating a film configuration including at least four cutoff adjustment pairs in which H/L is equal to or greater than 3. In Region 7, in a state in which the transmittance variation line lies down, it is possible to suppress the shift amount of the transmittance variation line with respect to a variation in incidence angle and satisfy all the characteristics of (1) to (4).

On the other hand, Region 6 is a region indicating a film configuration in which the number of cutoff adjustment pairs in which H/L is equal to or greater than 3 is 3 or less. In Region 6, even when the conditions of Region 5 are satisfied, it cannot be said that all the characteristics of (1) to (4) are satisfied to decrease the incidence angle dependency. For example, in Comparative Examples 2-3, 2-9, and 2-11 to be described later in which the number of cutoff adjustment pairs is 3 or less, the total sum of wavelength differences is greater than 350 nm and the characteristic of (4) is not satisfied.

From the above description, when the multilayer film 3 has a film configuration including at least four cutoff adjustment pairs in which H/L is equal to or greater than 3 and satisfying Δn×nH≧1.5, it can be said to easily or satisfactorily satisfy the characteristics of (1), (2), and (4) on the assumption that the conditional expression of (3) is satisfied. It is preferable that the number of cutoff adjustment pairs in which H/L is equal to or greater than 3 be 6 (six pairs) and it is more preferable that the number of cutoff adjustment pairs be equal to or greater than 13 (thirteen pairs).

In realizing the film configuration including at least four cutoff adjustment pairs in which H/L is equal to or greater than 3, the optical design can be more easily performed (more design solutions are likely to be obtained) by increasing the total number of layers constituting the multilayer film 3. Accordingly, the total thickness of the multilayer film 3 is preferably equal to or greater than 3000 nm and more preferably equal to or greater than 4000 nm.

[Another Configuration of IR Cut Filter]

The IR cut filter 1 according to this embodiment may further include a multilayer film 6 (second multilayer film) in addition to the configuration illustrated in FIG. 1, as illustrated in FIG. 4, similarly to the first embodiment.

The multilayer film 6 is an optical film in which a high refractive index layer 7 having a relatively high refractive index and a low refractive index layer 8 having a relatively low refractive index are alternately stacked and is formed on the opposite surface of the substrate 2 to the surface on which the multilayer film 3 is formed. The layer of the multilayer film 6 closest to the substrate 2 is not set to the high refractive index layer 7, but may be set to the low refractive index layer 8. The film configuration (material, thickness, the number of layers, and the like) of the multilayer film 6 may be equal to the film configuration of the multilayer film 3 or may be different therefrom. When the same low incidence angle dependency as the multilayer film 3 is realized for the multilayer film 6, the multilayer film 6 preferably includes at least four cutoff adjustment pairs in which H/L is equal to or greater than 3.

The multilayer film 6 is designed based on the film configuration of the multilayer film 3, and it is preferable that the multilayer film 6 cut light in an IR region of 700 nm to 1100 nm and have average transmittance of 90% in a wavelength region of 450 nm to 600 nm. In this case, in a state in which both surfaces of the substrate 2 are coated (in a state in which the multilayer film 3 is formed on one surface of the surface 2 and the multilayer film 6 is formed on the opposite surface thereof), average transmittance of 80% or more in a wavelength region of 450 nm to 600 nm and average transmittance of 5% or less in a wavelength region of 720 nm to 1100 nm can be realized. That is, the multilayer film 6 can improve the reflection characteristics of a near-infrared region of 720 nm to 1100 nm without markedly decreasing the transmission characteristics of the wavelength region of 450 nm to 600 nm in a double-side coated state. It is assumed that the substrate 2 is transparent and the influence of the transmittance of the substrate 2 on the spectral characteristics of the IR cut filter 1 as a whole can be almost neglected.

Accordingly, even when the transmittance of the near-infrared region cannot be satisfactorily decreased by only the multilayer film 3, it is possible to satisfactorily cut off light of the near-infrared region using the IR cut filter 1 by forming the multilayer film 6. By forming the multilayer film 6 on the opposite surface of the substrate 2 to the surface on which the multilayer film 3 is formed, distortion due to a stress of the multilayer film 3 can be cancelled by the multilayer film 6.

Preferably, in the state in which both surfaces of the substrate 2 are coated, the multilayer film 6 has spectral characteristics in which the conditional expression of 0.5%/nm<|ΔT|<7%/nm is satisfied and the wavelength with transmittance of 50% at the incidence angle of 0° is in a range of 650±25 nm. In other words, the multilayer film 6 preferably has spectral characteristics of not damaging the characteristics of (2) to (4) of the multilayer film 3. In this case, by forming the multilayer film 6, it is possible to prevent the effect of decreasing the incidence angle dependency due to the multilayer film 3 from being damaged.

As characteristics of only the multilayer film 6, it is preferable that the average transmittance in the wavelength region of 450 nm to 600 nm be equal to or greater than 90% and the wavelength with transmittance of 50% at the incidence angle of 0° be located on a longer wavelength side than the wavelength with transmittance of 50% at the incidence angle of 0° in the multilayer film 3. That is, the cutoff wavelength at the incidence angle of 0° of the multilayer film 6 is preferably located on a longer wavelength side than the cutoff wavelength at the incidence angle of 0° of the multilayer film 3.

In this case, for example, when the spectral characteristics of the multilayer film 6 and the spectral characteristics of the multilayer film 3 at the incidence angle of 0° are superimposed around a wavelength of 700 nm by decreasing the difference between the cutoff wavelength of the multilayer film 6 and the cutoff wavelength of the multilayer film 3, it is possible to further improve the cut characteristic of near-infrared light. On the contrary, when the difference between the cutoff wavelength of the multilayer film 6 and the cutoff wavelength of the multilayer film 3 increases, the cutoff wavelength of the multilayer film 6 can be prevented from passing over the cutoff wavelength of the multilayer film 3 and being shifted to a short wavelength side with a variation in incidence angle. Accordingly, the effect of decreasing the incidence angle dependency due to the multilayer film 3 can be prevented from being damaged by the spectral characteristics of the multilayer film 6.

### EXAMPLES

Specific examples of the IR cut filter according to this embodiment will be described below. Comparative examples will also be described for the purpose of comparison with the examples. The film configuration of a first multilayer film (which corresponds to the multilayer film 3) and a second multilayer film (which corresponds to the multilayer film 6) of an IR cut filter is acquired by the optical design and the spectral characteristics at that time are acquired.

FIG. 56 illustrates characteristics of the first multilayer films according to examples and comparative examples to be described below. In the drawing, T represents the transmittance (%) and is distinguished from ΔT which represents the slope of the transmittance variation line. Tave represents the average transmittance (%), and T=50% λ represents the wavelength (cutoff wavelength of which the unit is nm) with transmittance of 50%. The average transmittance and the cutoff wavelength are values at the incidence angle of 0°. Details of the examples and the comparative examples will be described below. Only representative examples of the IR cut filter of which both surfaces are coated will be described.

### Example 2-1

The film configuration and the spectral characteristics of the first multilayer film, the film configuration and the spectral characteristics of the second multilayer film, and the spectral characteristics of the IR cut filter according to Example 2-1 are the same as in Example 1-1 of the first embodiment.

The first multilayer film is configured to have 13 cutoff adjustment pairs in which H/L is equal to or greater than 3, where Δn×nH=2.26 and ΔT=−1.0%/nm. The spectral characteristics of the first multilayer film satisfy all the following three items of (A) to (C) and performance of low incidence angle dependency is realized.

(A) The average transmittance in a wavelength region of 450 nm to 600 nm is equal to or greater than 90%.

(B) The wavelength with transmittance of 50% at the incidence angle of 0° is in the range of 650±25 nm.

(C) When a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied (that is, the total sum of the wavelength differences is equal to or less than 350 nm),

$${\sum }_{n = 50}^{80} \vert Tn \% λ ( 0 ° ) - Tn \% λ ( 30 ° ) \vert ≦ 350 nm . \qquad [ Expression 1 ]$$

In the second multilayer film, the average transmittance in the wavelength region of 450 nm to 600 nm is 94.41%, the average transmittance in the wavelength region of 720 nm to 1100 nm is 1.09%, and the cutoff wavelength with transmittance of 50% at the incidence angle of 0° is 667 nm.

FIG. 57 illustrates characteristics of the IR cut filter in the double-side coated state. From the drawing, it can be said that the second multilayer film in the double-side coated state has spectral characteristics that:

(a) The average transmittance in the wavelength region of 450 nm to 600 nm is equal to or greater than 80%.

(b) The average transmittance in the wavelength region of 720 nm to 1100 nm is equal to or less than 5%.

(c) The wavelength with transmittance of 50% at the incidence angle of 0° is in the range of 650±25 nm.

(d) 0.5%/nm<|ΔT|<7%/nm is satisfied.

The second multilayer film can be said to have a characteristic that the total sum of the wavelength differences is equal to or less than 350 nm in a double-side coated state.

In Example 2-1, similarly to Example 1-1, only a part of near-infrared light can be cut off by only the first multilayer film, but it is possible to realize an IR cut filter of low incidence angle dependency as a whole which can cut off near-infrared light in a broader wavelength region by forming the second multilayer film on the opposite surface of the substrate.

Particularly, since the cutoff wavelength (667 nm) of the second multilayer film is located on a longer wavelength side than the cutoff wavelength (652 nm) of the first multilayer film, it is possible to improve the cut characteristic of near-infrared light by superimposing the spectral characteristics of the second multilayer film on the spectral characteristics of the first multilayer film around a wavelength of 700 nm.

### Example 2-2

FIG. 58 is a diagram illustrating a film configuration of a first multilayer film of an IR cut filter according to Example 2-2. FIG. 59 is a graph illustrating spectral characteristics of the first multilayer film. The first multilayer film according to Example 2-2 is formed by alternately stacking a high refractive index layer (with a refractive index of 2.4) and a low refractive index layer (with a refractive index of 1.7). For example, TiO₂ can be used as a high refractive index material with a refractive index of 2.4 as in Example 2-1 and, for example, substance M2 (which is a mixture of Al₂O₃ and La₂O₂) made by Merck KGaA can be used as a low refractive index material with a refractive index of 1.7.

The first multilayer film is configured to have 14 cutoff adjustment pairs in which H/L is equal to or greater than 3, where Δn×nH=1.68 and ΔT=−4.2%/nm. The spectral characteristics of the first multilayer film satisfy all the three items of (A) to (C) and performance of low incidence angle dependency is realized.

### Example 2-3

FIG. 60 is a diagram illustrating a film configuration of a first multilayer film of an IR cut filter according to Example 2-3. FIG. 61 is a graph illustrating spectral characteristics of the first multilayer film. The first multilayer film according to Example 2-3 is formed by alternately stacking a high refractive index layer (with a refractive index of 2.4) and a low refractive index layer (with a refractive index of 1.75). For example, TiO₂ can be used as a high refractive index material with a refractive index of 2.4 and, for example, substance M2 (made by Merck KGaA) can be used as a low refractive index material with a refractive index of 1.75. Even when the same low refractive index material as in Example 2-2 is used, a low refractive index layer having a refractive index different from that in Example 2-2 can be formed by changing the film formation conditions (such as a film formation temperature and a degree of vacuum).

The first multilayer film is configured to have 16 cutoff adjustment pairs in which H/L is equal to or greater than 3, where Δn×nH=1.56 and ΔT=−2.8%/nm. The spectral characteristics of the first multilayer film satisfy all the three items of (A) to (C) and performance of low incidence angle dependency is realized.

The film configuration and the spectral characteristics of the second multilayer film formed on the opposite surface of the substrate of the IR cut filter according to Example 2-3 to the surface on which the first multilayer film is formed are the same as in Example 1-3 according to the first embodiment. FIG. 62 is a graph illustrating the spectral characteristics of the second multilayer film. FIG. 19 is a graph illustrating the spectral characteristics of the IR cut filter in the double-side coated state. The same materials as the first multilayer film of Example 2-1 can be used as materials of the high refractive index layer and the low refractive index layer of the second multilayer film. The second multilayer film is configured to have 2 cutoff adjustment pairs in which H/L is equal to or greater than 3.

In the second multilayer film, the average transmittance in the wavelength region of 450 nm to 600 nm is 99.39%, the average transmittance in the wavelength region of 720 nm to 1100 nm is 0.02%, and the cutoff wavelength with transmittance of 50% at the incidence angle of 0° is 684 nm.

FIG. 63 illustrates characteristics of the IR cut filter in the double-side coated state. From the drawing, it can be said that the second multilayer film in the double-side coated state has spectral characteristics satisfying all the four items of (a) to (d). The second multilayer film can be said to have a characteristic that the total sum of the wavelength differences is equal to or less than 350 nm in a double-side coated state.

From FIG. 62, it can be seen that it is possible to realize an IR cut filter of low incidence angle dependency as a whole which can satisfactorily cut off near-infrared light in a broader wavelength region by performing double-side coating.

Particularly, the cutoff wavelength (684 nm) of the second multilayer film is closer to a long wavelength side than the cutoff wavelength (654 nm) of the first multilayer film and the difference is equal to or greater than 30 nm which is great. Accordingly, even when the incidence angle dependency of the second multilayer film is great, the cutoff wavelength of the second multilayer film can be prevented from passing over the cutoff wavelength of the first multilayer film and being shifted to a short wavelength side with a variation in incidence angle. Accordingly, the effect of decreasing the incidence angle dependency due to the first multilayer film can be prevented from being damaged by the spectral characteristics (incidence angle dependency) of the second multilayer film.

In Example 2-3, it can be seen that the transmittance of a wavelength 710 nm at the incidence angle of 0° in the second multilayer film is 0.51% which is equal to or less than 5%. Accordingly, it is possible to satisfactorily secure the reflection characteristic of near-infrared light using the second multilayer film.

In Example 2-3, T_{A}50% λ(30°)=642 nm and T_{B}50% λ(30°)=657 nm can be seen. In this case, T_{A}50% λ(30°)−T_{B}50% λ(30°)=−15 nm which is equal to or less than 8 nm. Accordingly, it is possible to satisfactorily secure the reflection characteristic of near-infrared light using the second multilayer film without greatly damaging the low incidence angle dependency which is achieved by the first multilayer film.

### Example 2-4

The film configuration and the spectral characteristics of the first multilayer film of the IR cut filter according to Example 2-4 are the same as in Example 1-4 of the first embodiment.

The first multilayer film is configured to have 6 cutoff adjustment pairs in which H/L is equal to or greater than 3, where Δn×nH=2.26 and ΔT=−2.1%/nm. The spectral characteristics of the first multilayer film satisfy all the three items of (A) to (C) and performance of low incidence angle dependency is realized.

### Example 2-5

FIG. 64 is a diagram illustrating a film configuration of a first multilayer film of an IR cut filter according to Example 2-5. FIG. 65 is a graph illustrating spectral characteristics of the first multilayer film. The first multilayer film according to Example 2-5 is formed by alternately stacking a high refractive index layer (with a refractive index of 2.4) and a low refractive index layer (with a refractive index of 1.7). For example, the same materials as in Example 2-2 can be used as a high refractive index material with a refractive index of 2.4 and a low refractive index material with a refractive index of 1.7.

The first multilayer film is configured to have 14 cutoff adjustment pairs in which H/L is equal to or greater than 3, where Δn×nH=1.68 and ΔT=−5.7%/nm. The spectral characteristics of the first multilayer film satisfy all the three items of (A) to (C) and performance of low incidence angle dependency is realized.

### Example 2-6

FIG. 66 is a diagram illustrating a film configuration of a first multilayer film of an IR cut filter according to Example 3-6. FIG. 67 is a graph illustrating spectral characteristics of the first multilayer film. The first multilayer film according to Example 2-6 is formed by alternately stacking a high refractive index layer (with a refractive index of 2.4) and a low refractive index layer (with a refractive index of 1.6). For example, the same material as in Example 2-1 can be used as a high refractive index material with a refractive index of 2.4 and, for example, Al₂O₃ can be used as a low refractive index material with a refractive index of 1.6.

The first multilayer film is configured to have 13 cutoff adjustment pairs in which H/L is equal to or greater than 3, where Δn×nH=1.92 and ΔT=−6.3%/nm. The spectral characteristics of the first multilayer film satisfy all the three items of (A) to (C) and performance of low incidence angle dependency is realized.

### Example 2-7

The film configuration and the spectral characteristics of the first multilayer film of the IR cut filter according to Example 2-7 are the same as in Example 1-7 of the first embodiment.

The first multilayer film is configured to have 15 cutoff adjustment pairs in which H/L is equal to or greater than 3, where Δn×nH=2.26 and ΔT=−4.1%/nm. The spectral characteristics of the first multilayer film satisfy all the three items of (A) to (C) and performance of low incidence angle dependency is realized.

### Example 2-8

The film configuration and the spectral characteristics of the first multilayer film of the IR cut filter according to Example 2-8 are the same as in Example 1-8 of the first embodiment.

The first multilayer film is configured to have 15 cutoff adjustment pairs in which H/L is equal to or greater than 3, where Δn×nH=2.26 and ΔT=−1.0%/nm. The spectral characteristics of the first multilayer film satisfy all the three items of (A) to (C) and performance of low incidence angle dependency is realized.

### Example 2-9

The film configuration and the spectral characteristics of the first multilayer film of the IR cut filter according to Example 2-9 are the same as in Example 1-9 of the first embodiment.

The first multilayer film is configured to have 4 cutoff adjustment pairs in which H/L is equal to or greater than 3, where Δn×nH=2.26 and ΔT=−2.0%/nm. The spectral characteristics of the first multilayer film satisfy all the three items of (A) to (C) and performance of low incidence angle dependency is realized.

### Example 2-10

FIG. 68 is a diagram illustrating a film configuration of a first multilayer film of an IR cut filter according to Example 2-10. FIG. 69 is a graph illustrating spectral characteristics of the first multilayer film. The first multilayer film according to Example 2-10 is formed by alternately stacking a high refractive index layer (with a refractive index of 2.4) and a low refractive index layer (with a refractive index of 1.46). TiO₂ and SiO₂ can be used as a high refractive index material with a refractive index of 2.4 and a low refractive index material with a refractive index of 1.46, similarly to Example 2-1.

The first multilayer film is configured to have 4 cutoff adjustment pairs in which H/L is equal to or greater than 3, where Δn×nH=2.26 and ΔT=−1.8%/nm. The spectral characteristics of the first multilayer film satisfy all the three items of (A) to (C) and performance of low incidence angle dependency is realized.

### Comparative Example 2-1

The film configuration and the spectral characteristics of the first multilayer film of the IR cut filter according to Comparative Example 2-1 are the same as in Comparative Example 1-1 of the first embodiment.

The first multilayer film is configured to have 18 cutoff adjustment pairs in which H/L is equal to or greater than 3, where Δn×nH=2.26 and ΔT=−7.3%/nm which does not satisfy |ΔT|<7%/nm and the total sum of the wavelength differences is 365 nm which is greater than 350 nm. As a result, it cannot be said in Comparative Example 2-1 that the low incidence angle dependency is realized.

### Comparative Example 2-2

The film configuration and the spectral characteristics of the first multilayer film of the IR cut filter according to Comparative Example 2-2 are the same as in Comparative Example 1-2 of the first embodiment.

The first multilayer film is configured to have 16 cutoff adjustment pairs in which H/L is equal to or greater than 3, where Δn×nH=1.38 which does not satisfy Δn×nH≧1.5 and ΔT=−7.5%/nm which does not satisfy |ΔT|<7%/nm. The total sum of the wavelength differences is 531 nm which is much greater than 350 nm. As a result, it cannot be said in Comparative Example 2-2 that the low incidence angle dependency is realized.

### Comparative Example 2-3

The film configuration and the spectral characteristics of the first multilayer film of the IR cut filter according to Comparative Example 2-3 are the same as in Comparative Example 1-3 of the first embodiment.

In the first multilayer film, Δn×nH=2.26 which satisfies Δn×nH≧1.5. ΔT=−1.0%/nm which satisfies 0.5%/nm<|ΔT|<7%/nm. However, there is no cutoff adjustment pair in which H/L is equal to or greater than 3, and the total sum of the wavelength differences is 713 nm which is much greater than 350 nm. As a result, it cannot be said in Comparative Example 2-3 that the low incidence angle dependency is realized.

### Comparative Example 2-4

The film configuration and the spectral characteristics of the first multilayer film of the IR cut filter according to Comparative Example 2-4 are the same as in Comparative Example 1-4 of the first embodiment.

In the first multilayer film, Δn×nH=2.26 which satisfies Δn×nH≧1.5. However, there is no cutoff adjustment pair in which H/L is equal to or greater than 3, and ΔT=−13%/nm which satisfies |ΔT|<7%/nm. The total sum of the wavelength differences is 903 nm which is much greater than 350 nm. As a result, it cannot be said in Comparative Example 2-4 that the low incidence angle dependency is realized.

### Comparative Example 2-5

The film configuration and the spectral characteristics of the first multilayer film of the IR cut filter according to Comparative Example 2-5 are the same as in Comparative Example 1-5 of the first embodiment.

The first multilayer film is configured to have 18 cutoff adjustment pairs in which H/L is equal to or greater than 3, where ΔT=−2.3%/nm which satisfies 0.5%/n<|ΔT|<7%/nm. However, Δn×nH=1.44 which does not satisfy Δn×nH≧1.5 and the total sum of the wavelength differences is 432 nm which is much greater than 350 nm. As a result, it cannot be said in Comparative Example 2-5 that the low incidence angle dependency is realized.

### Comparative Example 2-6

The film configuration and the spectral characteristics of the first multilayer film of the IR cut filter according to Comparative Example 2-6 are the same as in Comparative Example 1-6 of the first embodiment.

The first multilayer film is configured to have 16 cutoff adjustment pairs in which H/L is equal to or greater than 3, where Δn×nH=1.68 which satisfies Δn×nH≧1.5. However, ΔT=−7.6%/nm which does not satisfy |ΔT|<7%/nm and the total sum of the wavelength differences is 490 nm which is much greater than 350 nm. As a result, it cannot be said in Comparative Example 2-6 that the low incidence angle dependency is realized.

### Comparative Example 2-7

The film configuration and the spectral characteristics of the first multilayer film of the IR cut filter according to Comparative Example 2-7 are the same as in Comparative Example 1-7 of the first embodiment.

The first multilayer film is configured to have 15 cutoff adjustment pairs in which H/L is equal to or greater than 3, where ΔT=−6.4%/nm which satisfies 0.5%/n<|ΔT|<7%/nm. However, Δn×nH=1.44 which does not satisfy Δn×nH≧1.5 and the total sum of the wavelength differences is 476 nm which is much greater than 350 nm. As a result, it cannot be said in Comparative Example 2-7 that the low incidence angle dependency is realized.

### Comparative Example 2-8

The film configuration and the spectral characteristics of the first multilayer film of the IR cut filter according to Comparative Example 2-8 are the same as in Comparative Example 1-8 of the first embodiment.

The first multilayer film is configured to have 14 cutoff adjustment pairs in which H/L is equal to or greater than 3, where ΔT=−4.3%/nm which satisfies 0.5%/n<|ΔT|<7%/nm. However, Δn×nH=1.44 which does not satisfy Δn×nH≧1.5 and the total sum of the wavelength differences is 447 nm which is much greater than 350 nm. As a result, it cannot be said in Comparative Example 2-8 that the low incidence angle dependency is realized.

### Comparative Example 2-9

The film configuration and the spectral characteristics of the first multilayer film of the IR cut filter according to Comparative Example 2-9 are the same as in Comparative Example 1-9 of the first embodiment.

In the first multilayer film, Δn×nH=2.26 which satisfies Δn×nH≧1.5. ΔT=−1.1%/nm which satisfies 0.5%/nm<|ΔT|<7%/nm. However, there is no cutoff adjustment pair in which H/L is equal to or greater than 3, and the total sum of the wavelength differences is 723 nm which is much greater than 350 nm. As a result, it cannot be said in Comparative Example 2-9 that the low incidence angle dependency is realized.

### Comparative Example 2-10

The film configuration and the spectral characteristics of the first multilayer film of the IR cut filter according to Comparative Example 2-10 are the same as in Comparative Example 1-10 of the first embodiment.

In the first multilayer film, ΔT=−5.8%/nm which satisfies 0.5%/nm<|ΔT|<<7%/nm. However, there is no cutoff adjustment pair in which H/L is equal to or greater than 3, and Δn×nH=0.78 which does not satisfy Δn×nH≧1.5. The total sum of the wavelength differences is 606 nm which is much greater than 350 nm. As a result, it cannot be said in Comparative Example 2-10 that the low incidence angle dependency is realized.

### Comparative Example 2-11

FIG. 70 is a diagram illustrating a film configuration of a first multilayer film of an IR cut filter according to Comparative Example 2-11. FIG. 71 is a graph illustrating spectral characteristics of the first multilayer film. The first multilayer film according to Comparative Example 2-11 is formed by alternately stacking a high refractive index layer (with a refractive index of 2.4) and a low refractive index layer (with a refractive index of 1.46). TiO₂ and SiO₂ can be used as a high refractive index material with a refractive index of 2.4 and a low refractive index material with a refractive index of 1.46, similarly to Example 2-1.

In the first multilayer film, Δn×nH=2.26 which satisfies Δn×nH≧1.5. ΔT=−1.7%/nm which satisfies 0.5%/nm<|ΔT|<7%/nm. However, the number of cutoff adjustment pairs in which H/L is equal to or greater than 3 is 3 which is small, and the total sum of the wavelength differences is 528 nm which is much greater than 350 nm. As a result, it cannot be said in Comparative Example 2-11 that the low incidence angle dependency is realized.

As a result, the IR cut filter according to the second embodiment may have the following configurations.

That is, the IR cut filter is an IR cut filter including a substrate and a multilayer film formed on the substrate,

the multilayer film includes a high refractive index layer and a low refractive index layer which are alternately stacked,

the average transmittance in a wavelength region of 450 nm to 600 nm in the multilayer film is equal to or greater than 90%,

the wavelength with transmittance of 50% at an incidence angle of 0° is in a range of 650±25 nm,

0.5%/nm<|ΔT|<7%/nm is satisfied in the wavelength region of 600 nm to 700 nm,

|ΔT|: value (%/nm) of |(T_{70%}−T_{30%})/(λ_{70%}−λ_{30%}) at the incidence angle of 0°

T_{70%}: transmittance value of 70%

T_{30%}: transmittance value of 30%

λ_{70%}: wavelength (nm) with transmittance of 70%

λ_{30%}: wavelength (nm) with transmittance of 30%, and

when a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,

$${\sum }_{n = 50}^{80} \vert Tn \% λ ( 0 ° ) - Tn \% λ ( 30 ° ) \vert ≦ 350 nm . \qquad [ Expression 1 ]$$

According to this configuration, it is possible to suppress a variation in spectral characteristics with respect to a great variation in incidence angle (for example, a variation of 30°) and thus to realize an IR cut filter of low incidence angle dependency which can satisfactorily cope with the low profile of the imaging lens.

It is preferable that the multilayer film include at least four cutoff adjustment pairs in which an optical thickness ratio between the high refractive index layer and the low refractive index layer adjacent to each other is equal to or greater than 3, and that when a difference between a maximum refractive index and a minimum refractive index among the refractive indices of layers constituting the multilayer film is Δn and the maximum refractive index is nH, Δn×nH≧1.5 be satisfied.

The total thickness of the multilayer film may be equal to or greater than 3000 nm.

It is preferable that when the multilayer film is a first multilayer film, a second multilayer film be formed on the opposite surface of the substrate to the surface on which the first multilayer film is formed, and that the second multilayer film have a spectral characteristics in which average transmittance in the wavelength region of 450 nm to 600 nm is equal to or greater than 80% and average transmittance in a wavelength region of 720 nm to 1100 nm is equal to or less than 5% in a state in which the first multilayer film is formed on one surface of the substrate and the second multilayer film is formed on the opposite surface of the substrate.

It is preferable that the second multilayer film have a spectral characteristic that in the state in which the first multilayer film is formed on one surface of the substrate and the second multilayer film is formed on the opposite surface of the substrate,

0.5%/nm<|ΔT|<7%/nm be satisfied in the wavelength region of 600 nm to 700 nm, and

the wavelength with transmittance of 50% at the incidence angle of 0° be in a range of 650±25 nm.

In the second multilayer film, it is preferable that the average transmittance in the wavelength region of 450 nm to 600 nm be equal to or greater than 90%, and

the wavelength with transmittance of 50% at the incidence angle of 0° be located on a longer wavelength side than the wavelength with transmittance of 50% at the incidence angle of 0° in the first multilayer film.

On the other hand, the IR cut filter may further include an absorption film having an absorption peak in the wavelength region of 600 nm to 700 nm, which will be described in a fourth embodiment to be described later.

An image capturing device according to the second embodiment includes the above-mentioned IR cut filter, an imaging lens that is disposed on a light incidence side of the IR cut filter, and an imaging element that receives light which is incident through the imaging lens and the IR cut filter.

### Third Embodiment

A third embodiment of the present invention will be described below with reference to the accompanying drawings as follows. An IR cut filter 1 according to this embodiment is the same as the configuration of the first embodiment illustrated in FIG. 4, in that the IR cut filter includes a multilayer film 3 (first multilayer film) on one surface of a transparent substrate 2 and a multilayer film 6 (second multilayer film) on the opposite surface of the substrate 2.

In the IR cut filter 1 according to this embodiment in a state in which the multilayer film 3 is formed on one surface (Surface A) of the substrate 2 and the multilayer film 6 is formed on the opposite surface (Surface B), a wavelength with transmittance of 50% at an incidence angle of 0° is in a range of 650±25 nm. Hereinafter, this wavelength is also referred to as a cutoff wavelength. By setting the cutoff wavelength in this way, it is possible to realize an IR cut filter 1 that mainly transmits light (for example, visible light) on a shorter wavelength side than the cutoff wavelength and mainly reflects light (for example, near-infrared light) on a longer wavelength side than the cutoff wavelength.

The multilayer film 3 of the IR cut filter 1 has the following characteristics.

(1) The wavelength with transmittance of 50% at the incidence angle of 0° is in a range of 650±25 nm.

(2) A conditional expression of 0.5%/nm<|ΔT|<7%/nm is satisfied in a wavelength region of 600 nm to 700 nm. Here, definitions are as follows.

|ΔT|: value (%/nm) of |(T_{70%}−T_{30%})/(λ_{70%}−λ_{30%}) at an incidence angle of 0°

T_{70%}: transmittance value of 70%

T_{30%}: transmittance value of 30%

λ_{70%}: wavelength (nm) with transmittance of 70%

λ_{30%}: wavelength (nm) with transmittance of 70%

That is, |ΔT| indicates a slope of a straight line (ratio of a variation in transmittance to a variation in wavelength when a graph indicating the variation in transmittance is the straight line in a wavelength region in which the transmittance is lowered from 70% to 30% at an incidence angle of 0°. Hereinafter, |ΔT| is also referred to as a slope of a transmittance variation line.

(3) When a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,

$${\sum }_{n = 50}^{80} \vert Tn \% λ ( 0 ° ) - Tn \% λ ( 30 ° ) \vert ≦ 350 nm . \qquad [ Expression 1 ]$$

The units of Tn % λ(0°) and Tn % λ(30°) are both nm. In the below description, the left side of Expression 1 may be simply referred to as “total sum of wavelength differences” to simplify the description.

From the characteristic of (1), spectral characteristics in which the transmittance on a shorter wavelength side than the cutoff wavelength is higher and the transmittance on a longer wavelength side than the cutoff wavelength is lower can be realized as the spectral characteristics of only the multilayer film 3. Accordingly, it is possible to realize the spectral characteristics in which the IR cut filter 1 mainly transmits light (for example, visible light) on a shorter wavelength side than the cutoff wavelength and mainly reflects light (for example, near-infrared light) on a longer wavelength side than the cutoff wavelength as a whole. In realizing the spectral characteristics of the IR cut filter, it is preferable that the average transmittance in the wavelength region of 450 nm to 600 nm in the multilayer film 3 be equal to or greater than 90%.

The conditional expression described in the characteristic of (2) defines an appropriate range of the slope of the transmittance variation line at an incidence angle of 0°. When |ΔT| is equal to or less than the lower limit of the conditional expression, the slope of the transmittance variation line is excessively small (the transmittance variation line lies down) and thus separation of transmission/reflection with the cutoff wavelength as an interface is not clear. Accordingly, the cut characteristics of near-infrared light get worse and the performance as the IR cut filter is not sufficient. On the contrary, when |ΔT| is equal to or greater than the upper limit of the conditional expression, the slope of the transmittance variation line is great and the characteristics as the IR cut filter are sharpened, but the incidence angle dependency increases. That is, when the incidence angle is changed, for example, from 0° to 30°, the transmittance variation line is shifted to a short wavelength side, and the shift amount at that time increases.

The conditional expression of (3) defines that the total sum of differences (absolute values) between a wavelength (Tn % λ(0°)) with transmittance of n % at the incidence angle of 0° and a wavelength (Tn % λ(30°)) with transmittance of n % at the incidence angle of 30° is equal to or less than 350 (nm) when the differences in wavelength are calculated for each transmittance of 1% over a section from transmittance of 50% to transmittance of 80%, and is the same as the conditional expression (4) described in the second embodiment.

As illustrated in FIG. 53 according to the second embodiment, when the spectral characteristics (graph) of the multilayer film 3 is expressed with the wavelength λ (nm) as the horizontal axis and with the transmittance T (%) as the vertical axis, the total sum of the wavelength differences corresponds to the area of the hatched part in the drawing. Accordingly, by setting the total sum of the wavelength differences to be equal to or less than a predetermined, it is possible to suppress the area and to suppress the shift (shift amount) of the transmittance variation line with respect to the variation in incidence angle of 30° within an allowable range.

Accordingly, by satisfying the characteristics of (2) and (3), it is possible to decrease the slope of the transmittance variation line in a range in which the performance as an IR cut filter is satisfied (in a range in which separation of transmission/reflection can be performed) and to limit the shift of the transmittance variation line with respect to the variation in incidence angle of 30° to the allowable range, thereby reducing the incidence angle dependency. Accordingly, it is possible to realize an IR cut filter 1 of low incidence angle dependency which can satisfactorily cope with the low profile of the imaging lens. Therefore, even when the IR cut filter 1 along with the imaging lens is inserted into a camera of a thin portable terminal, it is possible to prevent the central part of a captured image from being reddened to cause unevenness in an in-plane color.

From the viewpoint of further decreasing the incidence angle dependency by further decreasing the shift of the transmittance variation line with respect to the variation in incidence angle of 30°, the multilayer film 3 preferably satisfies Expression 2 and more preferably Expression 3.

$$\begin{matrix}{\sum }_{n = 50}^{80} \vert Tn \% λ ( 0 ° ) - Tn \% λ ( 30 ° ) \vert ≦ 300 nm & [ Expression 2 ] \\ {\sum }_{n = 50}^{80} \vert Tn \% λ ( 0 ° ) - Tn \% λ ( 30 ° ) \vert ≦ 260 nm & [ Expression 3 ]\end{matrix}$$

Details of the multilayer film 6 will be described below. The multilayer film 6 is an optical film in which a high refractive index layer 7 having a relatively high refractive index and a low refractive index layer 8 having a relatively low refractive index are alternately stacked and is formed on Surface B of the substrate 2 opposite to Surface A on which the multilayer film 3 is formed. In FIG. 4, a layer of the multilayer film 6 closest to the substrate 2 is the high refractive index layer 7, but the layer may be the low refractive index layer 8.

The multilayer film 6 preferably has the following characteristics.

(a) The transmittance of a wavelength of 710 nm at the incidence angle of 0° is equal to or less than 5%.

(b) T_{A}50% λ(30°)−T_{B}50% λ(30°)≦8 nm is satisfied,

where Tₕ50% λ(30°): a wavelength (nm) with transmittance of 50% in the wavelength region of 600 nm to 700 nm at the incidence angle of 30° in the multilayer film 3

T_{B}50% λ(30°): a wavelength (nm) with transmittance of 50% in the wavelength region of 600 nm to 700 nm at the incidence angle of 30° in the multilayer film 6.

From the characteristic of (a), the reflection characteristics of near-infrared light which is on a longer wavelength side than the cutoff wavelength and which is in the vicinity of a wavelength region of 700 nm to 710 nm can be satisfactorily secured. Accordingly, even when the transmittance of the near-infrared region cannot be satisfactorily decreased by only the multilayer film 3, it is possible to satisfactorily cut off light of the near-infrared region using the IR cut filter 1 by forming the multilayer film 6. By forming the multilayer film 6 on Surface B of the substrate 2 opposite to Surface A on which the multilayer film 3 is formed, distortion due to a stress of the multilayer film 3 can be cancelled by the multilayer film 6.

The characteristic of (b) defines an appropriate range of a difference (hereinafter, also referred to as a 30° cutoff wavelength difference) between the cutoff wavelength at the incidence angle of 30° of the multilayer film 3 and the cutoff wavelength at the incidence angle of 30° of the multilayer film 6. FIG. 72 schematically illustrates the spectral characteristics of the multilayer film 3 and the multilayer film 6 at the incidence angle of 30° on in the wavelength region of 600 nm to 700 nm. In a configuration in which the cutoff wavelength of the IR cut filter 1 as a whole is in the range of 650±25 nm and the cutoff wavelength of only the multilayer film 3 is in the range of multilayer film 3, when the multilayer film 3 on Surface A has the low incidence angle dependency as described above and the multilayer film 6 on Surface B has the characteristic of (a) (the transmittance of the wavelength of 710 nm is equal to or less than 5%), the slope of the transmittance variation line in the wavelength region of 600 nm to 700 nm is greater in the multilayer film 6 on Surface B than in the multilayer film 3 on Surface A. In this case, when the 30° cutoff wavelength difference is greater than 8 nm (when the cutoff wavelength of the multilayer film 6 at the incidence angle of 30° is located on an excessively shorter wavelength side than the cutoff wavelength of the multilayer film 3 at the incidence angle of 30°), the angle dependency which is suppressed by the spectral characteristics of the multilayer film 3 on Surface A is collapsed by the spectral characteristics of the multilayer film 6 on Surface B and thus the low incidence angle dependency is greatly damaged.

Accordingly, by satisfying the conditional expression of (b), it is possible to satisfactorily secure the reflection characteristic of near-infrared light using the multilayer film 6 on Surface B without greatly damaging the low incidence angle dependency which is achieved by the multilayer film 3 on Surface A.

In order to satisfactorily secure the reflection characteristic of near-infrared light around the wavelength 700 nm while satisfactorily suppressing damage of the low incidence angle dependency which is achieved by the multilayer film 3 on Surface A, the multilayer film 6 preferably has characteristics that the transmittance of the wavelength of 700 nm at the incidence angle of 0° is equal to or less than 2% and T_{A}50% λ(30°)−T_{B}50% λ(30°)≦2 nm is satisfied.

### Examples

Specific examples of the IR cut filter according to this embodiment will be described below. Comparative examples will also be described for the purpose of comparison with the examples. The film configuration of a multilayer film on Surface A and a multilayer film on Surface B of an IR cut filter are acquired by the optical design and the characteristics of the multilayer films and the IR cut filter are acquired. In general, a thin film can be designed using an automatic design, and the automatic design can be performed using the above-mentioned characteristics as target conditions in optically designing the multilayer films.

FIGS. 73 and 74 illustrate characteristics and transmission performance of an IR cut filter as a whole, a multilayer film on Surface A, and a multilayer film on Surface B in ten types of IR cut filters (Numbers 1 to 10) which are produced based on the above-mentioned film designs. In the drawings, T_{A}50% λ(0°) and T_{A}50% λ(30°) are characteristics of the IR cut filter as a whole (characteristics in a state in which the first multilayer film and the second multilayer film are formed on both surfaces of the substrate) and represent wavelengths (nm) with transmittance of 50% in a wavelength region of 600 nm to 700 nm at an incidence angle of 0° and an incidence angle of 30°, respectively. T(700 nm) (0°) and T(710 nm) (0°) are characteristics of the IR cut filter as a whole and represent transmittance values (%) of a wavelength 700 nm and a wavelength 710 nm at the incidence angle of 0°.

When the above-mentioned value for only the multilayer film on Surface A or only the multilayer film on Surface B is expressed instead of the IR cut filter as a whole, T_{A}50% λ(0°) or T_{B}50% λ(0°) is described by adding a subscript of A or B to T. ΔT represents the slope of a transmittance variation line in the wavelength region of 600 nm to 700 nm, and Σ represents the total sum (nm) when a difference between a wavelength with transmittance of n % at the incidence angle of 0° and a wavelength with transmittance of n % at the incidence angle of 30° is calculated for each transmittance of 1% over a section from transmittance of 50% to transmittance of 80%.

In the IR cut filters of Numbers 1 to 4, the multilayer films on Surfaces B have the same film configuration and the multilayer films on Surfaces A have different film configurations. Accordingly, the values of T_{B}50% λ(0°), T_{B}50% λ(30°), T_{B}(700 nm) (0°), and T_{B}(710 nm) (0°) in the multilayer films on Surfaces B are the same as illustrated in FIG. 74, and the values of T_{A}50% λ(0°), T_{A}5% λ(30°), T_{A}(700 nm) (0°), and T_{A}(710 nm) (0°) in the multilayer films on Surfaces A are different as illustrated in FIG. 73.

In the IR cut filters of Numbers 5 to 10, the multilayer films on Surfaces B have different film configurations and the multilayer films on Surfaces A have the film configuration. Accordingly, at least one of the values of T_{B}50% λ(0°), T_{B}50% λ(30°), T_{B}(700 nm) (0°), and T_{B}(710 nm) (0°) in the multilayer films on Surfaces B is different as illustrated in FIG. 74, and the values of T_{A}50% λ(0°), T_{A}50% λ(30°), T_{A}(700 nm) (0°), and T_{A}(710 nm) (0°) in the multilayer films on Surfaces A are the same as illustrated in FIG. 73.

As can be seen from FIG. 73, in the multilayer films on Surfaces A of all the IR cut filters of Numbers 1 to 10, T_{A}50% λ(0°) is in a range of 650±25 nm, 0.5%/nm<|ΔT|<7%/nm is satisfied, the value of 2 is equal to or less than 350 nm. Therefore, in all the ten types of IR cut filters, the low incidence angle dependency is realized by the multilayer film on Surface A.

The correspondence among the ten types of IR cut filters, examples, and comparative examples is illustrated in FIGS. 73 and 74. The configurations of multilayer films on Surfaces A and the multilayer films on Surfaces B, the spectral characteristics of the multilayer films, and the spectral characteristics of the IR cut filters as a whole in the examples and the comparative examples are illustrated in FIGS. 75 to 114. The multilayer films on Surfaces A and the multilayer films on Surfaces B in the examples and the comparative examples are formed by alternately stacking a high refractive index layer (with a refractive index of 2.4) and a low refractive index layer (with a refractive index of 1.46). For example, TiO₂ can be used as a high refractive index material with a refractive index of 2.4 and, for example, SiO₂ can be used as a low refractive index material with a refractive index of 1.46.

Evaluation results of in-plane color unevenness and IR cut performance as transmission performance of the IR cut filters according to the examples and the comparative examples are illustrated together in FIG. 74.

Regarding the in-plane color unevenness, light from a light source (for example, a D50 light source) is received by an imaging element through the IR cut filter, it is determined with eyes whether the central part of the captured image is reddened relative to the peripheral part to cause color unevenness, and the color unevenness is evaluated based on the following criteria.

◯: Color unevenness is hardly observed and there is no problem in performance.

Δ: Color unevenness is observed but is in an allowable range.

x: Color unevenness is surely observed and there is a problem in performance.

The IR cut performance is evaluated based on the following criteria with reference to transmittance (T(710 nm) (0°)) of the wavelength 710 nm in the IR cut filter as a whole.

◯: The transmittance of the wavelength of 710 nm is equal to or less than 1%.

Δ: The transmittance of the wavelength of 710 nm is equal to or less than 5%.

x: The transmittance of the wavelength of 710 nm is greater than 5%.

In the IR cut filters according to Examples 3-1 to 3-7, good results of ◯ or Δ are obtained by the evaluation of the in-plane color unevenness. This is because since the values of T_{A}50% λ(30°)−T_{A}50% λ(30°) in Examples 3-1 to 3-7 are 5 nm or less which is small, the spectral characteristics of the multilayer film on Surface B at the incidence angle of 30° do not excessively affect the spectral characteristics of the multilayer film on Surface A and the low incidence angle dependency achieved by the multilayer film on Surface A is not greatly collapsed by the multilayer film on Surface B.

In Examples 3-1 to 3-7, goo results of ◯ or Δ are obtained by the evaluation of the IR cut characteristic. This is because since the value of T_{B}(710 nm) (0°) is 2.4% or less in Examples 3-1 to 3-7, the value of T(710 nm) (0°) of the IR cut filter as a whole is 2% or less and the reflection characteristics of the near-infrared light is sufficiently secured by formation of the multilayer film on Surface B.

On the contrary, in Comparative Example 3-1, since the value of T_{B}(710 nm) (0°) is 81.5% and the T(710 nm) (0°) of the IR cut filter as a whole is 8.8% which is great, it cannot be said that the IR cut performance is good. In Comparative Examples 3-2 and 3-3, it is considered that since the value of T_{A}50% λ(30°)−T_{B}50% λ(30°) is 10 nm or greater and T_{B}50% λ(30°) is located on a wavelength side much shorter than T_{A}50% λ(30°), the low incidence angle dependency achieved by the multilayer film on Surface A is greatly damaged by the multilayer film on Surface B and thus the in-plane color unevenness occurs.

From the evaluation results of the in-plane color unevenness, when the value of T_{A}50% λ(30°)−T_{B}50% λ(30°) is equal to or less than 8 nm which is located between 5 nm in Examples 3-5 and 3-7 with an evaluation result of Δ and 12 nm in Comparative Example 3-3 with an evaluation result of x, it is considered to suppress the in-plane color unevenness. When the value is equal to or less than 2 nm which is located between 5 nm in Examples 3-5 and 3-7 with an evaluation result of Δ and −2 nm in Example 3-3 with an evaluation result of ◯, it is considered to further suppress the in-plane color unevenness, and when the value is equal to or less than 0 nm, it is considered to further enhance the effect.

Therefore, from the viewpoint of suppressing the in-plane color unevenness, the appropriate range of the value of T_{A}50% λ(30°)−T_{B}50% λ(30°) is equal to or less than 8 nm, preferably equal to or less than 5 nm, more preferably equal to or less than 2 nm, and still more preferably equal to or less than 0 nm.

In Example 3-6, the value of T_{B}(710 nm) (0°) is 2.4% and the evaluation result of the IR cut characteristic is Δ. In Comparative Example 3-1, the value of T_{B}(710 nm) (0°) is 81.5% and the evaluation result of the IR cut characteristic is x. In order to satisfactorily secure the reflection characteristic of near-infrared light, it is considered that the value of T_{B}(710 nm) (0°) is preferably close to 2.4% as much as possible between 2.4% and 81.5%. Accordingly, the appropriate range of the value of T_{B}(710 nm) (0°) is equal to or less than 5%, preferably equal to or less than 3%, more preferably equal to or less than 2.4%, and still more preferably equal to or less than 1%.

In Example 3-6, the value of T_{B}(700 nm) (0°) is 37.5% and the evaluation result of the IR cut characteristic is Δ. In Comparative Example 3-2, the value of T_{B}(700 nm) (0°) is 5.0% and the evaluation result of the IR cut characteristic is ◯. In order to satisfactorily secure the reflection characteristic of near-infrared light around a wavelength of 700 nm, it is considered that the value of T_{B}(700 nm) (0°) is preferably close to 5.0% as much as possible between 5.0% and 37.5%. Accordingly, the appropriate range of the value of T_{B}(700 nm) (0°) is equal to or less than 10% and preferably equal to or less than 5%. From the results of Examples 3-1, 3-3, and 3-7, the appropriate range of the value of T_{B}(700 nm) (0°) is equal to or less than 2.0% and preferably equal to or less than 1.0%.

Accordingly, the IR cut filter according to the third embodiment may have the following configuration.

That is, the IR cut filter is an IR cut filter that transmits visible light and reflects near-infrared light, including a substrate, a first multilayer film formed on one surface of the substrate, and a second multilayer film formed on the opposite surface of the substrate,

in a state in which the first multilayer film and the second multilayer film are formed on both surfaces of the substrate, respectively, the wavelength with transmittance of 50% at an incidence angle of 0° is in a range of 650±25 nm,

in the first multilayer film,

the wavelength with transmittance of 50% at an incidence angle of 09 is in a range of 650±25 nm,

0.5%/nm<|ΔT|<7%/nm is satisfied in a wavelength region of 600 nm to 700 nm,

|ΔT|: value (%/nm) of |(T_{70%}−T_{30%})/(λ_{70%}−λ_{30%}) at the incidence angle of 0°

T_{70%}: transmittance value of 70%

T_{30%}: transmittance value of 30%

λ_{70%}: wavelength (nm) with transmittance of 70%

λ_{30%}: wavelength (nm) with transmittance of 30%, and

when the wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,

$${\sum }_{n = 50}^{80} \vert Tn \% λ ( 0 ° ) - Tn \% λ ( 30 ° ) \vert ≦ 350 nm . \qquad [ Expression 1 ]$$

and

in the second multilayer film,

the transmittance of a wavelength of 710 nm at the incidence angle of 0° is equal to or less than 5%, and

T_{A}50% λ(30°)−T_{B}50% λ(30°)≦8 nm is satisfied,

T_{A}50% λ(30°): wavelength (nm) with transmittance of 50% in the wavelength region of 600 nm to 700 nm at the incidence angle of 30° in the first multilayer film

T_{B}50% λ(30°): wavelength (nm) with transmittance of 50% in the wavelength region of 600 nm to 700 nm at the incidence angle of 30° in the second multilayer film.

According to this configuration, it is possible to realize the low incidence angle dependency using the first multilayer film formed on one surface of the substrate and to satisfactorily secure reflection characteristics of near-infrared light without greatly damaging the low incidence angle dependency using the second multilayer film formed on the opposite surface of the substrate.

In the second multilayer film, it is preferable that the in the second multilayer film, the transmittance of a wavelength of 700 nm at the incidence angle of 0° be equal to or less than 2% and T_{A}50% λ(30°)−T_{B}50% λ(30°)≦2 nm be satisfied.

The IR cut filter may further include an absorption film having an absorption peak in the wavelength region of 600 nm to 700 nm, which will be described in a fourth embodiment to be described later.

An image capturing device according to the third embodiment includes the above-mentioned IR cut filter, an imaging lens that is disposed on a light incidence side of the IR cut filter, and an imaging element that receives light which is incident through the imaging lens and the IR cut filter.

### Fourth Embodiment

A fourth embodiment of the present invention will be described below with reference to the accompanying drawings.

FIG. 115 is a cross-sectional view schematically illustrating a configuration of an IR cut filter 1 according to an embodiment of the present invention. In the IR cut filter 1 according to this embodiment, an absorption film 9 (a resin layer including an absorbent material) having an absorption peak in a wavelength region of 600 nm to 700 nm is formed on at least one of the multilayer film 3 and the multilayer film 6 in the configurations of the first to third embodiments in which the multilayer film 3 (first multilayer film) is formed on one surface of the transparent substrate 2 and the multilayer film 6 (second multilayer film) is formed on the opposite surface of the substrate 2. In the drawing, the absorption film 9 is formed on only the multilayer film 3, but may be formed on only the multilayer film 6 or may be formed on both the multilayer film 3 and the multilayer film 6. When the absorption film 9 is formed on only one multilayer film, the absorption film 9 is preferably formed on a light incidence side of the multilayer film. An antireflective film is preferably formed on the absorption film 9.

In this embodiment, characteristics of the films (the multilayer film 3 and the multilayer film 6) other than the absorption film 9 in the IR cut filter 1 are the same as the IR cut filters 1 according to the first to third embodiments, and thus detailed description thereof will not be repeated. Details of the absorption film 9 will be described below.

The formation of the absorption film 9 is performed by performing coating using a mixture in which an acryl-based transparent resin and an absorbent are mixed into an organic solvent by a casting method or a spin coating method. The transparent resin can transmit visible light and examples of the resin include acryl-based resins, polyester-based resins, polyether-based resins, polycarbonate-based resins, cyclic olefin-based resins, polyimide-based resins, and polyethylene naphthalate-based resins.

The absorbent of the absorption film 9 can be an absorbent that does not absorb visible light well. Examples of the absorbent include cyanine-based dyes, phthalocyanine-based dyes, aminium-based dyes, iminium-based pigments, azo-based pigments, anthraquinone-based pigments, diimmonium-based pigments, squarylium-based pigments, and porphyrine-based pigments. More specific examples thereof include Lumogen IR765 and Lumogen IR788 (made by BASF SE); ABS643, ABS 654, ABS 667, ABS 670T, IRA693N, and IRA 735 (made by EXCITON); SDA3598, SDA6075, SDA8030, SDA8303, SDA8470, SDA3039, SDA3040, SDA3922, and SDA7257 (made by H.W. Sands Corp.); and TAP-15 and IR-706 (made by YAMADA CHEMICAL CO., LTD.).

By forming the absorption film 9, light of red to near-infrared regions which is reflected by the multilayer film 3 or the multilayer film 6 can be absorbed by the absorption film 9, thereby reducing ghosts due to reflected light. In reducing the ghosts, the thickness of the absorption film 9 does not need to be partially changed. Accordingly, even when a substrate on which the absorption film 9 is formed is a flat panel such as the substrate 2, the absorption characteristic in a plane parallel to the substrate 2 does not vary.

In this embodiment, regarding reflectance at an incidence angle of 0° and reflectance at an incidence angle of 30° in a wavelength region of 600 nm to 700 nm of the multilayer film 3, when a wavelength on a shorter wavelength side among wavelengths with reflectance of 90% at the incidence angles is λ_{10%} and a wavelength on a longer wavelength side among wavelengths with reflectance of 90% at the incidence angles is λ_{90%}, the absorption film 9 has a characteristic that 40% to 90% of an area is absorbed which is obtained by integrating the higher reflectance of the reflectance at the incidence angle of 0° and the reflectance at the incidence angle of 30° of the multilayer film 3 over a wavelength region of λ_{10%} to λ_{90%}.

FIG. 116 illustrates examples of spectral characteristics of the multilayer film 3 of the IR cut filter in the wavelength region of 600 nm to 700 nm at the incidence angle of 0° and the incidence angle of 30°. The vertical axis of FIG. 116 represents the transmittance and may represent 100-transmittance (%) in consideration of the reflectance. When the absorption film 9 is formed on the multilayer film 3 having such spectral characteristics, the value obtained by integrating the higher reflectance of the reflectance at the incidence angle of 0° and the reflectance at the incidence angle of 30° in the spectral characteristics of the multilayer film 3 for each wavelength over a wavelength region of λ_{10%} to λ_{90%} corresponds to the area of the hatched part in the drawing, that is, an amount of light reflected by the multilayer film 3. Accordingly, by allowing the absorption film 9 to absorb 40% or more of the area (amount of light reflected) to reduce ghosts due to light reflected by the multilayer film 3 and suppressing the amount of light absorbed by the absorption film 9 so as to be equal to or less than 90% of the area, it is possible to suppress a decrease in transmittance of visible light. As a result, it is possible to realize high average transmittance (for example, average transmittance of 88.5% or more) in a visible wavelength region of 420 nm to 600 nm.

The absorption film 9 preferably has a characteristic that absorbs 40% to 85% of the area. In this case, it is possible to further suppress a decrease in transmittance of visible light due to the absorption by the absorption film 9. As a result, it is possible to realize high average transmittance (for example, average transmittance of 89.5% or more) in a visible wavelength region of 420 nm to 600 nm.

The absorption film 9 preferably has a characteristic that absorbs 40% to 78% of the area. In this case, it is possible to further suppress a decrease in transmittance of visible light due to the absorption by the absorption film 9 and thus to realize high average transmittance (for example, average transmittance of 90% or more) in a visible wavelength region of 420 nm to 600 nm.

### Examples

Examples of the IR cut filter having the absorption film that absorbs infrared light will be described below. In the IR cut filter (not including the second multilayer film) according to Example 1-1 of the first embodiment, an absorption film is formed on the light incidence side of the first multilayer film. The absorption film is formed of a mixture in which an absorbent (ABS670T (made by EXCITON)) is added to an acryl-based resin. The amount of absorbent added is changed in a range of 0.0009 wt % to 0.12 wt %, the amount of infrared light absorbed by the absorbent is calculated for each amount of absorbent added, and the ghost and the average transmittance at that time are evaluated.

The amount of infrared light absorbed is expressed by a ratio (area ratio) of the amount of infrared light absorbed to the area (area of the hatched part in FIG. 116) which is obtained by integrating the higher reflectance of the reflectance at the incidence angle of 0° and the reflectance at the incidence angle of 30° in the spectral characteristics of the first multilayer film over a wavelength region of λ_{10%} to λ_{90%} for each wavelength of 1 nm.

The ghost is evaluated based on the following criteria by inserting the IR cut filter into an image capturing device (see FIG. 5) and observing whether degradation in image quality due to a ghost is present in an image acquired by an imaging element with eyes.

◯: Degradation in image quality due to a ghost is not observed or is observed at a level not causing a problem in practical use.

x: Degradation in image quality due to a ghost is observed at a level causing a problem in practical use.

The visible light transmittance is evaluated based on the following criteria by calculating the average transmittance of visible light in the wavelength region of 420 nm to 600 nm of the IR cut filter.

⊙: The average transmittance is equal to or greater than 90%.

◯: The average transmittance is equal to or greater than 89.5% and less than 90%

Δ: The average transmittance is equal to or greater than 88.5% and less than 89.5%.

x: The average transmittance is less than 88.5%.

FIG. 117 illustrates evaluation results of an amount of infrared light absorbed by an absorbent for each amount of absorbent added, a ghost, and average transmittance. FIGS. 118 to 121 illustrate the spectral characteristics of the IR cut filter when the amount of infrared light absorbed by the absorbent is 78%, 90%, 85%, and 40% in terms of an area ratio at the incidence angle of 0° and the incidence angle of 30°.

As can be seen from FIG. 117, when the amount of infrared light absorbed by the absorbent is equal to or greater than 40% and equal to or less than 90% in terms of the area ratio, it can be said that the influence of a ghost is at a level causing no problem in practical use and the decrease in visible light transmittance is suppressed. It can be said that the decrease in visible light transmittance is further suppressed when the amount of infrared light absorbed by the absorbent is equal to or less than 85% in terms of the area ratio, and that the decrease in visible light transmittance is further suppressed when the amount of infrared light absorbed by the absorbent is equal, to or less than 78%.

An example in which an absorption film is applied to the IR cut filter having the first multilayer film formed on one surface of the substrate (the second multilayer film is not formed on the opposite surface of the substrate) is described above. On the other hand, in the configuration in which the second multilayer film is additionally formed on the opposite surface of the substrate, since the reflection characteristic of near-infrared light is enhanced by the second multilayer film (since the amount of near-infrared light reflected is increased), it is more effective that the amount of infrared light absorbed by the absorbent is defined as described above so as to secure the visible light transmittance while decreasing the ghost.

Accordingly, the IR cut filter according to the fourth embodiment may have the following configuration.

That is, the IR cut filter is an IR cut filter including a substrate, a multilayer film formed on the substrate, and a resin layer that absorbs light reflected by the multilayer film,

the multilayer film includes a high refractive index layer and a low refractive index layer which are alternately stacked,

the average transmittance in a wavelength region of 450 nm to 600 nm in the multilayer film is equal to or greater than 90%,

the wavelength with transmittance of 50% at an incidence angle of 0° is in a range of 650±25 nm,

0.5%/nm<|ΔT|<7%/nm is satisfied in a wavelength region of 600 nm to 700 nm,

|ΔT|: value (%/nm) of |(T_{70%}−T_{30%})/(λ_{70%}−λ_{30%})| at the incidence angle of 0°

T_{70%}: transmittance value of 70%

T_{30%}: transmittance value of 30%

λ_{70%}: wavelength (nm) with transmittance of 70%

λ_{30%}: wavelength (nm) with transmittance of 30%,

The difference in wavelength with transmittance of 50% between an incidence angle of 0° and an incidence angle of 30° in a wavelength region of 600 nm to 700 nm is equal to or less than 8 nm,

the difference in wavelength with transmittance of 75% between an incidence angle of 0° and an incidence angle of 30° in the wavelength region is equal to or less than 20 nm, and

when a shorter wavelength of wavelengths with reflectance of 10% at the incidence angles among reflectance at the incidence angle of 0° and reflectance at the incidence angle of 30° in the wavelength region of 600 nm to 750 nm of the multilayer film is λ_{10%} and a longer wavelength of wavelengths with reflectance of 90% at the incidence angles is λ_{90%}, the resin layer has a characteristic of absorbing 40% to 90% of an area which is obtained by integrating the higher reflectance of the reflectance at the incidence angle of 0° and the reflectance at the incidence angle of 30° of the multilayer film over the wavelength region of λ_{10%} to λ_{90%}.

According to this configuration, it is possible to suppress a variation in spectral characteristics with respect to a great variation in incidence angle (for example, a variation of 30°) and thus to realize an IR cut filter of low incidence angle dependency which can satisfactorily cope with the low profile of the imaging lens. It is also possible to decrease a ghost due to light reflected by the multilayer film without changing the thickness of the resin layer while suppressing absorption of visible light in the resin layer that absorbs infrared light.

It is preferable that the resin layer have a characteristic of absorbing 40% to 85% of the area.

It is preferable that the resin layer have a characteristic of absorbing 40% to 78% of the area.

In the multilayer film, it is preferable that the difference in wavelength with transmittance of 25% at the incidence angle of 0° and the incidence angle of 30° in the wavelength region of 600 nm to 700 nm be equal to or less than 20 nm.

It is preferable that the multilayer film include at least four cutoff adjustment pairs in which an optical thickness ratio between the high refractive index layer and the low refractive index layer adjacent to each other is equal to or greater than 3, and

Δn×nH≧1.5 be satisfied when a difference between a maximum refractive index and a minimum refractive index among the refractive indices of layers constituting the multilayer film is Δn and the maximum refractive index is nH.

It is preferable that the total thickness of the multilayer film be equal to or greater than 3000 nm.

An image capturing device according to the fourth embodiment includes the above-mentioned IR cut filter, an imaging lens that is disposed on a light incidence side of the IR cut filter, and an imaging element that receives light which is incident through the imaging lens and the IR cut filter.

<Supplement>

IR cut filters can be classified into three types of an absorption type, a reflection type, and a hybrid type. In an IR cut filter of the absorption type, a substrate includes an absorbent material. In an IR cut filter of the reflection type, an optical film (multilayer film) that transmits visible light and reflects near-infrared light is formed on a transparent substrate. In an IR cut filter of the hybrid type includes a substrate (layer) including an absorbent material and an optical film that transmits visible light and reflects near-infrared light. The IR cut filter described in the first to third embodiments is of the reflection type and the IR cut filter described in the fourth embodiment is of the hybrid type.

### INDUSTRIAL APPLICABILITY

The IR cut filter according to the present invention can be used for an electronic apparatus or an optical apparatus having a solid-state image capturing device, such as a mobile phone, a digital camera, a microscope, and an endoscope.

### REFERENCE SIGNS LIST

1: IR cut filter
2: substrate
3: multilayer film (first multilayer film)
4: high refractive index layer
5: low refractive index layer
6: multilayer film (second multilayer film)
9: absorption film (resin layer)

1. An IR cut filter that transmits visible light and reflects near-infrared light, comprising:
a transparent substrate; and
a multilayer film on the substrate,
the multilayer film including a high refractive index layer and a low refractive index layer which are alternately stacked,
the multilayer film having the following characteristics:
average transmittance in a wavelength region of 450 nm to 600 nm is equal to or greater than 90%;
a wavelength with transmittance of 50% at an incidence angle of 0° is in a range of 650±25 nm;
0.5%/nm<|ΔT|<7%/nm is satisfied;
in a wavelength region of 600 nm to 700 nm, a difference in wavelength with transmittance of 50% between an incidence angle of 0° and an incidence angle of 30° is equal to or less than 8 nm; and
in a wavelength region of 600 nm to 700 nm, a difference in wavelength with transmittance of 75% between an incidence angle of 0° and an incidence angle of 30° is less than 20 nm,
where

|ΔT| is value (%/nm) of |(T_{70%}−T_{30%})/(λ_{70%}−λ_{30%})| at the incidence angle of 0°,
T_{70%} is transmittance value of 70%,
T_{30%} is transmittance value of 30%,
λ_{70%} is wavelength (nm) with transmittance of 70%, and
λ_{30%} is wavelength (nm) with transmittance of 30%.

2. The IR cut filter according to claim 1, wherein the difference in wavelength with transmittance of 75% between an incidence angle of 0° and an incidence angle of 30° in the multilayer film is equal to or less than 15 nm.

3. The IR cut filter according to claim 1, wherein the difference in wavelength with transmittance of 75% between an incidence angle of 0° and an incidence angle of 30° in the multilayer film is equal to or less than 11 nm.

4. The IR cut filter according to claim 1, wherein the multilayer film satisfies 0.5%/nm<|ΔT|<2.5%/nm.

5. The IR cut filter according to claim 1, wherein the multilayer film satisfies 0.5%/nm<|ΔT|<1.5%/nm.

6. The IR cut filter according to claim 1, wherein the multilayer film includes at least four cutoff adjustment pairs in which an optical thickness ratio between the high refractive index layer and the low refractive index layer adjacent to each other is equal to or greater than 3, and
when a difference between a maximum refractive index and a minimum refractive index among the refractive indices of layers constituting the multilayer film is Δn and the maximum refractive index is nH, Δn×nH≧1.5 is satisfied.

7. The IR cut filter according to claim 1, wherein the total thickness of the multilayer film is equal to or greater than 3000 nm.

8. The IR cut filter according to claim 1, further comprising a resin layer including an absorbent material having an absorption peak in the wavelength region of 600 nm to 700 nm,
wherein when a shorter wavelength of wavelengths with reflectance of 10% at the incidence angles among reflectance at the incidence angle of 0° and reflectance at the incidence angle of 30° in the wavelength region of 600 nm to 750 nm of the multilayer film is λ_{10%} and a longer wavelength of wavelengths with reflectance of 90% at the incidence angles is λ_{90%}, the resin layer has a characteristic of absorbing 40% to 90% of an area which is obtained by integrating the higher reflectance of the reflectance at the incidence angle of 0° and the reflectance at the incidence angle of 30° of the multilayer film over the wavelength region of λ_{10%} to λ_{90%}.

9. The IR cut filter according to claim 8, wherein the resin layer has a characteristic of absorbing 40% to 85% of the area.

10. The IR cut filter according to claim 8, wherein the resin layer has a characteristic of absorbing 40% to 78% of the area.

11. The IR cut filter according to claim 1, wherein when the multilayer film is a first multilayer film, a second multilayer film is formed on the opposite surface of the substrate to the surface on which the first multilayer film is formed, and
the second multilayer film has a spectral characteristics in which average transmittance in the wavelength region of 450 nm to 600 nm is equal to or greater than 80% and average transmittance in a wavelength region of 720 nm to 1100 nm is equal to or less than 5% in a state in which the first multilayer film is formed on one surface of the substrate and the second multilayer film is formed on the opposite surface of the substrate.

12. The IR cut filter according to claim 11, wherein the second multilayer film has a spectral characteristic that in the state in which the first multilayer film is formed on one surface of the substrate and the second multilayer film is formed on the opposite surface of the substrate,
a wavelength with transmittance of 50% at the incidence angle of 0° is in a range of 650±25 nm,
0.5%/nm<|ΔT|<7%/nm is satisfied,
in the wavelength region of 600 nm to 700 nm, a difference in wavelength with transmittance of 50% between the incidence angle of 0° and the incidence angle of 30° is equal to or less than 8 nm, and
in the wavelength region of 600 nm to 700 nm, a difference in wavelength with transmittance of 75% between the incidence angle of 0° and the incidence angle of 30° is equal to or less than 20 nm.

13. The IR cut filter according to claim 11, wherein average transmittance in the wavelength region of 450 nm to 600 nm in the second multilayer film is equal to or greater than 90%, and
the wavelength with transmittance of 50% at the incidence angle of 0° in the second multilayer film is located on a longer wavelength side than the wavelength with transmittance of 50% at the incidence angle of 0° in the first multilayer film.

14. The IR cut filter according to claim 11, wherein transmittance of a wavelength of 710 nm at the incidence angle of 0° in the second multilayer film is equal to or less than 5%, and
T_{A}50% λ(30°)−T_{B}50% λ(30°)≦8 nm is satisfied,
where
T_{A}50% λ(30°) is wavelength (nm) with transmittance of 50% in the wavelength region of 600 nm to 700 nm at the incidence angle of 30° in the first multilayer film, and
T_{B}50% λ(30°) is wavelength (nm) with transmittance of 50% in the wavelength region of 600 nm to 700 nm at the incidence angle of 30° in the second multilayer film.

15. An IR cut filter that transmits visible light and reflects near-infrared light, comprising:
a transparent substrate; and
a multilayer film on the substrate,
the multilayer film including a high refractive index layer and a low refractive index layer which are alternately stacked, and having the following characteristics:
average transmittance in a wavelength region of 450 nm to 600 nm in the multilayer film is equal to or greater than 90%;
a wavelength with transmittance of 50% at an incidence angle of 0° is in a range of 650±25 nm; and
0.5%/nm<|ΔT|<7%/nm is satisfied in a wavelength region of 600 nm to 700 nm,
where

|ΔT| is value (%/nm) of |(T_{70%}−T_{30%})/(λ_{70%}−λ_{30%})| at the incidence angle of 0°,
T_{70%} is transmittance value of 70%,
T_{30%} is transmittance value of 30%,
λ_{70%} is wavelength (nm) with transmittance of 70%,
λ_{30%} is wavelength (nm) with transmittance of 30%, and
wherein when a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,
$${\sum }_{n = 50}^{80} \vert Tn \% λ ( 0 ° ) - Tn \% λ ( 30 ° ) \vert ≦ 350 nm . \qquad [ Expression 3 ]$$

16. The IR cut filter according to claim 15, wherein the multilayer film satisfies Expression 2,
$${\sum }_{n = 50}^{80} \vert Tn \% λ ( 0 ° ) - Tn \% λ ( 30 ° ) \vert ≦ 300 nm . \qquad [ Expression 1 ]$$

17. The IR cut filter according to claim 15, wherein the multilayer film satisfies Expression 3,
$${\sum }_{n = 50}^{80} \vert Tn \% λ ( 0 ° ) - Tn \% λ ( 30 ° ) \vert ≦ 260 nm . \qquad [ Expression 3 ]$$

18. The IR cut filter according to claim 15, wherein the multilayer film satisfies 0.5%/nm<|ΔT|<2.5%/nm.

19. The IR cut filter according to claim 15, wherein the multilayer film satisfies 0.5%/nm<|ΔT|<1.5%/nm.

20. The IR cut filter according to claim 15, wherein the multilayer film includes at least four cutoff adjustment pairs in which an optical thickness ratio between the high refractive index layer and the low refractive index layer adjacent to each other is equal to or greater than 3, and
when a difference between a maximum refractive index and a minimum refractive index among the refractive indices of layers constituting the multilayer film is Δn and the maximum refractive index is nH, Δn×nH≧1.5 is satisfied.

21. The IR cut filter according to claim 15, wherein the total thickness of the multilayer film is equal to or greater than 3000 nm.

22. The IR cut filter according to claim 15, wherein when the multilayer film is a first multilayer film, a second multilayer film is formed on the opposite surface of the substrate to the surface on which the first multilayer film is formed, and
the second multilayer film has a spectral characteristics in which average transmittance in the wavelength region of 450 nm to 600 nm is equal to or greater than 80% and average transmittance in a wavelength region of 720 nm to 1100 nm is equal to or less than 5% in a state in which the first multilayer film is formed on one surface of the substrate and the second multilayer film is formed on the opposite surface of the substrate.

23. The IR cut filter according to claim 22, wherein the IR cut filter has a spectral characteristic that in the state in which the first multilayer film is formed on one surface of the substrate and the second multilayer film is formed on the opposite surface of the substrate,
0.5%/nm<|ΔT|<7%/nm is satisfied in the wavelength region of 600 nm to 700 nm, and
a wavelength with transmittance of 50% at the incidence angle of 0° is in a range of 650±25 nm.

24. The IR cut filter according to claim 22, wherein average transmittance in the wavelength region of 450 nm to 600 nm in the second multilayer film is equal to or greater than 90%, and
the wavelength with transmittance of 50% at the incidence angle of 0° in the second multilayer film is located on a longer wavelength side than the wavelength with transmittance of 50% at the incidence angle of 0° in the first multilayer film.

25. The IR cut filter according to claim 15, wherein the IR cut filter includes an absorption film having an absorption peak in the wavelength region of 600 nm to 700 nm.

26. An IR cut filter that transmits visible light and reflects near-infrared light, comprising:
a transparent substrate;
a first multilayer film that is formed on one surface of the substrate; and
a second multilayer film that is formed on the opposite surface of the substrate to the surface on which the first multilayer film is formed,
wherein in a state in which the first multilayer film and the second multilayer film are formed on both surfaces of the substrate, respectively, a wavelength with transmittance of 50% at an incidence angle of 0° is in a range of 650±25 nm,
in the first multilayer film,
a wavelength with transmittance of 50% at an incidence angle of 0° is in a range of 650±25 nm, and
0.5%/nm<|ΔT|<7%/nm is satisfied in a wavelength region of 600 nm to 700 nm,
where

|ΔT| is value (%/nm) of |(T_{70%}−T_{30%})/(λ_{70%}−λ_{30%}) at the incidence angle of 0°
T_{70%} is transmittance value of 70%,
T_{30%} is transmittance value of 30%,
λ_{70%} is wavelength (nm) with transmittance of 70%,
λ_{30%} is wavelength (nm) with transmittance of 30%, and
when a wavelength with transmittance of n % at the incidence angle of 0° in the wavelength region of 600 nm to 700 nm is Tn % λ(0°), a wavelength with transmittance of n % at an incidence angle of 30° in the wavelength region of 600 nm to 700 nm is Tn % λ(30°), and n is an integer, Expression 1 is satisfied,
$${\sum }_{n = 50}^{80} \vert Tn \% λ ( 0 ° ) - Tn \% λ ( 30 ° ) \vert ≦ 350 nm , \qquad [ Expression 1 ]$$
and
in the second multilayer film,
transmittance of a wavelength of 710 nm at the incidence angle of 0° is equal to or less than 5%, and
T_{A}50% λ(30°)−T_{B}50% λ(30°)≦8 nm is satisfied,
where
T_{A}50% λ(30°) is wavelength (nm) with transmittance of 50% in the wavelength region of 600 nm to 700 nm at the incidence angle of 30° in the first multilayer film, and
T_{B}50% λ(30°) is wavelength (nm) with transmittance of 50% in the wavelength region of 600 nm to 700 nm at the incidence angle of 30° in the second multilayer film.

27. The IR cut filter according to claim 26, wherein the multilayer film satisfies Expression 2,
$${\sum }_{n = 50}^{80} \vert Tn \% λ ( 0 ° ) - Tn \% λ ( 30 ° ) \vert ≦ 300 nm . \qquad [ Expression 2 ]$$

28. The IR cut filter according to claim 26, wherein the multilayer film satisfies Expression 3,
$${\sum }_{n = 50}^{80} \vert Tn \% λ ( 0 ° ) - Tn \% λ ( 30 ° ) \vert ≦ 260 nm . \qquad [ Equation 3 ]$$

29. The IR cut filter according to claim 26, wherein in the second multilayer film,
transmittance of a wavelength of 700 nm at the incidence angle of 0° is equal to or less than 2%, and
T_{A}50% λ(30°)−T_{B}50% λ(30°)≧2 nm is satisfied.

30. The IR cut filter according to claim 26, wherein the IR cut filter includes an absorption film having an absorption peak in the wavelength region of 600 nm to 700 nm.

31. An image capturing device comprising:
the IR cut filter according to claim 1;
an imaging lens that is disposed on a light incidence side of the IR cut filter; and
an imaging element that receives light which is incident through the imaging lens and the IR cut filter.

32. An image capturing device comprising:
the IR cut filter according to claim 15;
an imaging lens that is disposed on a light incidence side of the IR cut filter; and
an imaging element that receives light which is incident through the imaging lens and the IR cut filter.

33. An image capturing device comprising:
the IR cut filter according to claim 26;
an imaging lens that is disposed on a light incidence side of the IR cut filter; and
an imaging element that receives light which is incident through the imaging lens and the IR cut filter.
